(19) United States
(12) Patent Application Publication
(10) Pub. No.: US 2021/0182993 A1
(43) Pub. Date: Jun. 17, 2021

(54) TARGETED TRAFFIC CAMPAIGN MANAGEMENT SYSTEM

(71) Applicant: Metropia, Inc., Tucson, AZ (US)

(72) Inventors: Ali Arian, Tucson, AZ (US); Corey Smith, Tucson, AZ (US); Shin-Yu Lin, Tucson, AZ (US); Mario Salomon, Tucson, AZ (US)

(21) Appl. No.: 16/760,882

(22) PCT Filed: Oct. 23, 2018
(86) PCT No.: PCT/US2018/057116

§ 371 Date: Apr. 30, 2020

Related U.S. Application Data
(60) Provisional application No. 62/576,612, filed on Oct. 24, 2017.

(51) Int. Cl. G06Q 50/26; G06Q 30/02

(52) U.S. Cl. CPC G06Q 50/26; G06Q 30/0236

(57) ABSTRACT

Described herein are systems, servers, devices, methods, and media for traffic management, including creating and launching traffic campaigns that target users with user selectable incentives for shifting transit behavior.

### CROSS-REFERENCE

This application claims the benefit of U.S. Provisional Application No. 62/576,612, filed Oct. 24, 2017, which application is incorporated herein by reference in its entirety.

### BACKGROUND OF THE INVENTION

Vehicular traffic congestion is a condition on traffic networks such as highways that occurs as use increases, and is characterized by slower speeds, longer trip times, increased vehicular queuing, and decreased fuel efficiency. The most common example of traffic congestion is the physical over-capacity use of roadways by vehicles. When traffic demand is great enough, the interaction between vehicles slows the speed of the traffic stream, congestion results. As demand exceeds the capacity of a roadway, extreme traffic congestion occurs. The condition resulting when vehicles are fully stopped for periods of time is colloquially known as a traffic jam.

Generally, traffic congestion occurs when a volume of travelers/commuters generates demand for roadway space greater than the available road capacity. This point may be termed saturation. A large percentage of traffic congestion is recurring and is attributed to the sheer rise of travel demand, and most of the rest of traffic congestion is attributed to traffic incidents, roadwork, and weather events. Attempts at solving traffic congestion such as adding or widening highways have various defects in terms of effectiveness, feasibility, cost, or other factors.

### SUMMARY OF THE INVENTION

One advantage provided by the systems, servers, devices, media, and methods of the instant application is the ability to reduce the number of single driver vehicles traveling on the road. Incentives offers can be made to users to shift transit behavior away from driving a vehicle towards alternative modes of transportation. Single vehicle drivers can be incentivized to switch to mass transit options such as taking a bus or a train, or to carpool. Examples of incentive offers include financial, non-financial, monetary, and non-monetary rewards. In some cases, incentive offers are only informational or psychological without an accompanying financial or monetary reward. For example, an incentive offer can be an offer of information regarding available alternative transportation modes or available public transportation modes. In some cases, the incentive offer comprises information regarding reductions in pollutants, savings in gas/money, fitness benefits of alternative transportation modes, time savings (e.g., for alternative route(s)), or other psychological incentives.

Another advantage provided by the systems, servers, devices, media, and methods of the instant application is the ability to reduce the number of vehicles on the road during certain times such as peak traffic congestion (e.g., rush hour). Incentive offers can be made to users to depart so as to avoid travel during times of peak traffic congestion such as by offering alternate departure time windows proximate in time to a preferred travel time.

Another advantage provided by the systems, servers, devices, media, and methods of the instant application is the ability to reduce the number of vehicles traveling in a particular geographic area or route to reduce congestion. Incentive offers can be made to users to travel on an alternate route to reach a destination.

Another advantage provided by the systems, servers, devices, media, and methods of the instant application is the ability to configure targeted traffic campaigns for managing traffic and/or reducing congestion. An administrative user is able to configure the campaign to target users based on personalized reward profiles generated for the users.

Another advantage provided by the systems, servers, devices, media, and methods of the instant application is the ability to generate personalized reward profiles for users. Although static incentives offered to users can successfully induce desired changes in transit behavior, they are not efficient because some users would have accepted the offer for a lower or less valuable incentive. In addition, it can be difficult to predict user responsiveness to incentive offers. Thus, a traffic campaign that randomly makes the same incentive offer to 100 users on a daily basis is likely to produce unpredictable results with high day-to-day variation. This presents a challenge to successfully managing traffic congestion. Accordingly, user data can be used for generating personalized reward profiles that indicate incentives predicted to successfully induce changes in transit behavior. For example, a particular user may have a reward profile for mode of transportation that specifies 50 points for switching to mass transit but only 20 points for switching to cycling because his past transit behavior indicates he enjoys cycling and has frequently accepted a transportation mode switch to cycling for an average of 20 points in the past.

Another advantage provided by the systems, servers, devices, media, and methods of the instant application is the ability to gather user data to enhance traffic management. User data is useful for identifying users to target with a traffic campaign and/or calculating reward profiles for users. User data is obtained through one or more of a variety of sources such as from a user electronic device (e.g., a smartphone), social media, microsurveys, and other data sources. User data can include a variety of information such as psychographics, social life, activity, lifestyle, user network, socio-demographic information, geo-relation (e.g., location in a geographic area), corridor relation (e.g., location on a particular transportation route such as a highway or road). User data can also include historical transit behavior such as past trips taken (e.g., departure times, travel times, average speed, routes taken, mode of transportation, responsiveness to incentive offers, etc.).

In one aspect, disclosed herein is a traffic campaign management system, comprising: a) an electronic device application executable on an electronic device of a user; and b) a server in operative communication with the electronic device application deployed to a plurality of electronic devices, the server comprising at least one processor, a memory, and instructions executable by the at least one processor to create a server application comprising: i) a campaign builder module generating a traffic campaign for reducing congestion by making micro-targeted incentive offers personalized to target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof; ii) a reward profile module analyzing user data to generate personalized reward profiles comprising incentive offers predicted to successfully shift transit behavior, the user data comprising responsiveness to previous incentive offers; iii) a campaign targeting module identifying target users by comparing traffic campaign parameters with user data comprising user-selected origin and destination pairs, wherein the user of the electronic device application is one of the target users, and determining at least one available travel option from the targeted shift in transit behavior for the user; iv) an incentive offering module calculating a user incentive for each available travel option according to a reward profile associated with the targeted shift in transit behavior for the user, and presenting the at least one available travel option and associated user incentive to the user; and v) a validation module receiving location information from the electronic device application, and verifying that the user has departed from the origin during a selected departure time window, traveled along at least a portion of the route thereafter, and utilized a selected mode of transportation according to one of the at least one available travel option. In some embodiments, the user data comprises historical user transit behavior. In some embodiments, the historical user transit behavior comprises departure time, mode of transportation, and route traveled for past trips. In some embodiments, the user data comprises a user-selected origin and destination pair, preferred travel time, mode of transportation, or any combination thereof for a current or upcoming trip. In some embodiments, the user data comprises activity or lifestyle, personality, socio-demographic, geo-relation, corridor relation, or any combination thereof. In some embodiments, the campaign builder module allows sorting or filtering based on activity or lifestyle, personality, socio-demographic, geo-relation, corridor relation, or any combination thereof for identifying target users. In some embodiments, geo-relation indicates a user-selected origin and destination pair that matches a location targeted by the traffic campaign for reducing congestion. In some embodiments, corridor relation indicates a user-selected origin and destination pair that matches a route targeted by the traffic campaign for reducing congestion. In some embodiments, the user data is obtained from GPS points, microsurveys, social media, email, or any combination thereof. In some embodiments, the GPS points are a source of user data comprising geo-relation, corridor relation, activity or lifestyle, or any combination thereof. In some embodiments, the microsurveys are a source of user data comprising activity or lifestyle, socio-demographic, psychographic, or any combination thereof. In some embodiments, social media is a source of user data comprising socio-demographic. In some embodiments, the sever application further comprises a microsurvey module presenting at least one user with at least one question and user incentive for answering the at least one question. In some embodiments, the microsurvey is triggered to present the at least one question and user incentive based on the user data, wherein the user data is indicative of a current state of the at least one user. In some embodiments, the current state of the at least one user comprises current time, physical location, and interaction with at least one of the plurality of electronic device applications. In some embodiments, the user incentive is selected based on past responsiveness to incentives for the at least one user. In some embodiments, the at least one question is selected based on relevance to the at least one user. In some embodiments, a reward profile comprises personalized incentives associated with different modes of transportation, departure time windows, routes, or any combination thereof. In some embodiments, modes of transportation comprise driving, biking, bus, train, ride-sharing, carpooling, subway, trolley, taxi, walking, scooter, microtransit, or any combination thereof. In some embodiments, modes of transportation comprise a plurality of modes of transportation and an incentive associated with each of the plurality of modes of transportation. In some embodiments, a reward profile comprises a plurality of departure time windows and an incentive associated with each of the plurality of departure time windows. In some embodiments, a reward profile comprises a plurality of departure time windows proximate to a preferred travel time. In some embodiments, a reward profile comprises a plurality of routes and an incentive associated with each of the plurality of routes. In some embodiments, a reward profile is adjusted to increase incentives corresponding to the targeted shift in transit behavior. In some embodiments, the traffic campaign comprises location, duration, budget, and targeted number of users. In some embodiments, the incentive offering module offers the user incentive based on a reward profile of the user so as to maximize the targeted shift in transit behavior without exceeding the budget. In some embodiments, the incentive offering module offers the user incentive based on a reward profile of the user so as to maximize a ratio of the targeted shift in transit behavior to a cost of the incentives. In some embodiments, the incentive offering module continues offering incentives to target users until the targeted number of users have accepted the targeted shift in transit behavior or performed the targeted shift in transit behavior. In some embodiments, the incentive offering module continues offering incentives to target users until the budget has been expended. In some embodiments, comparing traffic campaign parameters with user data comprises determining a geo-relation or corridor relation between users and the location of the traffic campaign. In some embodiments, the campaign targeting module dynamically identifies target users by receiving current or upcoming transit information from the target users and comparing the transit information with traffic campaign parameters. In some embodiments, the campaign targeting module identifies target users by comparing traffic campaign parameters with user data before receiving current or upcoming transit information from the target users. In some embodiments, the campaign targeting module presents incentive offers to target users in an order that minimizes cost of attaining the targeted shift in transit behavior for a targeted number of users. In some embodiments, target users are sorted into groups based on incentives corresponding to the targeted shift in transit behavior, wherein target users with lower incentives are presented with incentive offers before target users with higher incentives. In some embodiments, the traffic campaign comprises an incentive threshold that places a limit on an incentive amount that can be offered to a target user. In some embodiments, the targeted shift in transit behavior is a shift in mode of transportation, a shift in departure time, a shift in route, or any combination thereof. In some embodiments, the shift in mode of transportation comprises a change from driving to biking, bus, train, walking, or any combination thereof. In some embodiments, the shift in departure time comprises multiple departure time windows proximate in time to a preferred travel time for a user-selected origin and destination pair, wherein each of the departure time windows corresponds to a time interval when a user is to depart from the origin and travel along a route toward the destination. In some embodiments, the shift in route comprises at least one additional route distinct from a preferred route for a user-selected origin and destination pair. In some embodiments, the validation module disburses the user incentive offered to the at least one target user after verifying that the at least one target user has performed the targeted shift in transit behavior. In some embodiments, the verifying that the at least one target user has performed the targeted shift in transit behavior comprises analyzing location data obtained from at least one electronic device of the at least one target user. In some embodiments, the verifying comprises determining a mode of transportation used by the at least one target user and comparing a mode of transportation of the at least one target user with a targeted shift in mode of transportation. In some embodiments, the verifying comprises comparing a departure time of the at least one target user with a targeted shift in departure time. In some embodiments, the verifying comprises comparing a route taken by the at least one target user with a targeted shift in route. In some embodiments, the server application further comprises a transaction module tracking incentives collected by users and allowing exchange of incentives for rewards. In some embodiments, incentives comprise points that are redeemable for rewards. In some embodiments, rewards comprise parking, high occupancy vehicle designation, third party purchases, vouchers, discounts, gift cards, cash, or any combination thereof. In some embodiments, the user incentive has a monetary or non-monetary value. In some embodiments, the user incentive is selected to appeal to a lifestyle, socio-demographic, or psychographic aspect of the at least one user. In some embodiments, further comprises an analytics module calculating results of the traffic campaign. In some embodiments, the results comprise number of users shifted, change in average travel speed, average cost per user shifted, or any combination thereof. In some embodiments, the traffic campaign is a static campaign configured by an administrative user. In some embodiments, the traffic campaign is a dynamic campaign that is automatically configured in response to one or more traffic events. In some embodiments, the electronic device is a mobile device, a tablet, a laptop, a computer, or a vehicle console.

In another aspect, disclosed herein is a computer-implemented method for conducting a traffic campaign for reducing congestion, comprising: a) generating a traffic campaign for reducing congestion by making micro-targeted incentive offers personalized to target users via electronic devices of the target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof; b) analyzing user data to generate personalized reward profiles comprising incentive offers predicted to successfully shift transit behavior, the user data comprising responsiveness to previous incentive offers; c) identifying target users by comparing traffic campaign parameters with user data comprising user-selected origin and destination pairs; d) determining at least one available travel option from the targeted shift in transit behavior for a user selected from the target users; e) calculating a user incentive for each travel option according calculating a user incentive for each available travel option according to a reward profile associated with the targeted shift in transit behavior for the user; f) presenting the at least one available travel option and associated user incentive to the user; g) receiving location information from the electronic device application; and h) verifying that the user has departed from the origin during a selected departure time window, traveled along at least a portion of the route thereafter, and utilized a selected mode of transportation according to one of the at least one available travel option. In some embodiments, the user data comprises historical user transit behavior. In some embodiments, the historical user transit behavior comprises departure time, mode of transportation, and route traveled for past trips. In some embodiments, the user data comprises a user-selected origin and destination pair, preferred travel time, mode of transportation, or any combination thereof for a current or upcoming trip. In some embodiments, the user data comprises activity or lifestyle, personality, socio-demographic, geo-relation, corridor relation, or any combination thereof. In some embodiments, further comprises sorting or filtering based on activity or lifestyle, personality, socio-demographic, geo-relation, corridor relation, or any combination thereof for identifying the at least one target user. In some embodiments, geo-relation indicates a user-selected origin and destination pair that matches a location targeted by the traffic campaign for reducing congestion. In some embodiments, corridor relation indicates a user-selected origin and destination pair that matches a route targeted by the traffic campaign for reducing congestion. In some embodiments, the user data is obtained from GPS points, microsurveys, social media, email, or any combination thereof. In some embodiments, the GPS points are a source of user data comprising geo-relation, corridor relation, activity or lifestyle, or any combination thereof. In some embodiments, the microsurveys are a source of user data comprising activity or lifestyle, socio-demographic, psychographic, or any combination thereof. In some embodiments, social media is a source of user data comprising socio-demographic. In some embodiments, the method further comprises presenting at least one user with a microsurvey comprising at least one question and user incentive for answering the at least one question. In some embodiments, the microsurvey is triggered to present the at least one question and user incentive based on the user data, wherein the user data is indicative of a current state of the at least one user. In some embodiments, the current state of the at least one user comprises current time, physical location, and interaction with at least one of the plurality of electronic device applications. In some embodiments, the user incentive is selected based on past responsiveness to incentives for the at least one user. In some embodiments, the at least one question is selected based on relevance to the at least one user. In some embodiments, a reward profile comprises personalized incentives associated with different modes of transportation, departure time windows, routes, or any combination thereof. In some embodiments, modes of transportation comprise driving, biking, bus, train, ride-sharing, carpooling, subway, trolley, taxi, walking, scooter, microtransit, or any combination thereof. In some embodiments, modes of transportation comprise a plurality of modes of transportation and an incentive associated with each of the plurality of modes of transportation. In some embodiments, a reward profile comprises a plurality of departure time windows and an incentive associated with each of the plurality of departure time windows. In some embodiments, a reward profile comprises a plurality of departure time windows proximate to a preferred travel time. In some embodiments, a reward profile comprises a plurality of routes and an incentive associated with each of the plurality of routes. In some embodiments, a reward profile is adjusted to increase the incentives corresponding to the targeted shift in transit behavior. In some embodiments, the traffic campaign further comprises location, duration, budget, and targeted number of users. In some embodiments, the user incentive is based on a reward profile of the user so as to maximize the targeted shift in transit behavior without exceeding the budget. In some embodiments, the user incentive is based on a reward profile of the user so as to maximize a ratio of the targeted shift in transit behavior to a cost of the user incentive. In some embodiments, the method further comprises continuing to offer incentives to target users until the targeted number of users have accepted the targeted shift in transit behavior or performed the targeted shift in transit behavior. In some embodiments, the method further comprises continuing to offer incentives to target users until the budget has been expended. In some embodiments, comparing the user data with traffic campaign parameters comprises determining a geo-relation or corridor relation between users and the location of the traffic campaign. In some embodiments, target users are dynamically identified by receiving current or upcoming transit information from the target users and comparing the transit information with traffic campaign parameters. In some embodiments, target users are identified by comparing traffic campaign parameters with user data before receiving current or upcoming transit information from the target users. In some embodiments, incentives are offered to target users in an order that minimizes cost of attaining the targeted shift in transit behavior for a targeted number of users. In some embodiments, target users are sorted into groups based on incentives corresponding to the targeted shift in transit behavior, wherein target users with lower incentives are presented with incentive offers before target users with higher incentives. In some embodiments, the traffic campaign comprises an incentive threshold that places a limit on an incentive amount that can be offered to a target user. In some embodiments, the targeted shift in transit behavior is a shift in mode of transportation, a shift in departure time, a shift in route, or any combination thereof. In some embodiments, the shift in mode of transportation comprises a change from driving to biking, bus, train, walking, or any combination thereof. In some embodiments, the shift in departure time comprises multiple departure time windows proximate in time to a preferred travel time for a user-selected origin and destination pair, wherein each of the departure time windows corresponds to a time interval when a user is to depart from the origin and travel along a route toward the destination. In some embodiments, the shift in route comprises at least one additional route distinct from a preferred route for a user-selected origin and destination pair. In some embodiments, the method further comprises disbursing the user incentive offered to the at least one target user after verifying that the at least one target user has performed the targeted shift in transit behavior. In some embodiments, the verifying that the at least one target user has performed the targeted shift in transit behavior comprises analyzing location data obtained from at least one electronic device of the at least one target user. In some embodiments, the verifying comprises determining a mode of transportation used by the at least one target user and comparing a mode of transportation of the at least one target user with a targeted shift in mode of transportation. In some embodiments, the verifying comprises comparing a departure time of the at least one target user with a targeted shift in departure time. In some embodiments, the verifying comprises comparing a route taken by the at least one target user with a targeted shift in route. In some embodiments, the method further comprises tracking incentives collected by users and allowing exchange of incentives for rewards. In some embodiments, incentives comprise points that are redeemable for rewards. In some embodiments, rewards comprise parking, high occupancy vehicle designation, third party purchases, vouchers, discounts, gift cards, cash, or any combination thereof. In some embodiments, the user incentive has a monetary or non-monetary value. In some embodiments, the user incentive is selected to appeal to a lifestyle, socio-demographic, or psychographic aspect of the at least one user. In some embodiments, the method further comprises calculating results of the traffic campaign. In some embodiments, the results comprise number of users shifted, change in average travel speed, average cost per user shifted, or any combination thereof. In some embodiments, the traffic campaign is a static campaign configured by an administrative user. In some embodiments, the traffic campaign is a dynamic campaign that is automatically configured in response to one or more traffic events. In some embodiments, the electronic device is a mobile device, a tablet, a laptop, a computer, or a vehicle console.

In another aspect, disclosed herein is non-transitory computer-readable storage media encoded with a computer program including instructions executable by at least one processor to create a computer software server system in operative communication with a plurality of electronic device applications executable on a plurality of electronic devices of a plurality of users, the computer software server system comprising: i) a campaign builder module generating a traffic campaign for reducing congestion by making micro-targeted incentive offers personalized to target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof; ii) a reward profile module analyzing user data to generate personalized reward profiles comprising incentive offers predicted to successfully shift transit behavior, the user data comprising responsiveness to previous incentive offers; iii) a campaign targeting module identifying target users by comparing traffic campaign parameters with user data comprising user-selected origin and destination pairs, and determining at least one available travel option from the targeted shift in transit behavior for a user; iv) an incentive offering module calculating a user incentive for each available travel option according to a reward profile associated with the targeted shift in transit behavior for the user, and presenting the at least one available travel option and associated user incentive to the user; and v) a validation module receiving location information from the electronic device application, and verifying that the user has departed from the origin during a selected departure time window, traveled along at least a portion of the route thereafter, and utilized a selected mode of transportation according to one of the at least one available travel option. In some embodiments, the user data comprises historical user transit behavior. In some embodiments, the historical user transit behavior comprises departure time, mode of transportation, and route traveled for past trips. In some embodiments, the user data comprises a user-selected origin and destination pair, preferred travel time, mode of transportation, or any combination thereof for a current or upcoming trip. In some embodiments, the user data comprises activity or lifestyle, personality, socio-demographic, geo-relation, corridor relation, or any combination thereof. In some embodiments, the campaign builder module allows sorting or filtering based on activity or lifestyle, personality, socio-demographic, geo-relation, corridor relation, or any combination thereof for identifying the at least one target user. In some embodiments, geo-relation indicates a user-selected origin and destination pair that matches a location targeted by the traffic campaign for reducing congestion. In some embodiments, corridor relation indicates a user-selected origin and destination pair that matches a route targeted by the traffic campaign for reducing congestion. In some embodiments, the user data is obtained from GPS points, microsurveys, social media, email, or any combination thereof. In some embodiments, the GPS points are a source of user data comprising geo-relation, corridor relation, activity or lifestyle, or any combination thereof. In some embodiments, the microsurveys are a source of user data comprising activity or lifestyle, socio-demographic, psychographic, or any combination thereof. In some embodiments, social media is a source of user data comprising socio-demographic. In some embodiments, the computer software server system further comprises a microsurvey module presenting at least one user with at least one question and user incentive for answering the at least one question. In some embodiments, the microsurvey is triggered to present the at least one question and user incentive based on the user data, wherein the user data is indicative of a current state of the at least one user. In some embodiments, the current state of the at least one user comprises current time, physical location, and interaction with at least one of the plurality of electronic device applications. In some embodiments, the user incentive is selected based on past responsiveness to incentives for the at least one user. In some embodiments, the at least one question is selected based on relevance to the at least one user. In some embodiments, a reward profile comprises personalized incentives associated with different modes of transportation, departure time windows, routes, or any combination thereof. In some embodiments, modes of transportation comprise driving, biking, bus, train, ride-sharing, carpooling, subway, trolley, taxi, walking, scooter, microtransit, or any combination thereof. In some embodiments, modes of transportation comprise a plurality of modes of transportation and an incentive associated with each of the plurality of modes of transportation. In some embodiments, a reward profile comprises a plurality of departure time windows and an incentive associated with each of the plurality of departure time windows. In some embodiments, a reward profile comprises a plurality of departure time windows proximate to a preferred travel time. In some embodiments, a reward profile comprises a plurality of routes and an incentive associated with each of the plurality of routes. In some embodiments, a reward profile is adjusted to increase the incentives corresponding to the targeted shift in transit behavior. In some embodiments, the traffic campaign comprises location, duration, budget, and targeted number of users. In some embodiments, the incentive offering module offers incentives to the at least one target user based on reward profiles of said target user so as to maximize the targeted shift in transit behavior without exceeding the budget. In some embodiments, the incentive offering module offers the user incentive based on a reward profile of the user so as to maximize a ratio of the targeted shift in transit behavior to a cost of the incentives. In some embodiments, the incentive offering module continues offering incentives to target users until the targeted number of users have accepted the targeted shift in transit behavior or performed the targeted shift in transit behavior. In some embodiments, the incentive offering module continues offering incentives to target users until the budget has been expended. In some embodiments, comparing the user data with traffic campaign parameters comprises determining a geo-relation or corridor relation between users and the location of the traffic campaign. In some embodiments, the campaign targeting module dynamically identifies target users by receiving current or upcoming transit information from the target users and comparing the transit information with traffic campaign parameters. In some embodiments, the campaign targeting module identifies target users by comparing traffic campaign parameters with user data before receiving current or upcoming transit information from the target users. In some embodiments, the campaign targeting module presents incentive offers to target users in an order that minimizes cost of attaining the targeted shift in transit behavior for a targeted number of users. In some embodiments, target users are sorted into groups based on incentives corresponding to the targeted shift in transit behavior, wherein target users with lower incentives are presented with incentive offers before target users with higher incentives. In some embodiments, the traffic campaign comprises an incentive threshold that places a limit on an incentive amount that can be offered to a target user. In some embodiments, the targeted shift in transit behavior is a shift in mode of transportation, a shift in departure time, a shift in route, or any combination thereof. In some embodiments, the shift in mode of transportation comprises a change from driving to biking, bus, train, walking, or any combination thereof. In some embodiments, the shift in departure time comprises multiple departure time windows proximate in time to a preferred travel time for a user-selected origin and destination pair, wherein each of the departure time windows corresponds to a time interval when a user is to depart from the origin and travel along a route toward the destination. In some embodiments, the shift in route comprises at least one additional route distinct from a preferred route for a user-selected origin and destination pair. In some embodiments, the validation module disburses the user incentive offered to the at least one target user after verifying that the at least one target user has performed the targeted shift in transit behavior. In some embodiments, the verifying that the at least one target user has performed the targeted shift in transit behavior comprises analyzing location data obtained from at least one electronic device of the at least one target user. In some embodiments, the verifying comprises determining a mode of transportation used by the at least one target user and comparing a mode of transportation of the at least one target user with a targeted shift in mode of transportation. In some embodiments, the verifying comprises comparing a departure time of the at least one target user with a targeted shift in departure time. In some embodiments, the verifying comprises comparing a route taken by the at least one target user with a targeted shift in route. In some embodiments, the computer software server system further comprises a transaction module tracking incentives collected by users and allowing exchange of incentives for rewards. In some embodiments, incentives comprise points that are redeemable for rewards. In some embodiments, rewards comprise parking, high occupancy vehicle designation, third party purchases, vouchers, discounts, gift cards, cash, or any combination thereof. In some embodiments, the user incentive has a monetary or non-monetary value. In some embodiments, the user incentive is selected to appeal to a lifestyle, socio-demographic, or psychographic aspect of the at least one user. In some embodiments, the computer software server system further comprises an analytics module calculating results of the traffic campaign. In some embodiments, the results comprise number of users shifted, change in average travel speed, average cost per user shifted, or any combination thereof. In some embodiments, the traffic campaign is a static campaign configured by an administrative user. In some embodiments, the traffic campaign is a dynamic campaign that is automatically configured in response to one or more traffic events. In some embodiments, the electronic device is a mobile device, a tablet, a laptop, a computer, or a vehicle console.

In another aspect, disclosed herein is a traffic campaign management system, comprising: a) an electronic device application executable on an electronic device of a user; and b) a server in operative communication with the electronic device application deployed to a plurality of electronic devices, the server comprising at least one processor, a memory, and instructions executable by the at least one processor to create a server application comprising: i) a campaign builder module generating a traffic campaign for reducing congestion by making micro-targeted transit suggestions personalized to target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof; ii) a reward profile module analyzing user data to generate personalized reward profiles comprising transit suggestions predicted to successfully shift transit behavior, the user data comprising responsiveness to previous transit suggestions; iii) a campaign targeting module identifying target users by comparing traffic campaign parameters with user data comprising user-selected origin and destination pairs, wherein the user of the electronic device application is one of the target users, and determining at least one available travel option from the targeted shift in transit behavior for the user; iv) a transit suggestion module determining a transit suggestion for each available travel option according to a reward profile associated with the targeted shift in transit behavior for the user, and presenting the at least one available travel option and the transit suggestion to the user. In some embodiments, the user data comprises historical user transit behavior. In some embodiments, the historical user transit behavior comprises departure time, mode of transportation, and route traveled for past trips. In some embodiments, the user data comprises a user-selected origin and destination pair, preferred travel time, mode of transportation, or any combination thereof for a current or upcoming trip. In some embodiments, the user data comprises activity or lifestyle, personality, socio-demographic, geo-relation, corridor relation, or any combination thereof. In some embodiments, the campaign builder module allows sorting or filtering based on activity or lifestyle, personality, socio-demographic, geo-relation, corridor relation, or any combination thereof for identifying target users. In some embodiments, geo-relation indicates a user-selected origin and destination pair that matches a location targeted by the traffic campaign for reducing congestion. In some embodiments, corridor relation indicates a user-selected origin and destination pair that matches a route targeted by the traffic campaign for reducing congestion. In some embodiments, the user data is obtained from GPS points, microsurveys, social media, email, or any combination thereof. In some embodiments, the GPS points are a source of user data comprising geo-relation, corridor relation, activity or lifestyle, or any combination thereof. In some embodiments, the microsurveys are a source of user data comprising activity or lifestyle, socio-demographic, psychographic, or any combination thereof. In some embodiments, social media is a source of user data comprising socio-demographic. In some embodiments, the server application further comprises a microsurvey module presenting at least one user with at least one question and an incentive offer for answering the at least one question. In some embodiments, the microsurvey is triggered to present the at least one question and the incentive offer based on the user data, wherein the user data is indicative of a current state of the at least one user. In some embodiments, the current state of the at least one user comprises current time, physical location, and interaction with at least one of the plurality of electronic device applications. In some embodiments, the transit suggestion is selected based on responsiveness to past transit suggestions for the at least one user. In some embodiments, the at least one question is selected based on relevance to the at least one user. In some embodiments, a reward profile comprises personalized transit suggestions associated with different modes of transportation, departure time windows, routes, or any combination thereof. In some embodiments, modes of transportation comprise driving, biking, bus, train, ride-sharing, carpooling, subway, trolley, taxi, walking, scooter, microtransit, or any combination thereof. In some embodiments, modes of transportation comprise a plurality of modes of transportation and a transit suggestion associated with each of the plurality of modes of transportation. In some embodiments, a reward profile comprises a plurality of departure time windows and a transit suggestion associated with each of the plurality of departure time windows. In some embodiments, a reward profile comprises a plurality of departure time windows proximate to a preferred travel time. In some embodiments, a reward profile comprises a plurality of routes and a transit suggestion associated with each of the plurality of routes. In some embodiments, a reward profile is adjusted to provide an incentive corresponding to the targeted shift in transit behavior. In some embodiments, the traffic campaign comprises location, duration, and targeted number of users. In some embodiments, the transit suggestion module offers the transit suggestion based on a reward profile of the user so as to maximize the targeted shift in transit behavior. In some embodiments, the transit suggestion module continues offering transit suggestions to target users until the targeted number of users have accepted the targeted shift in transit behavior or performed the targeted shift in transit behavior. In some embodiments, comparing traffic campaign parameters with user data comprises determining a geo-relation or corridor relation between users and the location of the traffic campaign. In some embodiments, the campaign targeting module dynamically identifies target users by receiving current or upcoming transit information from the target users and comparing the transit information with traffic campaign parameters. In some embodiments, the campaign targeting module identifies target users by comparing traffic campaign parameters with user data before receiving current or upcoming transit information from the target users. In some embodiments, the campaign targeting module presents transit suggestions to target users in an order that maximizes an adoption rate for the targeted shift in transit behavior for a targeted number of users. In some embodiments, the targeted shift in transit behavior is a shift in mode of transportation, a shift in departure time, a shift in route, or any combination thereof. In some embodiments, the shift in mode of transportation comprises a change from driving to biking, bus, train, walking, or any combination thereof. In some embodiments, the shift in departure time comprises multiple departure time windows proximate in time to a preferred travel time for a user-selected origin and destination pair, wherein each of the departure time windows corresponds to a time interval when a user is to depart from the origin and travel along a route toward the destination. In some embodiments, the shift in route comprises at least one additional route distinct from a preferred route for a user-selected origin and destination pair. In some embodiments, the transit suggestion has no monetary value. In some embodiments, the transit suggestion is selected to appeal to a lifestyle, socio-demographic, or psychographic aspect of the at least one user. In some embodiments, the server application further comprises an analytics module calculating results of the traffic campaign. In some embodiments, the results comprise number of users shifted, change in average travel speed, average cost per user shifted, or any combination thereof. In some embodiments, the traffic campaign is a static campaign configured by an administrative user. In some embodiments, the traffic campaign is a dynamic campaign that is automatically configured in response to one or more traffic events. In some embodiments, the electronic device is a mobile device, a tablet, a laptop, a computer, or a vehicle console. In some embodiments, the server application further comprises a validation module receiving location information from the electronic device application, and verifying that the user has departed from the origin during a selected departure time window, traveled along at least a portion of the route thereafter, and utilized a selected mode of transportation according to one of the at least one available travel option.

In another aspect, disclosed herein is a computer-implemented method for conducting a traffic campaign for reducing congestion, comprising: a) generating a traffic campaign for reducing congestion by making micro-targeted transit suggestions personalized to target users via electronic devices of the target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof; b) analyzing user data to generate personalized reward profiles comprising transit suggestions predicted to successfully shift transit behavior, the user data comprising responsiveness to previous transit suggestions; c) identifying target users by comparing traffic campaign parameters with user data comprising user-selected origin and destination pairs; d) determining at least one available travel option from the targeted shift in transit behavior for a user selected from the target users; e) determining a transit suggestion for each available travel option according to a reward profile associated with the targeted shift in transit behavior for the user; and f) presenting the at least one available travel option and the transit suggestion to the user. In some embodiments, the user data comprises historical user transit behavior. In some embodiments, the historical user transit behavior comprises departure time, mode of transportation, and route traveled for past trips. In some embodiments, the user data comprises a user-selected origin and destination pair, preferred travel time, mode of transportation, or any combination thereof for a current or upcoming trip. In some embodiments, the user data comprises activity or lifestyle, personality, socio-demographic, geo-relation, corridor relation, or any combination thereof. In some embodiments, the method further comprises sorting or filtering based on activity or lifestyle, personality, socio-demographic, geo-relation, corridor relation, or any combination thereof for identifying the at least one target user. In some embodiments, geo-relation indicates a user-selected origin and destination pair that matches a location targeted by the traffic campaign for reducing congestion. In some embodiments, corridor relation indicates a user-selected origin and destination pair that matches a route targeted by the traffic campaign for reducing congestion. In some embodiments, the user data is obtained from GPS points, microsurveys, social media, email, or any combination thereof. In some embodiments, the GPS points are a source of user data comprising geo-relation, corridor relation, activity or lifestyle, or any combination thereof. In some embodiments, the microsurveys are a source of user data comprising activity or lifestyle, socio-demographic, psychographic, or any combination thereof. In some embodiments, social media is a source of user data comprising socio-demographic. In some embodiments, the method further comprises presenting at least one user with a microsurvey comprising at least one question and an incentive offer for answering the at least one question. In some embodiments, the microsurvey is triggered to present the at least one question and the incentive offer based on the user data, wherein the user data is indicative of a current state of the at least one user. In some embodiments, the current state of the at least one user comprises current time, physical location, and interaction with at least one of the plurality of electronic device applications. In some embodiments, the transit suggestion is selected based on responsiveness to past transit suggestions for the at least one user. In some embodiments, the at least one question is selected based on relevance to the at least one user. In some embodiments, a reward profile comprises personalized transit suggestions associated with different modes of transportation, departure time windows, routes, or any combination thereof. In some embodiments, modes of transportation comprise driving, biking, bus, train, ride-sharing, carpooling, subway, trolley, taxi, walking, scooter, microtransit, or any combination thereof. In some embodiments, modes of transportation comprise a plurality of modes of transportation and a transit suggestion associated with each of the plurality of modes of transportation. In some embodiments, a reward profile comprises a plurality of departure time windows and a transit suggestion associated with each of the plurality of departure time windows. In some embodiments, a reward profile comprises a plurality of departure time windows proximate to a preferred travel time. In some embodiments, a reward profile comprises a plurality of routes and a transit suggestion associated with each of the plurality of routes. In some embodiments, a reward profile is adjusted to provide an incentive corresponding to the targeted shift in transit behavior. In some embodiments, the traffic campaign comprises location, duration, and targeted number of users. In some embodiments, the transit suggestion is based on a reward profile of the user so as to maximize the targeted shift in transit behavior. In some embodiments, the method further comprises continuing to offer transit suggestions to target users until the targeted number of users have accepted the targeted shift in transit behavior or performed the targeted shift in transit behavior. In some embodiments, comparing the user data with traffic campaign parameters comprises determining a geo-relation or corridor relation between users and the location of the traffic campaign. In some embodiments, target users are dynamically identified by receiving current or upcoming transit information from the target users and comparing the transit information with traffic campaign parameters. In some embodiments, target users are identified by comparing traffic campaign parameters with user data before receiving current or upcoming transit information from the target users. In some embodiments, incentives are offered to target users in an order that maximizes an adoption rate for the targeted shift in transit behavior for a targeted number of users. In some embodiments, the targeted shift in transit behavior is a shift in mode of transportation, a shift in departure time, a shift in route, or any combination thereof. In some embodiments, the shift in mode of transportation comprises a change from driving to biking, bus, train, walking, or any combination thereof. In some embodiments, the shift in departure time comprises multiple departure time windows proximate in time to a preferred travel time for a user-selected origin and destination pair, wherein each of the departure time windows corresponds to a time interval when a user is to depart from the origin and travel along a route toward the destination. In some embodiments, the shift in route comprises at least one additional route distinct from a preferred route for a user-selected origin and destination pair. In some embodiments, the transit suggestion has no monetary value. In some embodiments, the transit suggestion is selected to appeal to a lifestyle, socio-demographic, or psychographic aspect of the at least one user. In some embodiments, the method further comprises calculating results of the traffic campaign. In some embodiments, the results comprise number of users shifted, change in average travel speed, average cost per user shifted, or any combination thereof. In some embodiments, the traffic campaign is a static campaign configured by an administrative user. In some embodiments, the traffic campaign is a dynamic campaign that is automatically configured in response to one or more traffic events. In some embodiments, the electronic device is a mobile device, a tablet, a laptop, a computer, or a vehicle console. In some embodiments, the method further comprises receiving location information from the electronic device application, and verifying that the user has departed from the origin during a selected departure time window, traveled along at least a portion of the route thereafter, and utilized a selected mode of transportation according to one of the at least one available travel option.

In another aspect, disclosed herein is non-transitory computer-readable storage media encoded with a computer program including instructions executable by at least one processor to create a computer software server system in operative communication with a plurality of electronic device applications executable on a plurality of electronic devices of a plurality of users, the computer software server system comprising: i) a campaign builder module generating a traffic campaign for reducing congestion by making micro-targeted transit suggestions personalized to target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof; ii) a reward profile module analyzing user data to generate personalized reward profiles comprising transit suggestions predicted to successfully shift transit behavior, the user data comprising responsiveness to previous transit suggestions; iii) a campaign targeting module identifying target users by comparing traffic campaign parameters with user data comprising user-selected origin and destination pairs, and determining at least one available travel option from the targeted shift in transit behavior for a user; iv) a transit suggestion module determining a transit suggestion for each available travel option according to a reward profile associated with the targeted shift in transit behavior for the user, and presenting the at least one available travel option and the transit suggestion to the user. In some embodiments, the user data comprises historical user transit behavior. In some embodiments, the historical user transit behavior comprises departure time, mode of transportation, and route traveled for past trips. In some embodiments, the user data comprises a user-selected origin and destination pair, preferred travel time, mode of transportation, or any combination thereof for a current or upcoming trip. In some embodiments, the user data comprises activity or lifestyle, personality, socio-demographic, geo-relation, corridor relation, or any combination thereof. In some embodiments, the campaign builder module allows sorting or filtering based on activity or lifestyle, personality, socio-demographic, geo-relation, corridor relation, or any combination thereof for identifying the at least one target user. In some embodiments, geo-relation indicates a user-selected origin and destination pair that matches a location targeted by the traffic campaign for reducing congestion. In some embodiments, corridor relation indicates a user-selected origin and destination pair that matches a route targeted by the traffic campaign for reducing congestion. In some embodiments, the user data is obtained from GPS points, microsurveys, social media, email, or any combination thereof. In some embodiments, the GPS points are a source of user data comprising geo-relation, corridor relation, activity or lifestyle, or any combination thereof. In some embodiments, the microsurveys are a source of user data comprising activity or lifestyle, socio-demographic, psychographic, or any combination thereof. In some embodiments, social media is a source of user data comprising socio-demographic. In some embodiments, the computer software server system further comprises a microsurvey module presenting at least one user with at least one question and an incentive offer for answering the at least one question. In some embodiments, the microsurvey is triggered to present the at least one question and the incentive offer based on the user data, wherein the user data is indicative of a current state of the at least one user. In some embodiments, the current state of the at least one user comprises current time, physical location, and interaction with at least one of the plurality of electronic device applications. In some embodiments, the transit suggestion is selected based on responsiveness to past transit suggestions for the at least one user. In some embodiments, the at least one question is selected based on relevance to the at least one user. In some embodiments, a reward profile comprises personalized transit suggestions associated with different modes of transportation, departure time windows, routes, or any combination thereof. In some embodiments, modes of transportation comprise driving, biking, bus, train, ride-sharing, carpooling, subway, trolley, taxi, walking, scooter, microtransit, or any combination thereof. In some embodiments, modes of transportation comprise a plurality of modes of transportation and a transit suggestion associated with each of the plurality of modes of transportation. In some embodiments, a reward profile comprises a plurality of departure time windows and a transit suggestion associated with each of the plurality of departure time windows. In some embodiments, a reward profile comprises a plurality of departure time windows proximate to a preferred travel time. In some embodiments, a reward profile comprises a plurality of routes and a transit suggestion associated with each of the plurality of routes. In some embodiments, a reward profile is adjusted to provide an incentive corresponding to the targeted shift in transit behavior. In some embodiments, the traffic campaign comprises location, duration, and targeted number of users. In some embodiments, the transit suggestion module offers incentives to the at least one target user based on reward profiles of said target user so as to maximize the targeted shift in transit behavior. In some embodiments, the transit suggestion module continues offering transit suggestions to target users until the targeted number of users have accepted the targeted shift in transit behavior or performed the targeted shift in transit behavior. In some embodiments, comparing the user data with traffic campaign parameters comprises determining a geo-relation or corridor relation between users and the location of the traffic campaign. In some embodiments, the campaign targeting module dynamically identifies target users by receiving current or upcoming transit information from the target users and comparing the transit information with traffic campaign parameters. In some embodiments, the campaign targeting module identifies target users by comparing traffic campaign parameters with user data before receiving current or upcoming transit information from the target users. In some embodiments, the campaign targeting module presents transit suggestions to target users in an order that maximizes an adoption rate for the targeted shift in transit behavior for a targeted number of users. In some embodiments, the targeted shift in transit behavior is a shift in mode of transportation, a shift in departure time, a shift in route, or any combination thereof. In some embodiments, the shift in mode of transportation comprises a change from driving to biking, bus, train, walking, or any combination thereof. In some embodiments, the shift in departure time comprises multiple departure time windows proximate in time to a preferred travel time for a user-selected origin and destination pair, wherein each of the departure time windows corresponds to a time interval when a user is to depart from the origin and travel along a route toward the destination. In some embodiments, the shift in route comprises at least one additional route distinct from a preferred route for a user-selected origin and destination pair. In some embodiments, the transit suggestion has no monetary value. In some embodiments, the transit suggestion is selected to appeal to a lifestyle, socio-demographic, or psychographic aspect of the at least one user. In some embodiments, the computer software server system further comprises an analytics module calculating results of the traffic campaign. In some embodiments, the results comprise number of users shifted, change in average travel speed, average cost per user shifted, or any combination thereof. In some embodiments, the traffic campaign is a static campaign configured by an administrative user. In some embodiments, the traffic campaign is a dynamic campaign that is automatically configured in response to one or more traffic events. In some embodiments, the electronic device is a mobile device, a tablet, a laptop, a computer, or a vehicle console. In some embodiments, the software server system further comprises a validation module receiving location information from one of the plurality of electronic device applications, and verifying that the user has departed from the origin during a selected departure time window, traveled along at least a portion of the route thereafter, and utilized a selected mode of transportation according to one of the at least one available travel option.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A depicts an upper portion of a block diagram illustrating a reservation process of an traffic management system;

FIG. 1B depicts a lower portion of the block diagram illustrating a validation and post transaction process of the traffic management system shown in FIG. 1A;

FIG. 2A depicts a departure time selection display screen of a mobile device executing a mobile device application of the traffic management system shown in FIGS. 1A and 1B;

FIG. 2B depicts another embodiment of a departure time selection display screen of the electronic device application;

FIG. 2C depicts a route selection display screen of the electronic device application;

FIG. 2D depicts an incentive selection display screen of the mobile application;

FIG. 3A and FIG. 3B depict a flow chart of an exemplary process for implementing the traffic management system shown in FIGS. 1A and 1B;

FIG. 4 depicts a flow chart of an exemplary process for using the traffic management system shown in FIGS. 1A and 1B;

FIG. 5 depicts a diagram of a hardware environment and an operating environment in which one or more computing devices associated with the active traffic and demand management system and mobile devices may be implemented;

FIG. 6A depicts a another diagram of various modules and information repositories of an exemplary traffic management system;

FIG. 6B depicts an exemplary embodiment of various types of user profile data or user data;

FIG. 6C depicts an exemplary embodiment of various types of user historical activity data;

FIG. 6D depicts a user network activity graph;

FIG. 6E depicts a flow chart of an exemplary process for generating a recommendation for a particular multimodal transportation and trip chain to a user;

FIG. 7 depicts a dashboard or graphical user interface that allows an administrator or administrative user to setup campaigns with transportation options that can be targeted based on micro targets (user data or parameters) and reward profiles;

FIG. 8 depicts exemplary micro targets and reward profiles for transportation mode changes;

FIG. 9 depicts exemplary data sources of exemplary user data types;

FIG. 10 depicts a diagram showing various information sources that go into providing multi-modal travel options to a user;

FIG. 11A and FIG. 11B depict displays of a user electronic device providing various travel options;

FIG. 12 depicts an exemplary embodiment of a reward profile for various departure times throughout the day;

FIG. 13A depicts a display of a user electronic device providing various travel options;

FIG. 13B depicts a display of a user electronic device showing a scheduled travel option;

FIG. 13C depicts a display of a user electronic device showing a navigation map of the user in transit;

FIG. 13D depicts a display of a user electronic device showing arrival at the destination and information about the trip;

FIG. 14 depicts an exemplary dashboard or graphic user interface of a traffic management system for use by an administrator to setup, deploy, monitor, and review traffic campaigns;

FIG. 15 depicts a diagram showing various information that go into sending a microsurvey to a user;

FIG. 16A, FIG. 16B, and FIG. 16C depicts an exemplary sequence of images displayed by a user electronic device for showing the presentation and answering of a microsurvey;

FIG. 17A, FIG. 17B, and FIG. 17C depict an exemplary set of images displayed by a user electronic device showing options for redeeming incentive points or credits; FIG. 17D depicts an exemplary image displayed by a user electronic device showing psychological incentives; FIG. 17E depicts an exemplary image displayed by a user electronic device showing user driving scores;

FIG. 18A, FIG. 18B, and FIG. 18C show an exemplary web-based campaign setup;

FIG. 19 depicts an interactive map allowing an administrator to select a corridor or area to target during setup of a traffic campaign;

FIG. 20 depicts an interface allowing an administrator to select a corridor or area to target, a time range, and a duration range during setup of a traffic campaign;

FIG. 21A, FIG. 21B, FIG. 21C, FIG. 21D, FIG. 21E, FIG. 21F, and FIG. 21G depict an exemplary set of images displayed by a user electronic device showing non-monetary transit suggestions;

FIG. 22A depicts an image displayed by a user electronic device showing details of a ride-share trip;

FIG. 22B and FIG. 22C depict maps showing a trip in progress as displayed by a user electronic device;

FIG. 23A, FIG. 23B, and FIG. 23C depict exemplary images of a microsurvey displayed by a user electronic device;

FIG. 24A shows an exemplary dashboard of a traffic campaign application for configuring traffic campaigns;

FIG. 24B, FIG. 24C, FIG. 24D, FIG. 24E, FIG. 24F, FIG. 24G, FIG. 24H, and FIG. 24I depict exemplary images showing steps for configuring a traffic campaign using the traffic campaign application;

FIG. 25 shows a diagram of an embodiment of a traffic campaign manager application server and associated components for configuring and implementing traffic campaigns;

FIG. 26 shows a diagram depicting an embodiment of the relationship between a user electronic device and a traffic campaign application server;

FIG. 27 shows a chart depicting transit suggestions and the relationship between difficulty of the transit suggestions and corresponding requisite incentives;

FIG. 28 shows a diagram of an algorithm for generating travel options; and

FIG. 29 shows a diagram depicting various modules for making predictions.

### DETAILED DESCRIPTION

Provided herein are systems, servers, devices, media, and methods for managing traffic using targeted incentive offers to shift transit behavior. In some embodiments, the targeted incentive offers are merely informational or psychological. Alternatively, in some cases, the targeted incentive offers are monetary and/or have financial value. In some embodiments, user data is obtained from one or more sources and used to generate reward profiles that delineate incentives corresponding to transportation mode options. In some embodiments, sources of user data include one or more of user registration information, microsurveys, GPS or locationing component of a user electronic device, social media, public databases, government agency databases, database(s) of the traffic management system or server, and other sources of information. In some embodiments, the microsurveys are targeted and/or user-specific to enhance predictive accuracy of the user's reward profile. In some embodiments, these reward profiles are personalized to individual users such that a population of users forms a distribution of varying reward profiles that are tailored to their individual preferences and/or needs. A traffic management system or server application provides an interface allowing administrative users to setup and configure targeted traffic campaigns. In some embodiments, a traffic campaign is configured with various parameters including a target shift in transit behavior. In some embodiments, the target shift in transit behavior includes one or more of a change in mode of transportation, a change in route, or a change in departure time. Additional campaign parameters can include campaign budget, location (geographic area and/or corridor), target number of vehicles/users, campaign duration and/or schedule (e.g., start and end dates, start and end times of the day), and other factors. In some embodiments, the user device has a stand-alone mobile application for receiving targeted transit suggestions.

Once the campaign is configured, it can be launched according to the campaign schedule. In some embodiments, the traffic management system then selects target users by comparing user data to the campaign parameters. In some embodiments, user selection goes through one or more steps or filters. As an example, one user selection step includes sorting or filtering for users who have entered an origin and destination pair for a trip that matches or falls within the scope of the traffic campaign (e.g., the origin, destination, and/or route in-between falls within the geographic area and/or corridor targeted by the traffic campaign). Another example of a user selection step is sorting or filtering for users whose reward profiles indicate an incentive cost for the targeted shift in transit behavior that is below a certain threshold (e.g., selecting users whose cost of shifting transit behavior is relatively low in order to maximize efficient user of the campaign budget). In some embodiments, an administrator pre-screens target users while setting up the campaign. As an example, a campaign is configured to target only SUV drivers. Next, selected target users are sent incentive offers that fall within the scope of the traffic campaign. As an example, a campaign is configured to offer SUV drivers incentives to switch to a different mode of transportation but not for changing departure time or route (e.g., the campaign is designed to reduce the number of SUV drivers on the road).

In some embodiments, the traffic campaign is a static campaign with duration, schedule, and various parameters configured by the administrator. Alternatively or in combination, a traffic management system automatically launches a campaign to respond to dynamic events (“dynamic campaign”) such as a traffic accident that has caused significant traffic congestion (such dynamic events are detectable using various methods such as, for example, traffic monitoring software, google maps, location data from users, etc.). In one embodiment, FIG. 18C shows a traffic management system interface allowing an administrator to select specific corridor(s) to target with a traffic campaign or to allow automated route management in which the traffic campaign automatically adjust transit options (e.g., route, mode of transportation, time of departure, etc.). These dynamic campaigns provide incentives to reduce the detected congestion and typically do not require an administrator to configure every parameter. In some embodiments, a dynamic campaign is launched automatically without administrator permission or requires a final decision by an administrator once the campaign has been configured. The administrator optionally sets triggers for dynamic campaigns (e.g., launching a dynamic traffic campaign to alleviate congestion once a certain threshold level of congestion has been reached such as average mph falling below 20 mph).

In some embodiments, a user has the option of accepting an incentive offer. Alternatively, a user implicitly accepts the offer by performing the targeted shift in transit behavior according to the terms of the incentive offer. In some embodiments, the traffic management system monitors the user to determine whether the user has carried out his/her part of the bargain according to the incentive offer. In some embodiments, the user is monitored using location data from the user's electronic device (e.g., cell phone, vehicle dashboard). In some embodiments, the user is monitored using data from a user app or other database (e.g., receiving confirmation from a ride-sharing app or database that the user made the trip using the targeted ride-sharing mode of transportation instead of driving).

In some embodiments, the traffic management system provides an exchange (“reward shop”) allowing users to trade in earned incentives for rewards. As an example, a user uses the exchange to trade points for coupons, discounts, rebates, parking passes, or various other rewards. In some embodiments, the traffic management system provides user accounts linked to individual users that tracks user information such as earned incentives.

In some embodiments, the traffic management system provides analytics to evaluate a traffic campaign. In some embodiments, the analytics are calculated and updated in real-time while the campaign is in progress. In some embodiments, the analytics are generated after the campaign is over. Analytics provide metrics that help administrators evaluate the success of the traffic campaign such as reduction in the number of drivers along a targeted corridor.

Traffic Management System

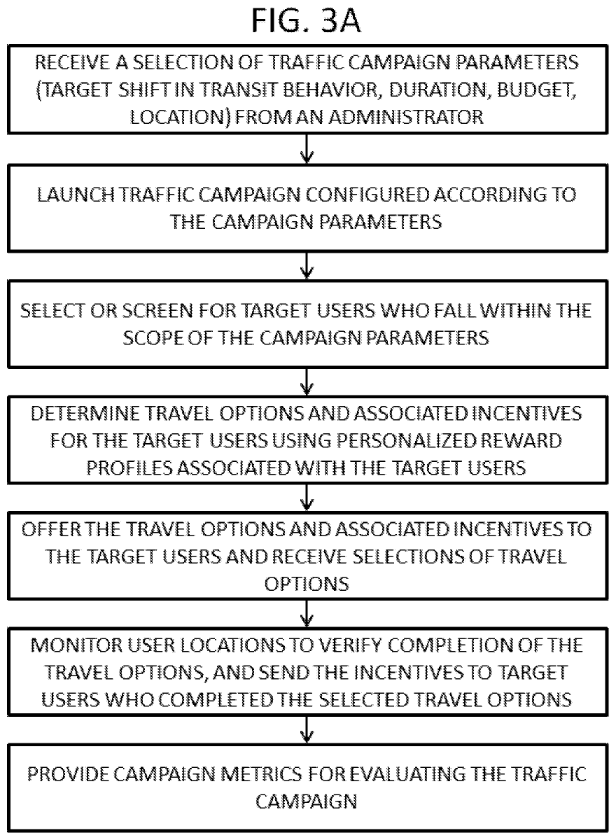

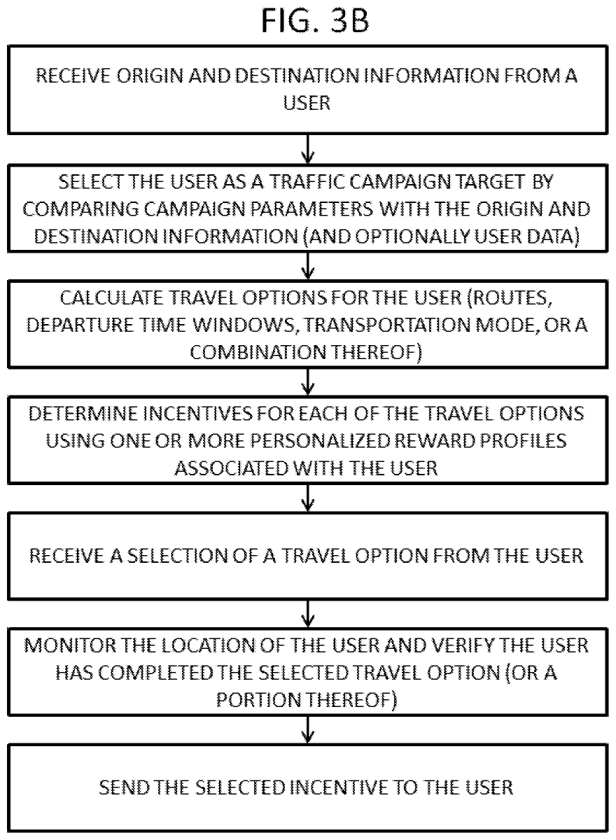

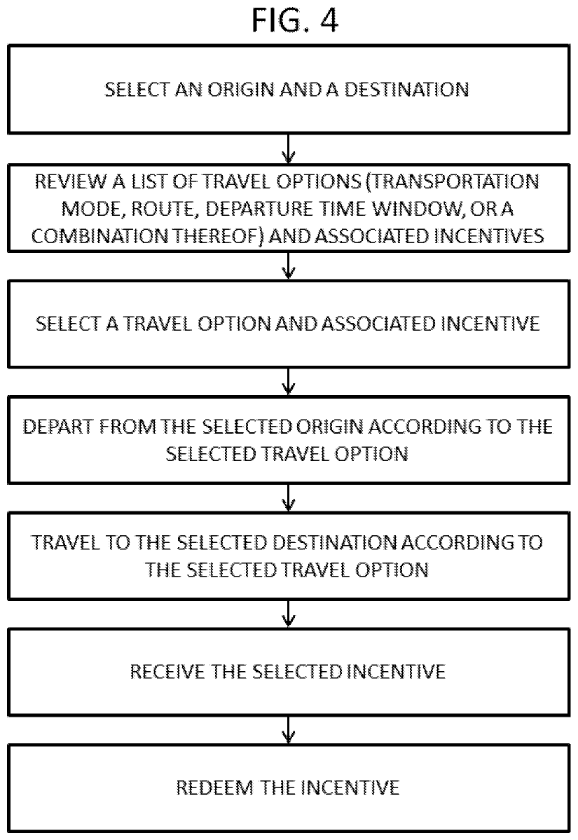

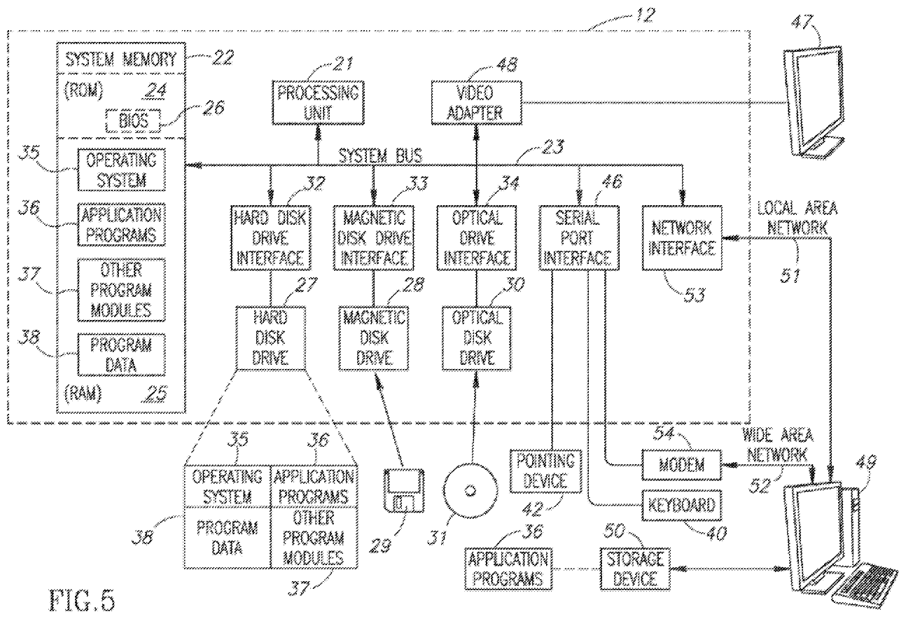

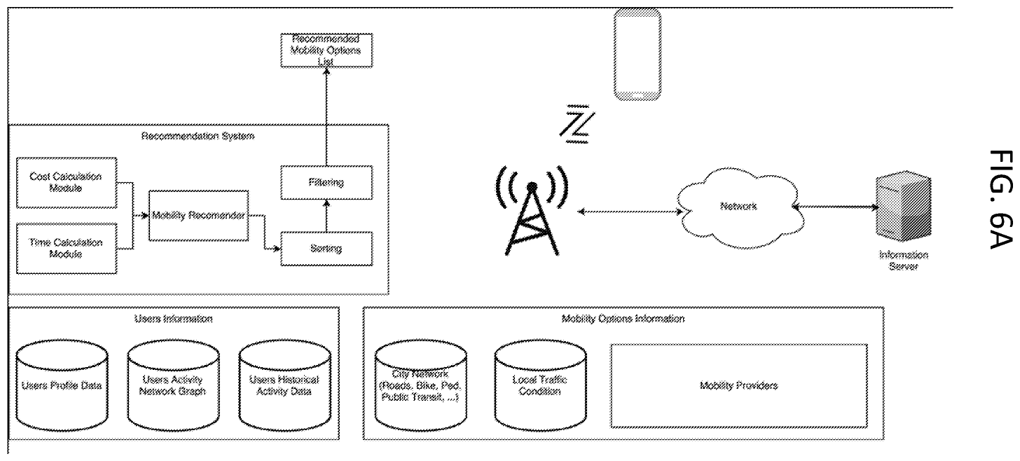

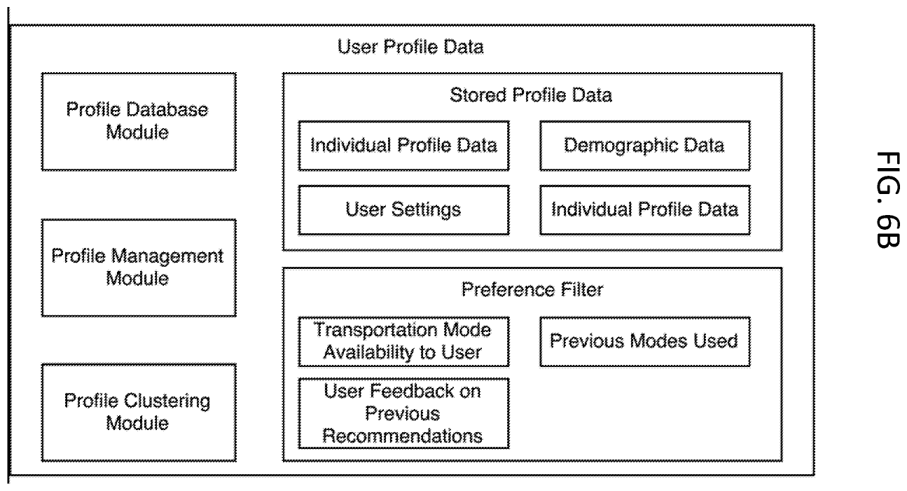

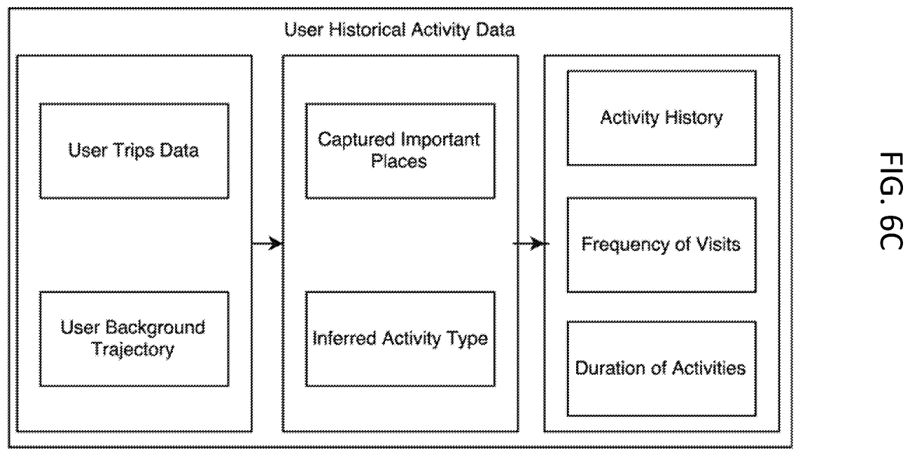

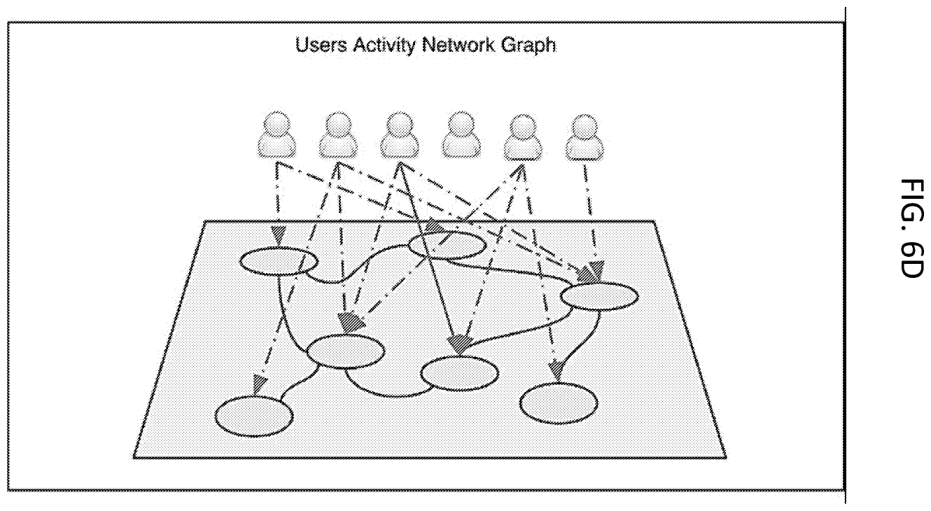

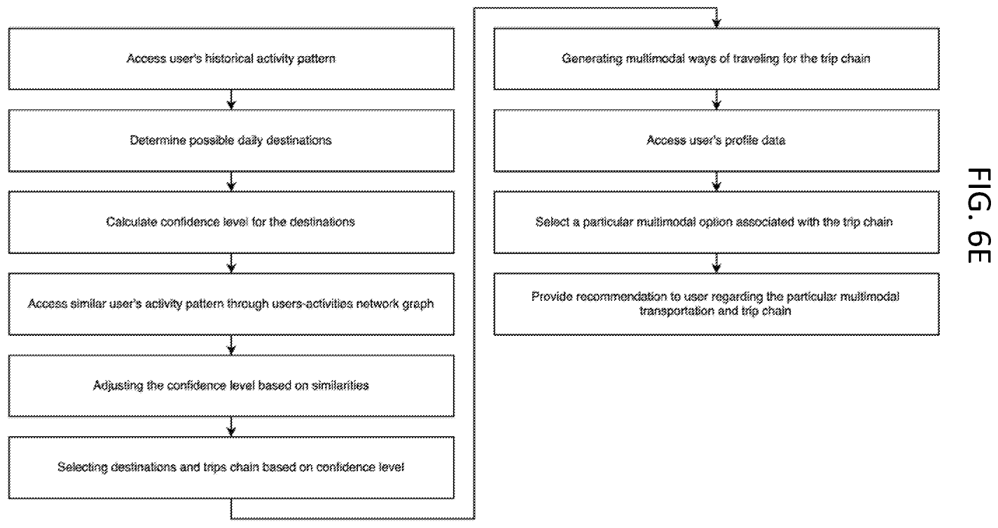

Embodiments of the present disclosure relate to systems and methods for providing incentives for the travelling public to travel according to travel options that help alleviate traffic congestion. In some embodiments, the desired goal is not alleviating traffic congestion but for a different purpose such as, for example, reducing the incidence of drunk driving (incentivizing ride-sharing or mass transit around bar locations at night on weekends), increasing adoption of an alternative transportation mode (incentivizing use of a new bus line to the beach), or increasing population health (e.g., incentivizing bicycling). As used herein, traffic refers to the flux or passage of vehicles and/or pedestrians on roads, the commercial transport and exchange of goods, the movement of passengers or people, and the like. In some embodiments, the systems described herein such as a traffic management system include at least two components: a computer server software system that includes various algorithms or modules and database sub-systems; and an electronic device application for execution on users' electronic devices. In some embodiments, an electronic device is a mobile phone, smartphone, desktop computer, laptop, tablet, vehicle console, or other digital processing device. FIG. 3A provides one embodiment of a process for launching and/or running a traffic campaign. FIG. 3B provides one embodiment of a process by which the traffic campaign provides an incentive to a user for shifting transit behavior. FIG. 4 provides one embodiment of the process by which a user interacts with a software application on the user device to engage in an incentive-based shift in transit behavior.

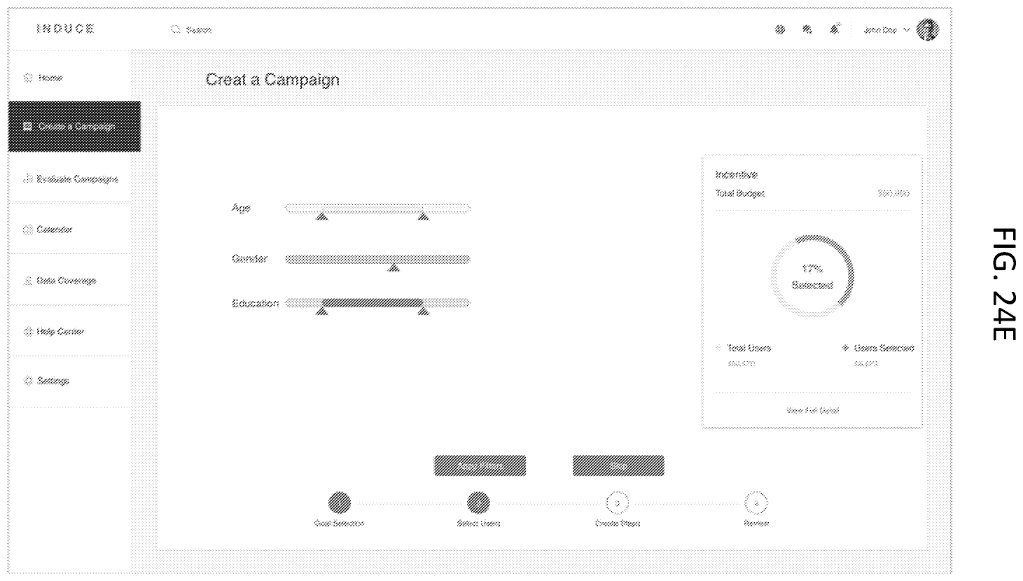

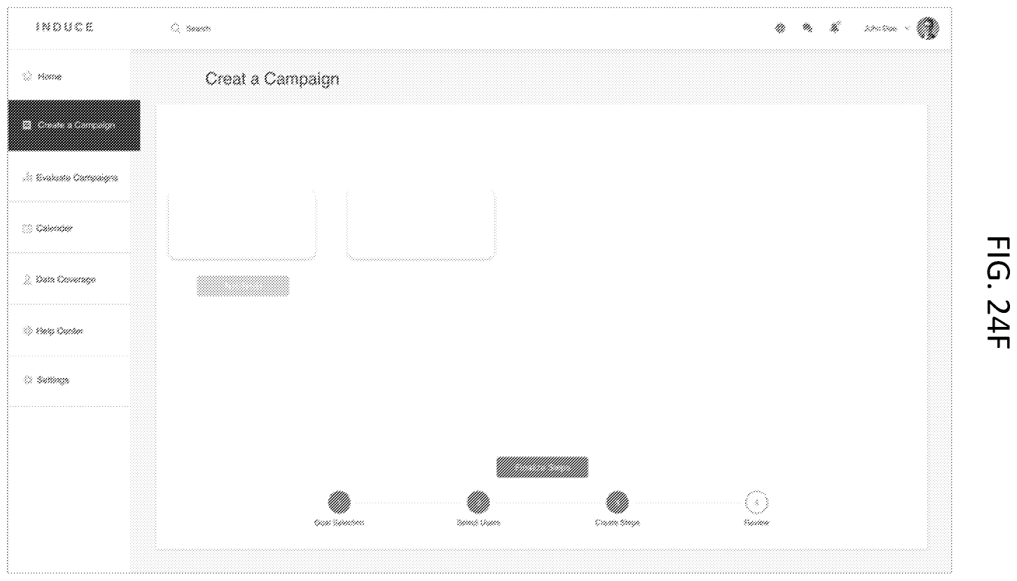

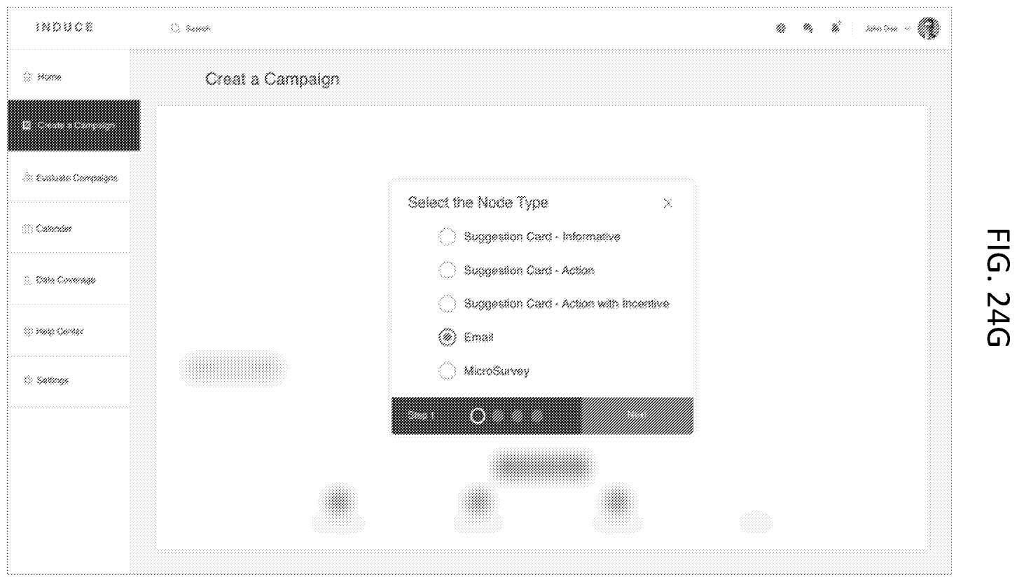

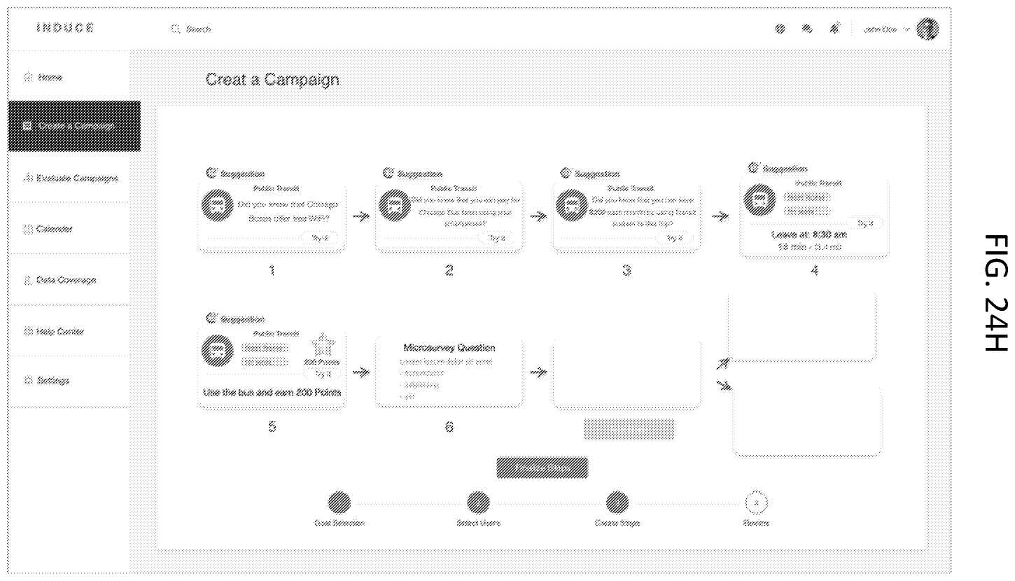

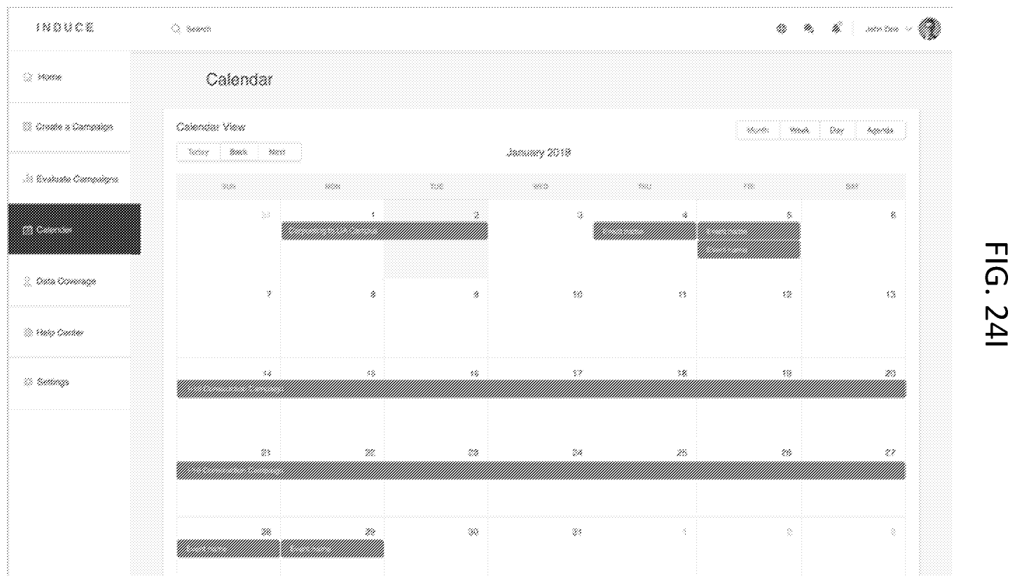

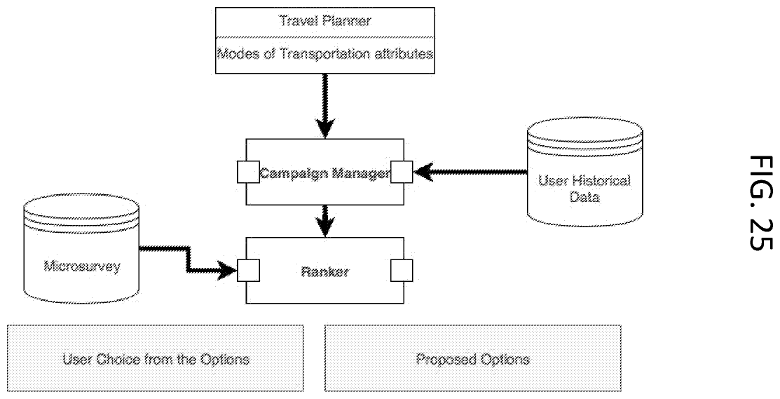

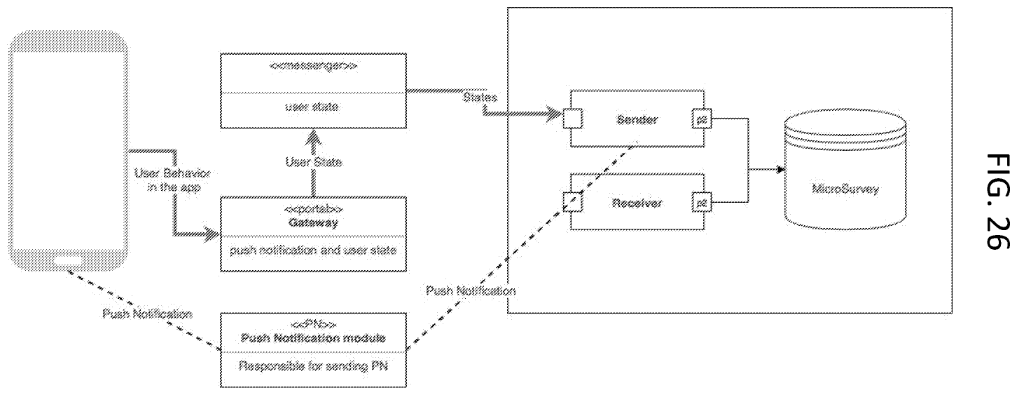

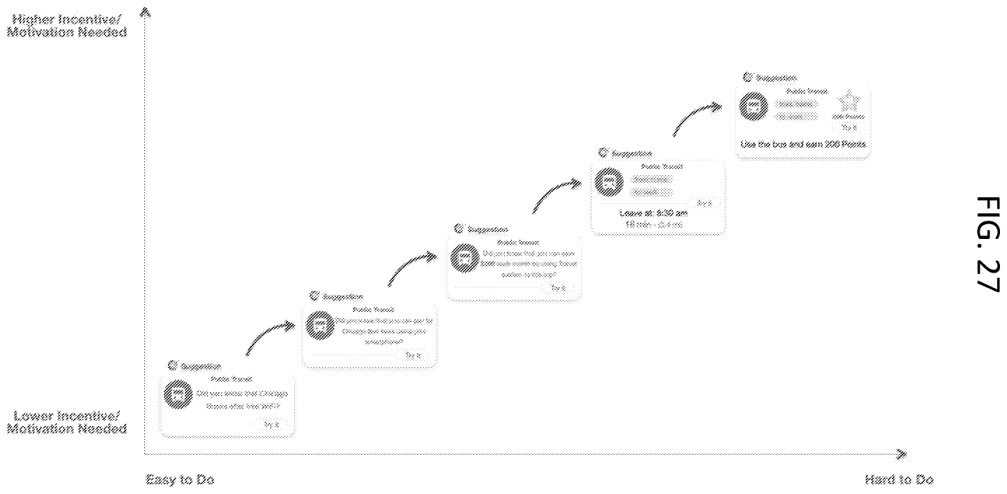

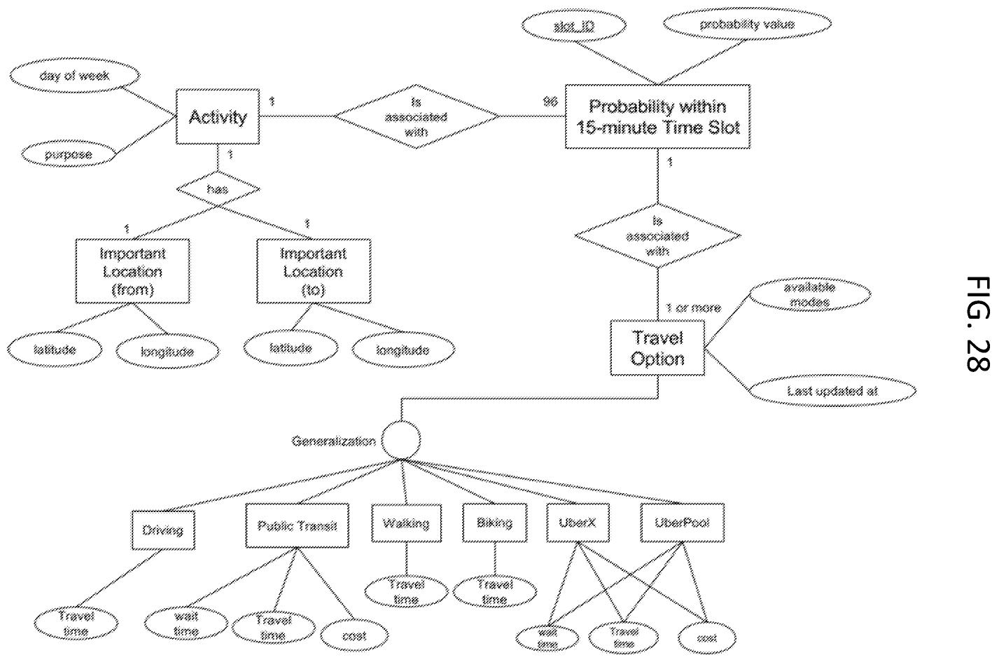

Embodiments of the traffic management system allow the configuration and launch of traffic campaigns for modulating user transit behavior. In some embodiments, a system provides an interface allowing administrators to setup and configure targeted traffic campaigns. Examples of the interface showing options for configuring traffic campaign parameters are shown in FIGS. 18A-18C. In some embodiments, a traffic campaign is configured with various parameters including a target shift in transit behavior. In some embodiments, the target shift in transit behavior includes one or more of a change in mode of transportation, a change in route, or a change in departure time. In some embodiments, modes of transportation include driving, biking, bus, train, walking, carpooling, ride-sharing, or a combination thereof. In some embodiments, modes of transportation are provided in greater detail such as, for example, vehicle type (sports car, 4-door sedan, minivan, van, bus, RV, SUV, etc.). Examples of other campaign parameters include campaign budget, location (geographic area and/or corridor), target number of vehicles/users, campaign duration and/or schedule (e.g., start and end dates, start and end times of the day), and other factors. Specific geographic targets such as geo-relation or corridors can be selected using an interactive map, which optionally shows traffic patterns or congestion (current, historical, or predicted future traffic) (see FIG. 19). In some embodiments, the campaign management system interface provides statistical data and other performance metrics for evaluating specific geo-relations or corridors. For example, FIG. 20 shows a calendar with selected date, a selected corridor, and traffic congestion metrics for the selected corridor on the selected date. In some embodiments, traffic congestion for the date is shown in a histogram or chart compared to other dates over some time period such as for the month or year (e.g., showing the relative congestion of a given date for the past six months). In some embodiments, the interface provides an overview of a particular region comprising one or more metrics or parameters informative of the traffic and/or drivers/users in the region. For example, FIG. 24A shows the percentage of users in a behavior change campaign (e.g., traffic campaign targeting a shift in transit behavior). The top four modes of transportation for each day of the week are also shown as well as the number of users from month to month. In addition, a chart showing the amount of incentives and number of users incentivized over a timeline are shown at the bottom of FIG. 24A. In some embodiments, the interface provides traffic campaign configuration options for creating a campaign such as shown in FIGS. 24B-24I). FIG. 24B shows a goal selection step displaying various selectable shifts in transit behavior including transportation mode change to public transit, mode change to carpooling, departure time change, and route change. FIG. 24B also shows additional campaign options that can be configured including select users (e.g., targeting specific group of users based on user data). In some embodiments, campaign parameters are customized to target specific users or groups of users based on user data. As an example, a campaign is configured to target drivers who own vehicles with low gas mileage (e.g., below 10 mpg), which can encompass multiple vehicle types. As another example, a campaign is configured to target young drivers (e.g., age 25 or younger) traveling to and from a music festival (e.g., origin or destination selected by a user is in proximity to the festival location) in attempting to shift their transit behavior towards mass transit to reduce incidences of drunk driving and/or traffic fatalities. FIG. 24C shows the number and percentage of users selected under the traffic campaign and the budget allocated to the campaign. FIG. 24D shows a step for selecting a corridor to target with the traffic campaign (e.g., a particularly congested bridge). FIG. 24E shows other user selectable parameters such as options to target users based on maximum and/or minimum age, gender, and level of education. Other examples of micro-targeted user parameters are shown in FIG. 18B including lifestyle, gender, and personality as well as geographical targets such as geo-relation and corridor. Accordingly, in some embodiments, the system allows administrators to select, screen, or filter users based on user data. The system allows these users to be targeted as part of a traffic campaign.

In some embodiments, after a traffic campaign has been launched, the system identifies target users and selects those who are suitable for receiving an incentive offer. In some embodiments, target users are sent incentive offers ahead of an upcoming trip. For example, a user enters the origin and destination for a future trip with a preferred departure and/or travel time that is set a few days in the future. The electronic device application transmits this information to the server of the traffic management system. In this example, the traffic campaign is configured to make incentive offers ahead of time (e.g., not in real-time), so the system sends incentive offers to the user for shifting transit behavior. Alternatively, in some embodiments, target users are sent incentive offers when they use the electronic device application to enter information for a current trip they are about to make (e.g., preferred departure time is within 30 minutes of the current time). In some embodiments, the difference between a future trip and a current is a matter of degree and is optionally configured by an administrator. For example, an administrator sets a 30 minute cut-off time such that preferred departure times that are less than or equal to 30 minutes from now quality as a current trip, while preferred departure times that are later than 30 minutes from the current time qualify as a future trip. In some embodiments, the traffic campaign is configured to target users for current trips, future trips, or both. In some embodiments, the traffic campaign is configured to target users through one or more electronic communication methods such as email, microsurvey, transit suggestion, or other means. In some embodiments, the interface allows an administrator to configure one or more nodes, optionally in a sequence, as part of the campaign such as suggestion card informative, suggestion card action, and suggestion card incentive (see FIG. 24G). In this case, the suggestion card informative comprises an informational incentive (e.g., just provides information of alternative travel options). The suggestion card action can be a suggested course of action (e.g., offer to adopt an alternative travel option). The suggestion card incentive can be an incentivized course of action (e.g., offer a reward for adopting an alternative travel option). In some embodiments, the nodes are emails or microsurveys. In some embodiments, the nodes are configured in a sequence such as seen in FIG. 24H. For example, the nodes may be presented in a particular order to users. In some cases, a succeeding node is presented to a user after the preceding node has been viewed. In some cases, the nodes progress from informational to suggestion to incentivized shifts in transit behavior as shown in FIG. 24H. FIG. 24I shows a calendar with various configured traffic campaigns such as carpooling and construction campaigns.

In some embodiments, selection of target users to receive incentive offers comprises comparing user data against campaign parameters. In some embodiments, the selection process includes one or more filtering or screening steps. In some embodiments, a target use is selected after successfully passing one or more filtering or screening steps. In some embodiments, selection comprises identifying users who have entered an origin and destination pair for a trip that falls within the scope of the traffic campaign or one or more traffic campaign parameters. In some embodiments, selection comprises determining that an origin or destination that is located within and/or in proximity to a targeted geographic area of a traffic campaign. In some embodiments, selection comprises determining one or more routes for traveling between the origin and destination that fall within a targeted geographic area (e.g., a city's downtown area) and/or a targeted traffic corridor (e.g., road or highway). In some embodiments, selection comprises identifying users based on user data that matches or falls within a campaign parameter. For example, a campaign parameter is configured to target users based on activity/lifestyle information obtained from social media such as targeting users who have posted comments or links relating to bicycling with incentive offers to commute via bicycling (e.g., for those who live within a threshold distance to work such as 5 miles).

In some embodiments, user data includes any of the following: activity, lifestyle, personality/psychographic, socio-demographic, geo-relation, or corridor relation. As used herein, corridor relation refers to proximity of a route to a targeted traffic corridor. As used herein, geo-relation refers to proximity of an origin, destination, and/or route to a targeted geographic area. In some embodiments, sources of user data include one or more of user registration information, microsurveys, GPS or locationing component of a user electronic device, social media, public databases, government agency databases, database(s) of the traffic management system or server, and other sources of information. In some embodiments, the traffic management system uses web crawlers to mine data from various data sources such as government agency databases/sites or social media sites. In some embodiments, user data from social media sites comprises data mined from user blog postings, linked content, comments, subscribed content, and other publicly available user information. In some embodiments, user data obtained from social media sites includes keywords (e.g., keyword frequency). As an example, user data is mined from social media sites for keywords relating to drinking and/or driving. In addition, public court records may be mined for information relating to past DUIs and driving infractions. Accordingly, in this example, a traffic campaign can be constructed to target users who are at greater risk of having a traffic incident based on analysis of the user data.

In some embodiments, user data comprises trip information such as one or more of origin and destination pair, route(s) between the origin and destination pair, departure time, and mode of transportation. In some embodiments, the trip information is for past trips. In some embodiments, the trip information is for current or upcoming trips. In some embodiments, trip information for past trips is used to inform a traffic campaign and/or develop reward profile(s) for the user. For example, a user who frequently takes a certain route for his commute is inferred to have a route preference. Accordingly, this information can be incorporated into the user's reward profile for routes by adjusting upwards the incentive for shifting the user to a different route.

In some embodiments, various datasets are incorporated for estimating or predicting traffic conditions. Such datasets include GPS travel/drive cycles (e.g., obtained from user devices), digital street maps (e.g., Google maps), traffic speeds, elevation/grade (e.g., elevation/grade of a road or route can impact fuel economy and/or driving speed), ambient temperature, freight volumes, vehicle registrations, solar intensity, overall road volumes, and relevant datasets relevant to road or traffic conditions.

In some embodiments, microsurveys are used to obtain user data by asking questions. In some embodiments, the microsurveys are targeted and/or user-specific to enhance predictive accuracy of the user's reward profile. In some embodiments, the system sends microsurveys to users via their electronic device applications. In some embodiments, a microsurvey comprises at least one query or question. In some embodiments, a microsurvey is accompanied by an incentive offer for answering the microsurvey. In some embodiments, an increased incentive offer is made to the user when the user refuses to answer the microsurvey the first time. In some embodiments, microsurvey questions are stored in a question bank (e.g., on a database of the traffic management system). In some embodiments, the incentive offer made to the user for answering the microsurvey is based on a microsurvey reward profile. In some embodiments, the microsurvey reward profile is generated using user data comprising past microsurvey responses. In some embodiments, a microsurvey question is selected for the user based on past microsurvey responses. As an example, a user is not asked the exact same question twice (unless it is a context-dependent question that is expected to provoke a different answer depending on the user's state or other factor). In some embodiments, microsurvey are presented to a user in a sequence and/or as part of a logic tree. As an example, a first microsurvey question asks what type of vehicle the user drives. When the user selects SUV in response, a subsequent microsurvey question asks for the make/model. This information can be used to extrapolate certain information such as vehicle mileage, for example.

In some embodiments, a user is prompted with a microsurvey and associated incentive based on a trigger. In some embodiments, a microsurvey is triggered based on the user's state (e.g., time, location, interaction with device application). In some embodiments, a microsurvey is triggered based on time of day, user's physical location, user's interaction with the electronic device application, or a combination thereof. As an example, a microsurvey is triggered when the user's physical location is determined to be at or near the beach and asks the user how s/he got to the beach. As another example, a microsurvey is triggered when the user interacts with the electronic device application (since it shows the user's attention is on the device). As another example, the microsurvey is triggered right after the user arrives at home after commuting during rush hour and asks the user if s/he would be willing to consider alternative transportation options that reduce the length of the commute (e.g., when the user is primed to respond due to having just experienced a long rush hour commute).

In some embodiments, a microsurvey comprises a multiple choice question, a true/false question, a ranking question (e.g., ranking choices in order of preference), numbering question (e.g., entering or selecting a number indicative of degree of preference or agreement with the question prompt), or an open-ended question (e.g., a short answer question). Examples of microsurvey questions include: the purpose of a recent trip (e.g., the current trip the user has just entered or finished), the type of vehicle the user drives, workplace address, home address, hobbies, favorite travel destinations, most frequent travel destinations, vehicle occupancy (e.g., solo driver or carpooling, number of drivers in the vehicle), favorite or preferred incentives, ranking incentives in order of preference, preferred transportation modes (e.g., choosing favorite mode or arranging in order of preference), and willingness to try new things (e.g., alternative transportation modes).

In some embodiments, one or more reward profiles are generated for each user. In some embodiments, a reward profile comprises a distribution of transportation options and associated incentives. In some embodiments, a user has a reward profile for one or more of transportation mode, route, and departure time window. In some embodiments, a user has separate reward profiles for each of transportation mode, route, and departure time window. For example, a user can have a transportation mode reward profile, a route reward profile, and a departure time reward profile. In some embodiments, a reward profile is personalized for the user based on user data. In some embodiments, a reward profile is personalized based on user data comprising past transit behavior. In some embodiments, the past transit behavior includes responses to previous incentive offers. As an example, the reward profile(s) for a user who regularly refused previous incentive offers may have incentives that are adjusted upwards based on the expected high incentive cost to induce the user to accept the incentive offer. In some embodiments, users are given default reward profiles in the absence of user data. In some embodiments, reward profiles are adjusted based on user data as data is obtained. In some embodiments, reward profiles are adjusted according to preset rules. Examples of preset rules for adjusting a reward profiles include increasing an incentive for a specific transportation option by a set amount (e.g., 10 points) when a user refuses the transportation option and decreasing an incentive for a specific transportation option by a set amount when a user accepts the transportation option. In some embodiments, reward profiles are configured or adjusted beforehand based on historical user data. In some embodiments, reward profiles are configured or adjusted dynamically and/or in real-time based on a user response.

In some embodiments, administrative users/administrators configure static traffic campaigns that are targeted towards regular or recurring traffic patterns or traffic-affecting events that are predictable ahead of time (e.g., rush hour traffic congestion, seasonal traffic patterns such as more traffic towards the beach during summertime, sporting events, etc.). In such embodiments, administrators are able to configure the campaign.

In some embodiments, a campaign is configured with a campaign duration. In some embodiments, the campaign duration comprises the time during which the campaign is active. In some embodiments, the campaign duration comprises a particular time of day. In some embodiments, the campaign duration comprises a type of day (weekend, weekday, Monday, Tuesday, Wednesday, Thursday, Friday, Saturday, Sunday, holiday, business day). In some embodiments, the campaign duration comprises a date range (e.g., July 1 through August 31). In some embodiments, the campaign duration comprises a season (summer, fall, winter, spring). In some embodiments, the campaign duration comprises a dynamic time range that is determined using real-time or near real-time data. As an example, the campaign duration may be set to be active during morning time rush hour, which is configured as the period during which average speed falls below 40 mph anytime between 6 AM and 10 AM weekdays. Accordingly, the campaign is not activated until the traffic management system detects average traffic speed falling below 40 mph during that time-frame. On some days, the campaign is not activated at all because the 40 mph trigger is never met.

In some embodiments, a campaign is configured with a campaign budget. In some embodiments, a campaign budget comprises a maximum total budget for the entire duration of the campaign. In some embodiments, a campaign budget comprises a daily maximum budget that sets an upper limit on budgetary costs. In some embodiments, a campaign budget comprises specific budgets for different transportation options. For example, a budget is set for shifting transportation mode from self-driving to taking the bus, or a budget is set for shifting departure times outside of rush hour traffic. In some embodiments, a campaign budget comprises a budget per user that sets a ceiling on the cost of shifting transit behavior for each user. As an example, campaign may have a campaign budget that sets a maximum of 100 points per user per day for shifting routes during rush hour. In some embodiments, the campaign budget is delineated in points. In some embodiments, the campaign budget is delineated in monetary value such as in a currency. In some embodiments, the campaign is adjusted to compensate for going under or over-budget during previous time periods. In some embodiments, a campaign is configured to expend some or all of the campaign budget (e.g., configured to compensate for going under-budget until the surplus budget is expended). In some embodiments, a campaign is configured to preserve the budget once other goals have been met (e.g., shift in transit behavior for a specified target number of users has been reached).

In some embodiments, a campaign is configured with a target number of users. In some embodiments, the target number of users is the number of users who are sent an incentive offer (regardless of whether they accept and/or perform according to the offer). In some embodiments, the target number of users is the number of users whose transit behavior is to be shifted. In some embodiments, the target number of users is not expressly specified. For example, the target number of users can be a percentage of users. In some embodiments, the target number of users is a percentage of users identified as target users by the traffic management system, or alternatively, the percentage of users of total users. In some embodiments, the percentage of users is at least about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, or at least about 99% of target users. As an example, when a traffic campaign is configured to make an incentive offer to at least 1% of target users, the system identifies 1000 target users who fall within or match the campaign parameters, and then makes an incentive offer to 10 of those target users. In some embodiments, the target number of users is apportioned based on the campaign duration. For example, a campaign is configured with a target number of users for the entire duration of the campaign. Alternatively or in combination, the campaign is configured with a target number of users on a daily basis or for morning versus evening rush hour. In some embodiments, the target number of users varies (e.g., from day to day or from week to week) to compensate for going over or under previous target numbers. In some embodiments, compensating for going over or under previous target number of users is limited by the campaign budget.

In some embodiments, a campaign is configured with a campaign location. In some embodiments, the campaign location comprises a geographic area. In some embodiments, the geographic area comprises one or more grids. For example, the traffic management system may have a grid map of an area that allows an administrator to select grids to target with a traffic campaign. In some embodiments, the geographic area comprises an area enclosed by a boundary. In some embodiments, the boundary comprises artificial man-made structures such as a wall, a fence, a building, a road, or other physical structures. In some embodiments, the boundary comprises natural structures or boundaries such as a tree-line or a body of water such as a lake or river. In some embodiments, the boundary comprises a combination of artificial and natural components. In some embodiments, the boundary comprises political or governmental boundaries such as national borders or city/town/county limits. In some embodiments, the campaign location comprises a corridor. As used herein, a corridor refers to a roadway or path used for travel or transportation. In some embodiments, a corridor comprises a paved roadway such as a highway or local road. In some embodiments, a corridor comprises a non-paved roadway or path such as a dirt hiking trail. In some embodiments, a corridor comprises a paved or non-paved roadway or path for bicycling. In some embodiments, a campaign is configured with a plurality of campaign locations such as a combination of geographic area(s) and corridor(s). In some embodiments, the traffic management system selects users based in part on the geo-relation (proximity to the geographic area targeted by the campaign) and/or corridor relation (proximity to the corridor targeted by the campaign).

In some embodiments, the traffic management system automatically configures and launches dynamic traffic campaigns in response to dynamic traffic events. For example, traffic accidents, natural disasters, and other forms of unpredictable traffic-influencing events can occur suddenly and without warning. Therefore, in some embodiments, the traffic management system monitors traffic flow in real time and detects sudden slowdowns or alterations in traffic flow that is indicative of a traffic-altering event. In some embodiments, upon detection of the traffic event, the traffic management system launches a dynamic traffic campaign to reduce congestion resulting from the traffic event. In some embodiments, the administrator sets traffic thresholds that trigger the configuration and deployment of a dynamic traffic campaign. As an example, a traffic threshold is set to be at least about 5, 10, 15, 20, 25, 30, 35, 40, 45, 50, 55, 60, 65, 70, 75, 80 mph such that detection of average traffic speed in an geographic area and/or route or corridor that falls below the traffic threshold triggers the launch of a dynamic traffic campaign. In some embodiments, the average traffic speed is determined by calculating a moving average of traffic speed calculated for a time window. As an example, the moving average traffic speed for a 1 mile section of an interstate highway is calculated by determining the average traffic speed for vehicles traveling along that section for a time window from 5 minutes ago until the current time. The use of time windows to calculate average traffic speed can help prevent temporary dips in speed from triggering a dynamic traffic campaign. In some embodiments, traffic speed data is obtained from one or more data sources such as public databases, electronic devices of users (e.g., mobile phone, vehicle console), or a traffic management system database. In some embodiments, a time window is set to be at least about 5, 10, 15, 20, 25, 30, 35, 40, 45, 50, 55, 60 seconds or more, or at least about 1, 2, 3, 4, 5, 6, 7, 8, 9, 10, 15, 20, 25, 30, 35, 40, 45, 50, 55, 60 minutes or more.

In some embodiments, a user enters an origin, destination, and preferred time of travel of an intended trip into the electronic device application. In some embodiments, a user enters a preferred mode of transportation, or the preferred mode of transportation is already stored on the electronic device and/or a database of the traffic management system. In some embodiments, this information is transmitted to the traffic management system or remote server system (“system”). In some embodiments, the system computes travel options for the user such as one or more routes for the trip, one or more departure time windows, one or more modes of transportation, or a combination thereof. In some embodiments, the system computes one or more incentives associated with the travel options. As an example, a travel option may comprise time windows or slots that are in 15 or 30-minute intervals. In some embodiments, a greater incentive may be offered if the system wishes to encourage the user to choose the travel option that would reduce congestion the most. Alternatively, a greater incentive is offered to encourage the user to choose the travel option that best satisfies a different campaign goal (e.g., reducing drunk driving). In some embodiments, the user's electronic device retrieves, for the intended trip, the travel options, which can include a plurality of departure time windows, transportation modes, and/or routes between the origin and destination, each having respective incentives from the system. In some embodiments, the user then makes a reservation (or “commitment”) accepting a travel option. In some embodiments, the incentives for the travel options are computed using one or more reward profile associated with the user.

When the user actually makes the selected trip, the user's device's global positioning system (GPS) function is activated and the mobile application compares the received GPS location information and the reserved route information to verify whether the user has traveled according to the selected travel option. In some cases, additional location determination methods are utilized such as, for example, Wi-Fi positioning for indoor locations or paths when GPS is less accurate. The location information can be used to determine whether the user has traveled along at least a threshold or minimum portion of the selected route during the specified time window. In some embodiments, the mode of transportation is ascertained by comparing the historical user location during the trip against known corridors or routes taken by various modes of transportation. For example, location data indicating the user has traveled along a bicycle trail at an average speed of greater than 10 mph but less than 20 mph suggests the user performed the travel option of bicycling. In some embodiments, this comparison is performed locally by the device application, and the user also has an option to allow the application to transmit the GPS location information to the remote server to receive additional real-time alert and guidance in times of unexpected network disruptions such as incidents. In some embodiments, this comparison is performed by the traffic management system or a server thereof. After the travel has been verified, the system or server then credits the user's account with the previously agreed upon incentive. The system may notify the user of receipt of the incentive via the user's electronic device, by email, or the like.

The system includes algorithms that are operative to analyze the historical and real-time traffic data for the one or more routes and for each route, to predict the departing time windows that would result in the least amount of impact to the route's congestion. As can be appreciated, if departure time windows are deemed to be undesirable from a traffic congestion management standpoint, minimal or no incentives may be offered for those time windows on a particular route. In some embodiments, the system includes algorithms that predict a destination location. In some embodiments, the algorithms predict a destination location based on user data (e.g., historical travel information and current location and trip details). In some embodiments, the algorithm predicts the destination location when the user enters trip details that do not include a destination location. In some embodiments, the algorithm predicts a next destination location based on trip details that already include a destination. For example, a user may enter travel or trip details to arrive at a first destination, but historical user data indicates this user often makes this trip followed by a second trip to a second location. In this case, the algorithm may predict a likelihood or probability that the user will make the second trip in this instance.

In some embodiments, exemplary incentives include discounts to various vendors along the traveling corridor, origin, and/or destination, or online vendors, and may be based on users' personal profiles and interests. In some embodiments, exemplary incentives also include certain points or credits that the user can use with other user accounts (e.g., credits to existing tolling accounts, reduced roadway tolling charges, credits to other merchant or airlines accounts, etc.) or within their system account. The points may be accumulated and redeemed for various goods and services. In some embodiments, incentives comprise non-monetary incentives. Examples of non-monetary incentives include psychological incentives such as a readout or message indicating CO2 savings, number of trees saved, fuel or gas savings, money saved on gas, and other psychological factors. In some cases, such psychological incentives may be more compelling for users than monetary incentives. Such users can be specifically targeted using user data. For example, users who frequently post environmental links/websites, make posts or comments with environmental keywords, and/or subscribe to environmental activist groups may be selected as target users for a traffic campaign that offers psychological incentives (e.g., a message stating that taking the bus for the morning commute will save 2.0 pounds of CO2). Psychological savings can be determined based on user data. For example, in some embodiments, CO2 savings are calculated based on user vehicle information (e.g., make/model/year), traffic predictions (e.g., low/medium/high traffic congestion can impact fuel economy), user driving style (e.g., average travel speed determined using GPS on user electronic device or from route distance and time of travel for completing the route), refueling data (e.g., based on stops made at gas stations or answers to microsurvey questions regarding fuel use). In some embodiments, predicted vehicle fuel use is calculated based on simulations using collected vehicle and road type/conditions/traffic data. The correlations between the specific vehicle and/or user with the road type/conditions/traffic data allows for more accurate calculation of predicted vehicle fuel use and associated fuel savings from shifts in transit behavior. Thus, in some embodiments, a user is presented with more accurate information on the benefits of the shift in transit behavior. In some embodiments, when the user is determined to have a driving style that affects fuel efficiency (e.g., aggressive driving that wastes gas), a suggestion is made to modify driving style (e.g., to drive less aggressively) or, alternatively, the user is praised for having an efficient driving style.

In some embodiments, psychological incentives include informational incentives. For example, a user may be unaware of alternative travel options such as, for example, alternative modes of transportation or of their availability and/or proximity. Accordingly, in some embodiments, informational incentives include information on alternative and/or available modes of transportation, alternative travel routes, alternative departure and/or arrival times, and other relevant travel information. For example, relevant travel information can include proximity of an alternative travel route to a restaurant or shop the user frequents. Alternative and/or available modes of transportation can include the various transportation modes described herein such as bus, train, subway, trolley, bike, walk, scooter, drive, taxi, ride-share, or shuttle and combinations of transportation modes (e.g., multimodal transportation). For example, multimodal transportation can be used in a route that includes a bike route and a train route that together connect the departure and destination locations for the trip. In some embodiments, the systems and methods described herein provide applications that communicate with or are operatively coupled to third party software or APIs such as, for example, ride-share services (e.g., Uber, Lyft). In some embodiments, the application accesses and requests a trip using a ride-share service based on user adoption or acceptance of a suggested travel option (with or without an incentive offer).

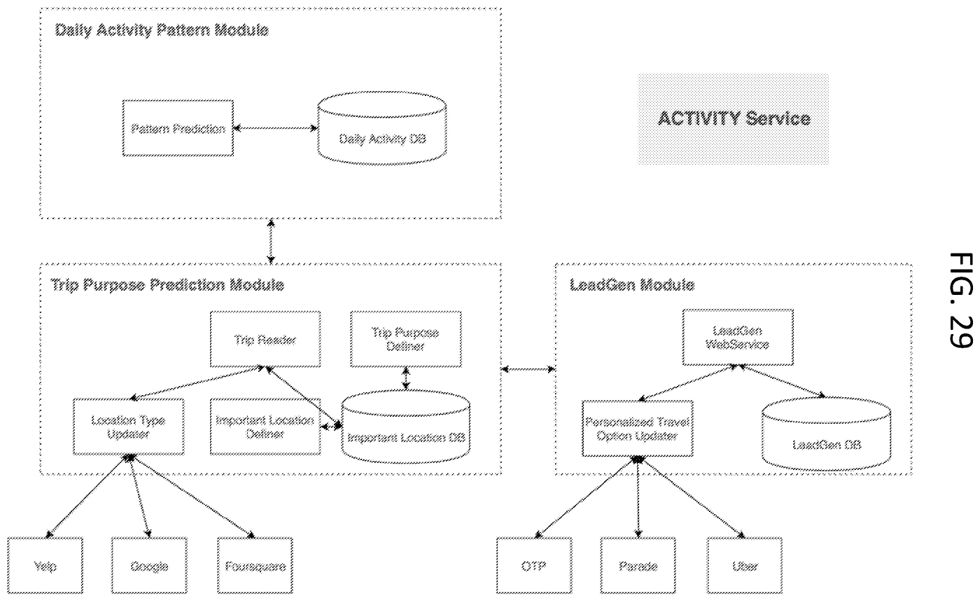

Informational incentives can also be referred to as transit suggestions. In some embodiments, a transit suggestion comprises information about one or more available and/or nearby alternative travel options. In some embodiments, the transit suggestion suggests or recommends that the user adopt one of the travel options. In some embodiments, the transit suggestion makes a recommendation to adopt a travel option based on a prediction about the user. Such predictions can be generated by any of the algorithms described herein and can include the predicted adoption rate of the travel option. In some embodiments, daily activity patterns are predicted such as, for example, repetitive daily travel behavior to and from work. In some embodiments, the trip purpose is predicted. Examples of software modules for making predictions are shown in FIG. 29, including daily activity pattern module, trip purpose prediction module, and leadgen module. These modules are optionally in communication with third party databases or services (e.g., Google, Yelp, Foursquare).

In some embodiments, psychological incentives comprise network incentives. In some embodiments, the user is given the option to post information about the trip to social media or other users. For example, a social media post can include details of a completed trip taking the train instead of driving and the accompanying CO2 and fuel savings. In some embodiments, the network incentive comprises social media posts. In some embodiments, the network incentives comprise information indicating that one or more individuals in the user's social media network or other users have also adopted or used the targeted transit shift. In this way, the network effects of the user can be leveraged to encourage user adoption of shifts in transit behavior.

In some embodiments, various incentives are combined to facilitate user adoption of shifts in transit behavior. In some embodiments, monetary incentives (e.g., incentives having financial value) and informational incentives are combined to provide challenges to users. For example, the challenge can be for the user to save a certain amount of fuel or CO2 and win a corresponding reward. In some embodiments, monetary incentives are combined with network incentives to create competitions. For example, users can compete for a reward based on who has traveled the longest total distance using green energy (e.g., electric vehicles) in a given time period. In some embodiments, informational incentives and network incentives are combined. For example, a leaderboard may be provided ranking users (e.g., within the mobile app and/or on social media) based on amount of CO2 savings.

In some embodiments, the system's algorithms are operative to dynamically adjust, for each route, the incentives allocation based on historical and real-time data as well as the existing reserved departures for each time window in addition to personalized reward profiles and campaign parameters. As the number of users of the system becomes large, this dynamic adjustment feature becomes especially advantageous as it ensures there are no individual time windows, routes, or modes of transportation that become overloaded with reservations, which would increase traffic congestion during those time windows.

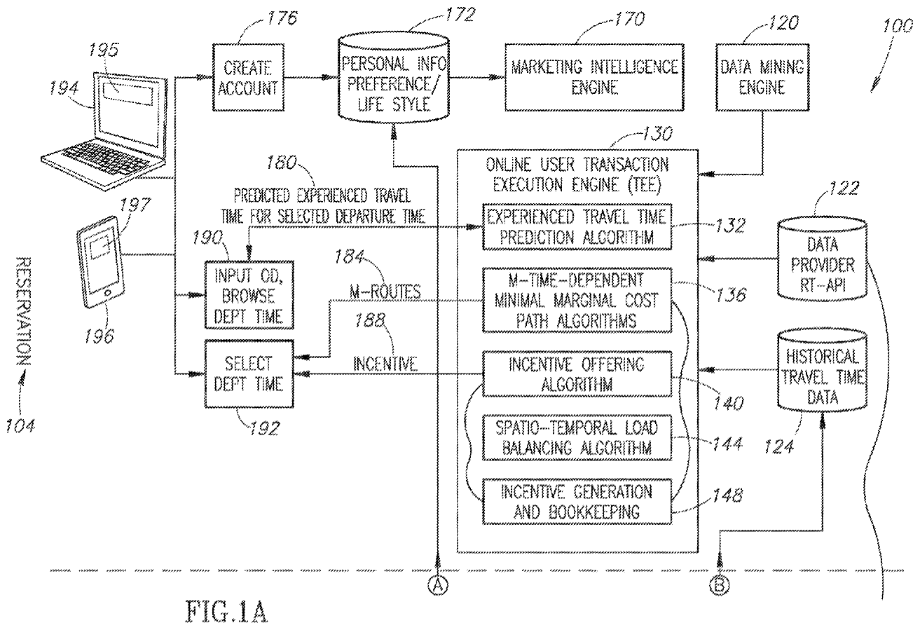

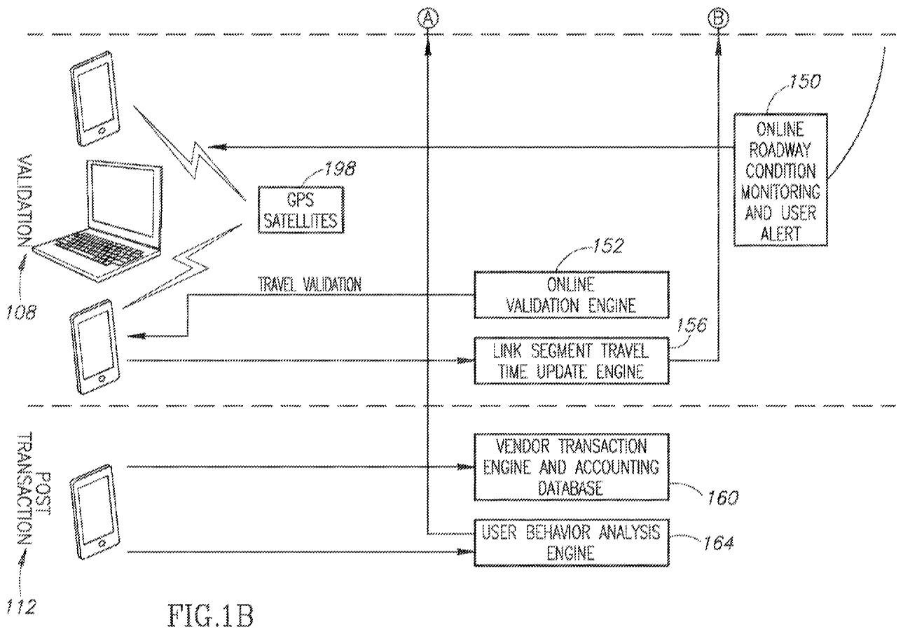

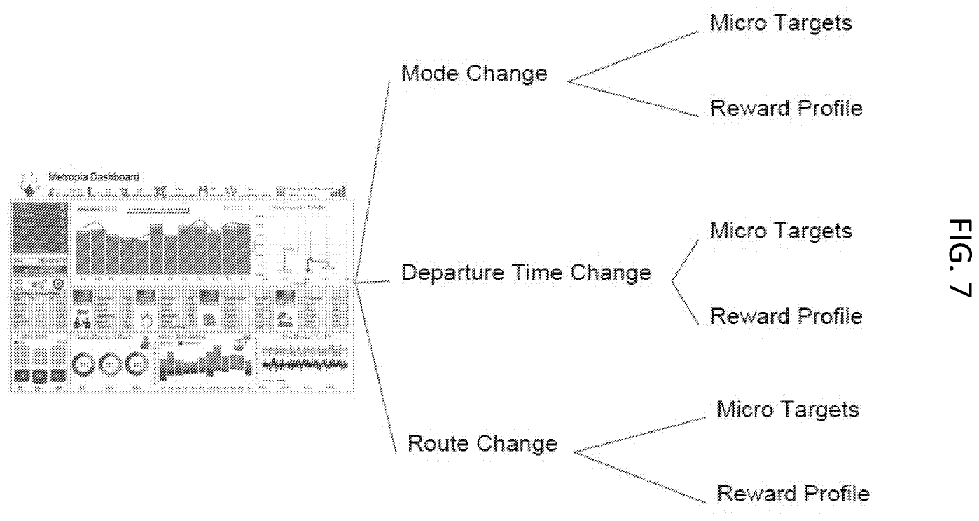

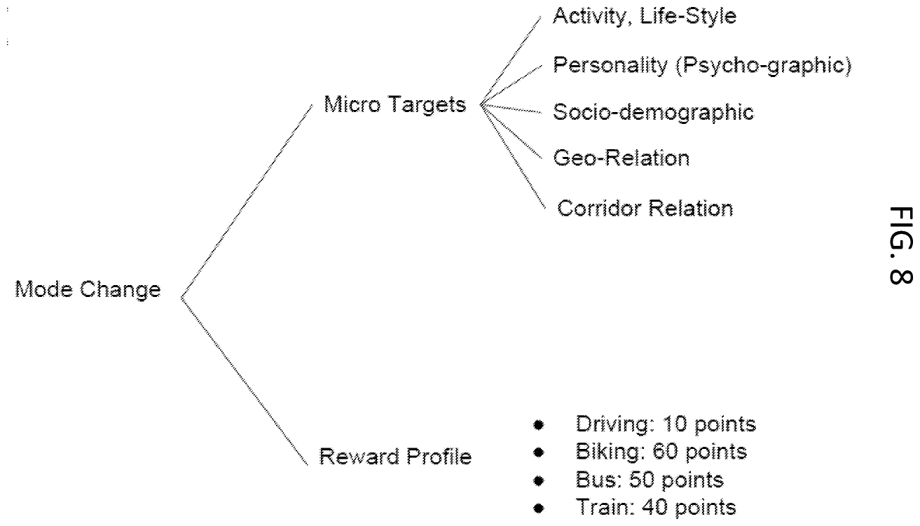

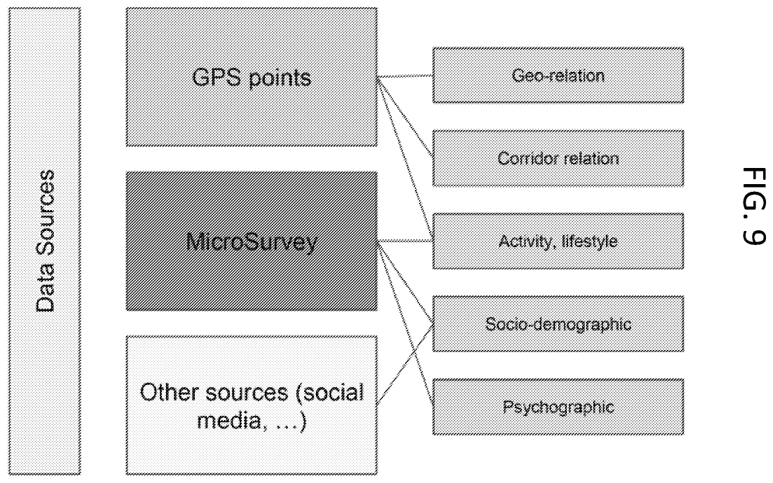

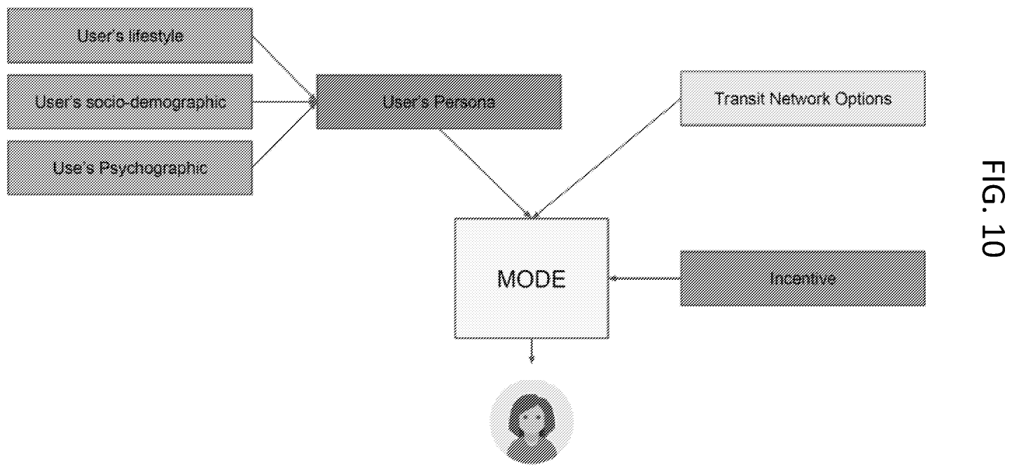

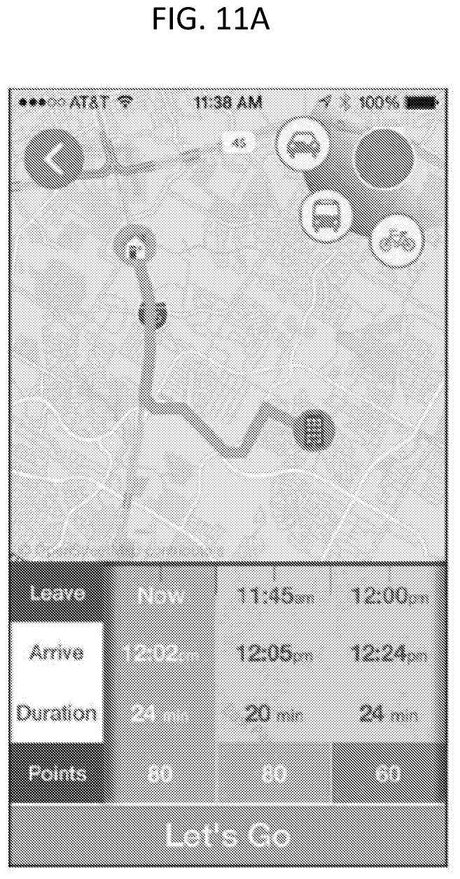

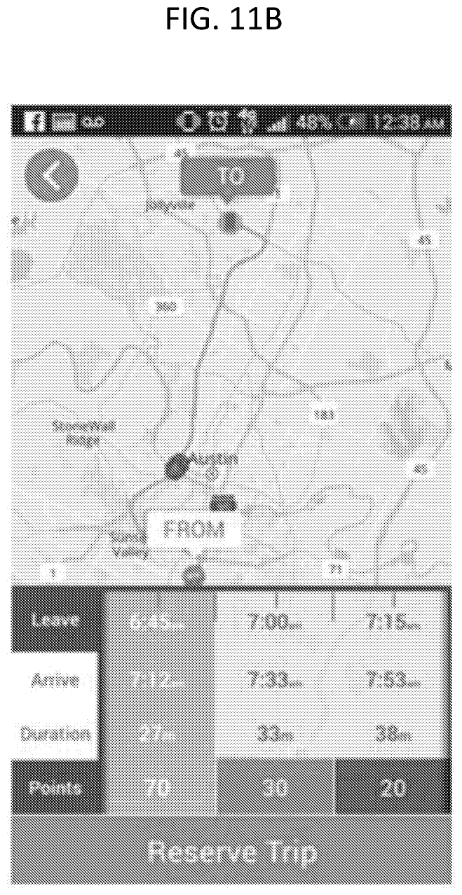

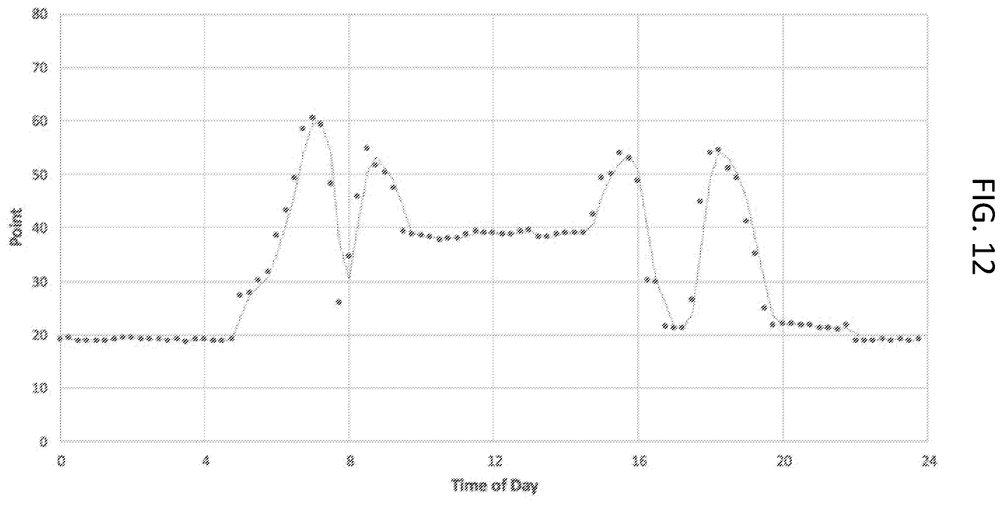

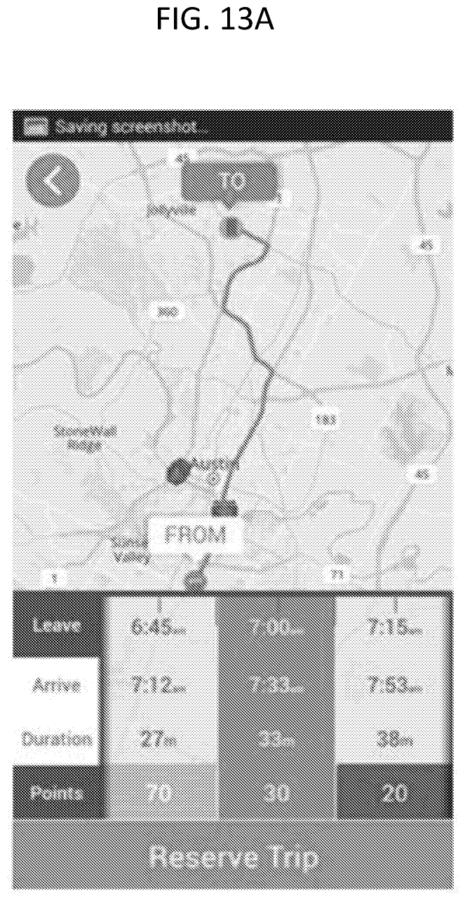

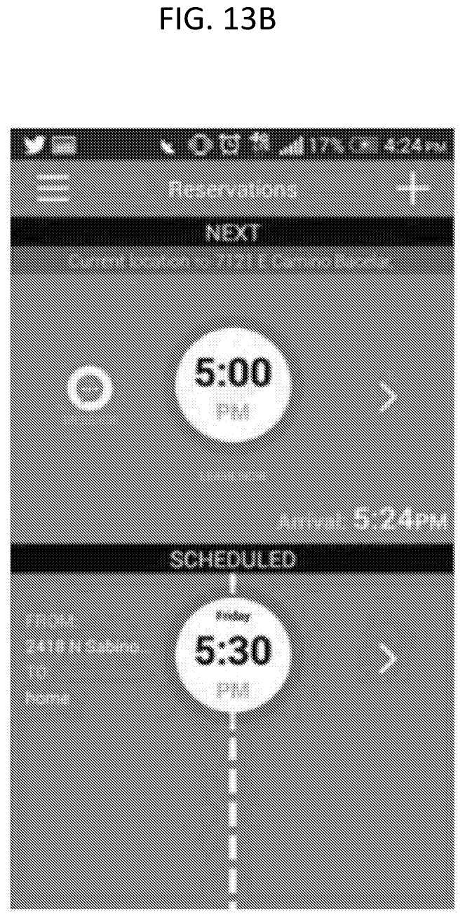

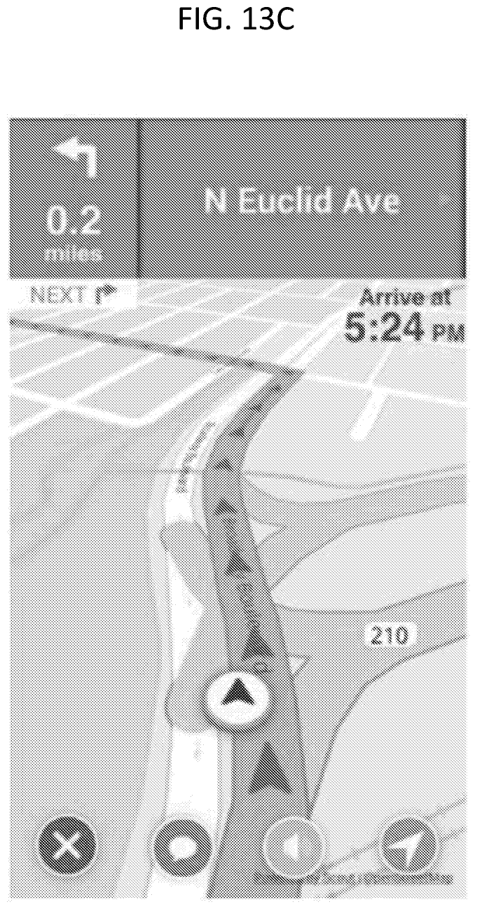

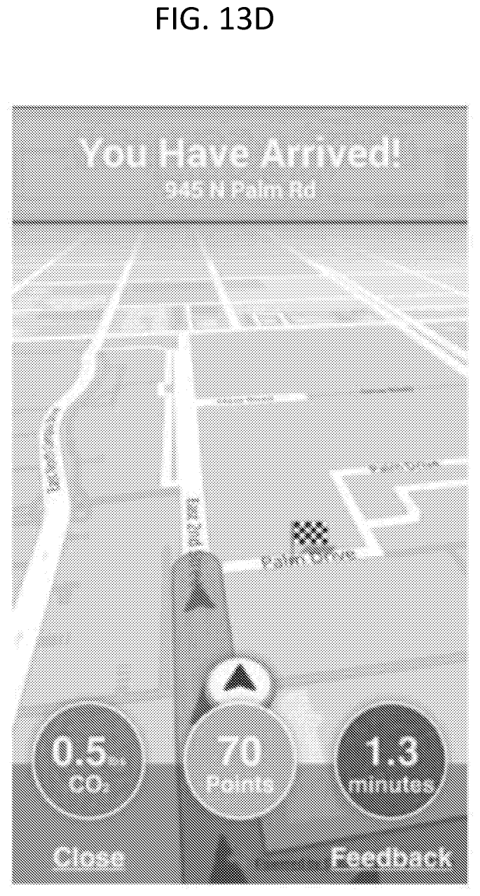

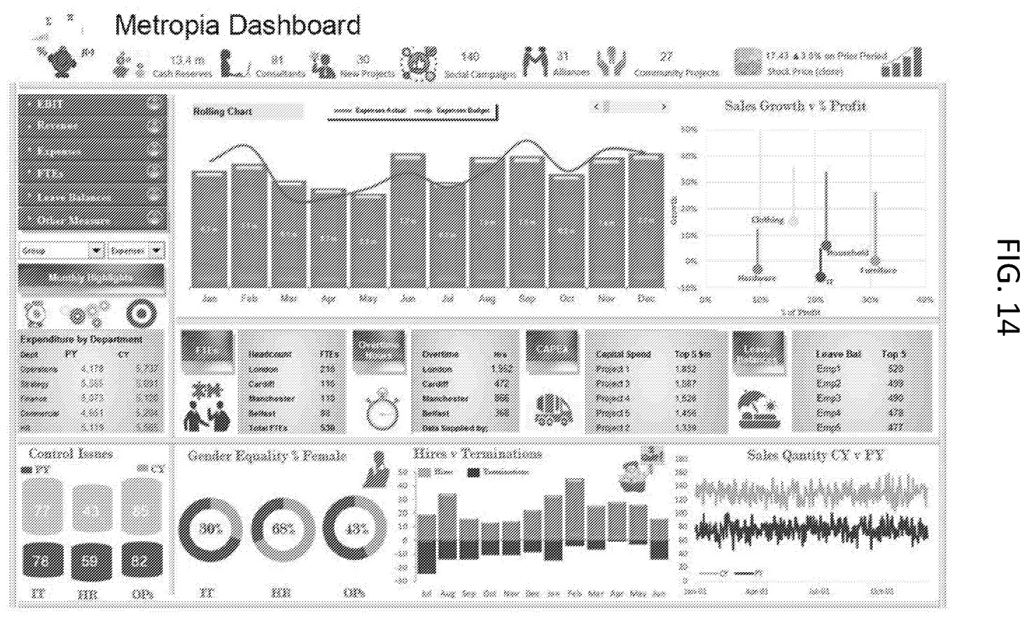

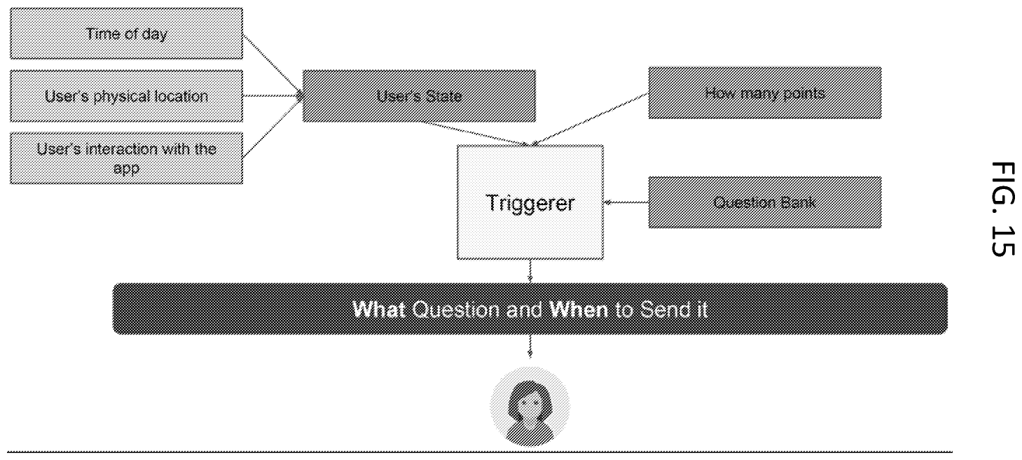

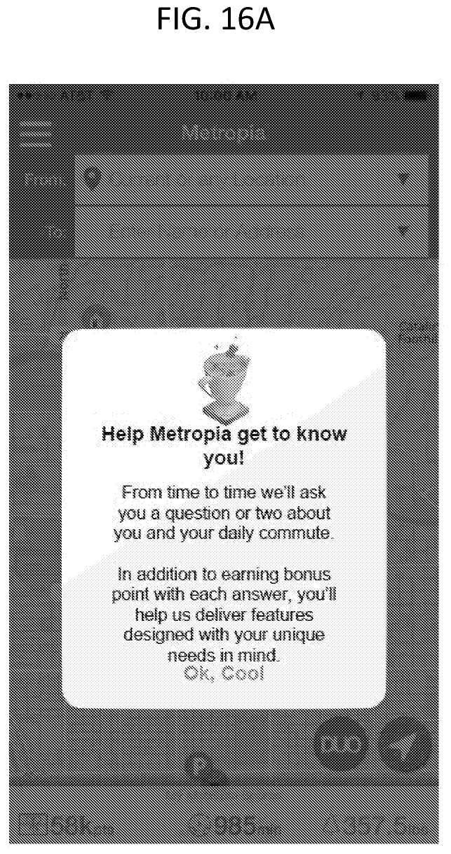

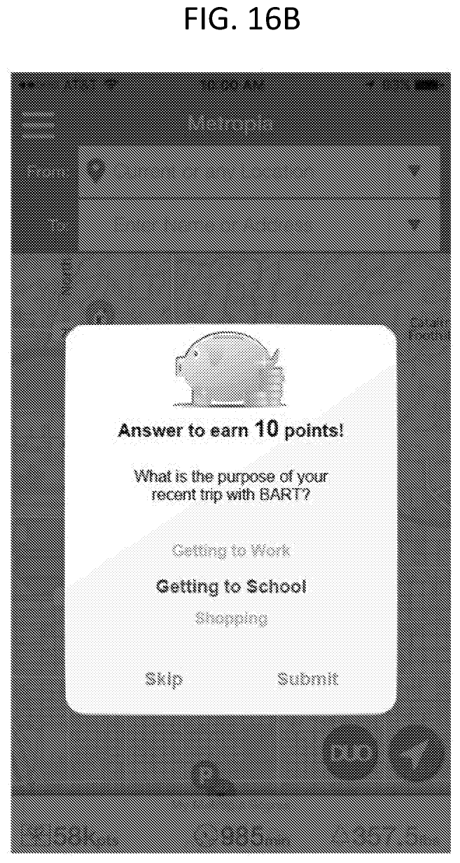

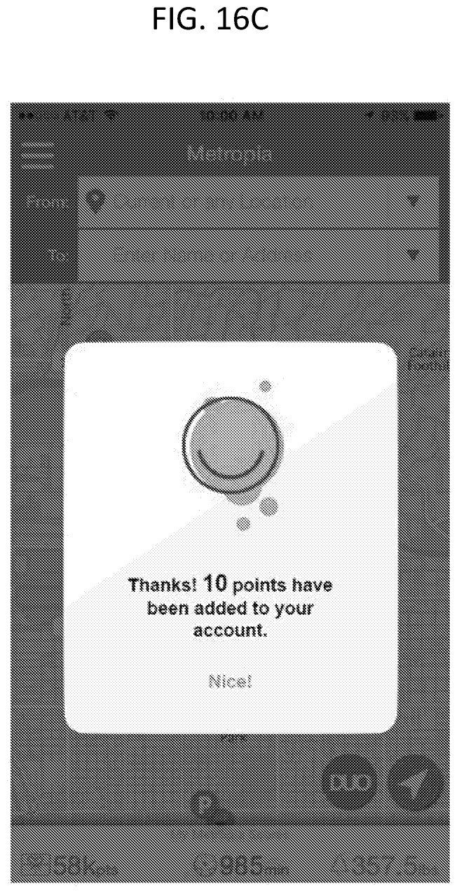

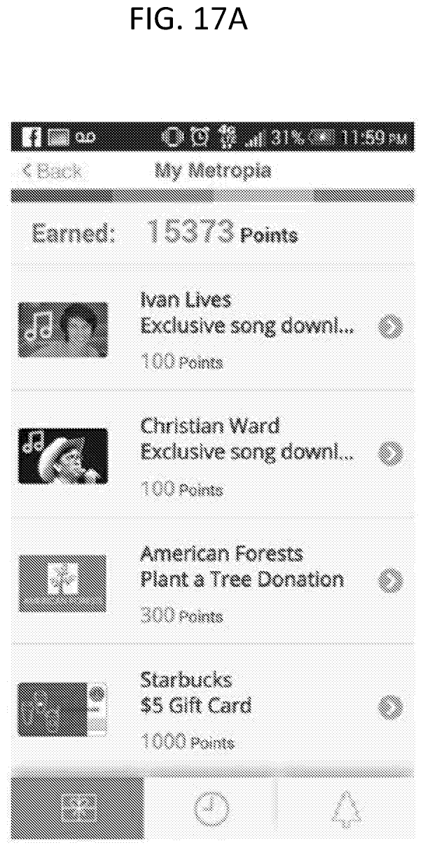

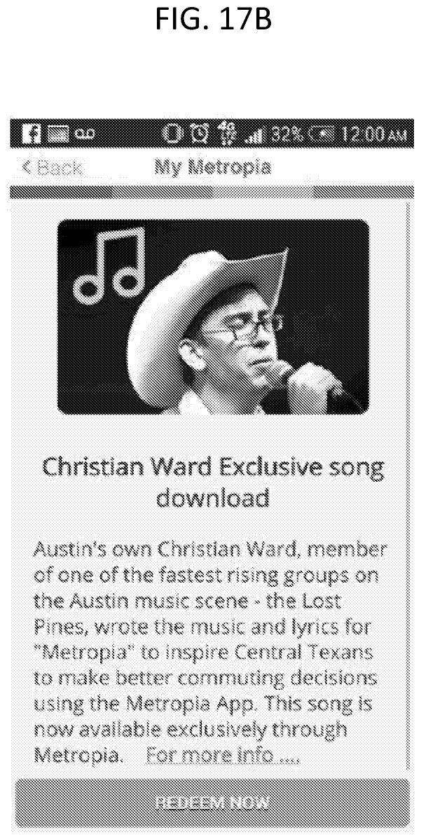

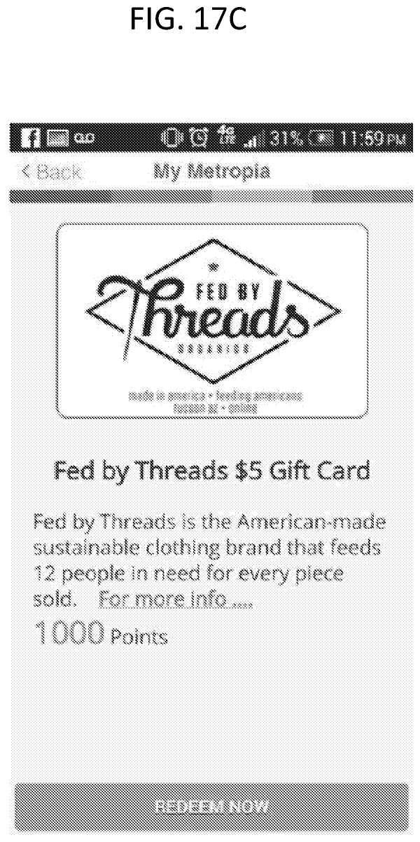

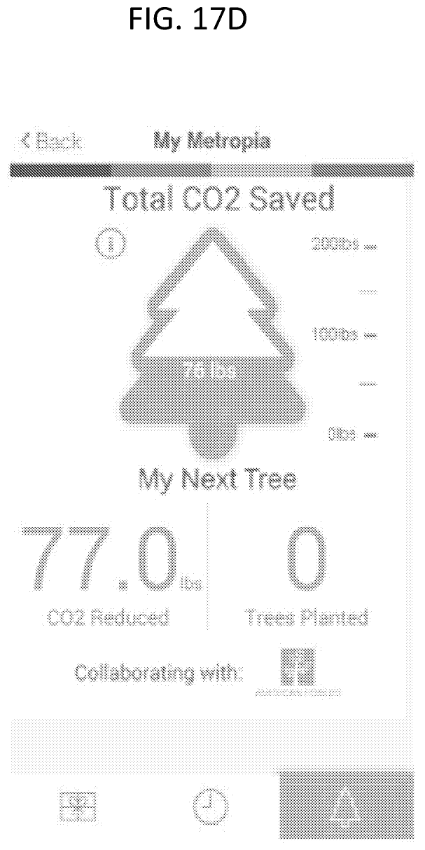

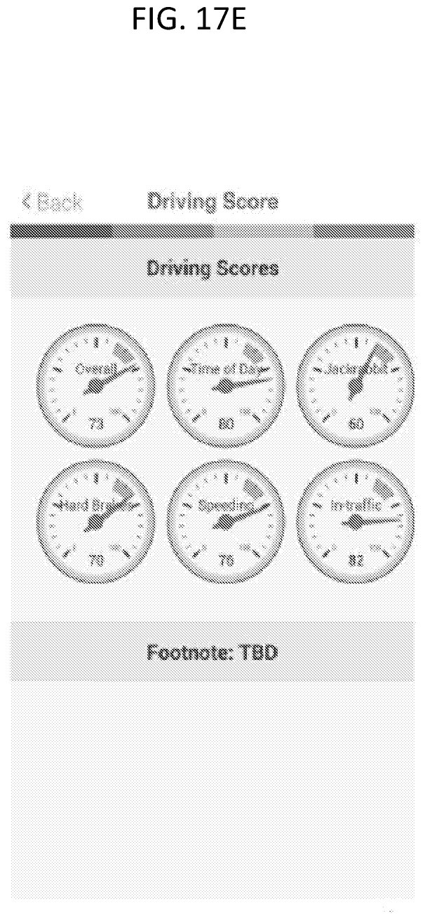

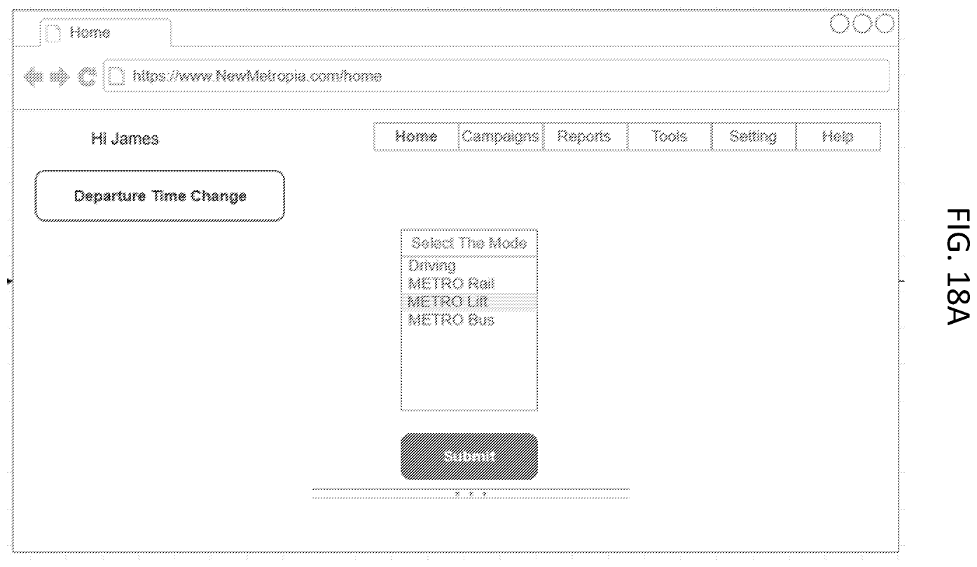

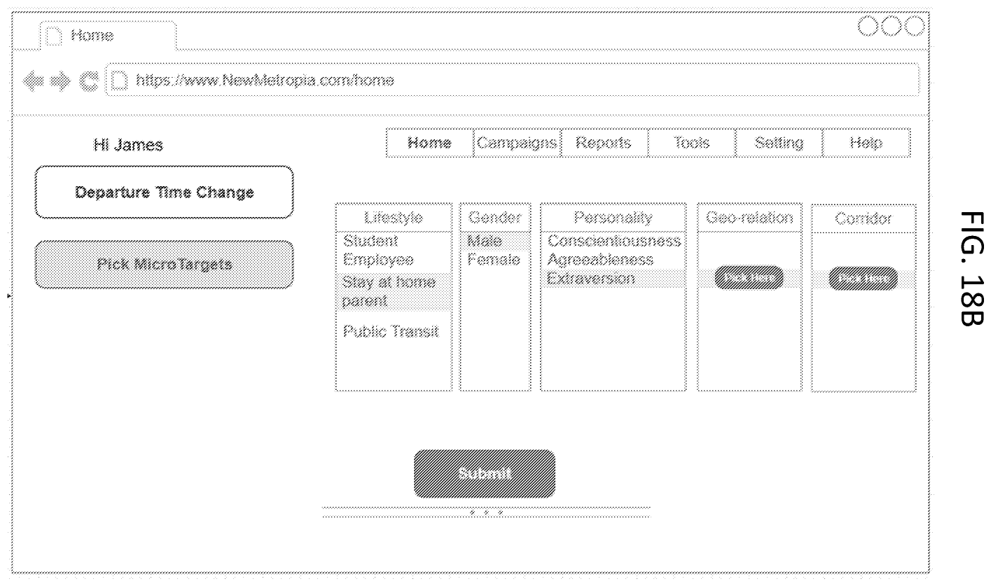

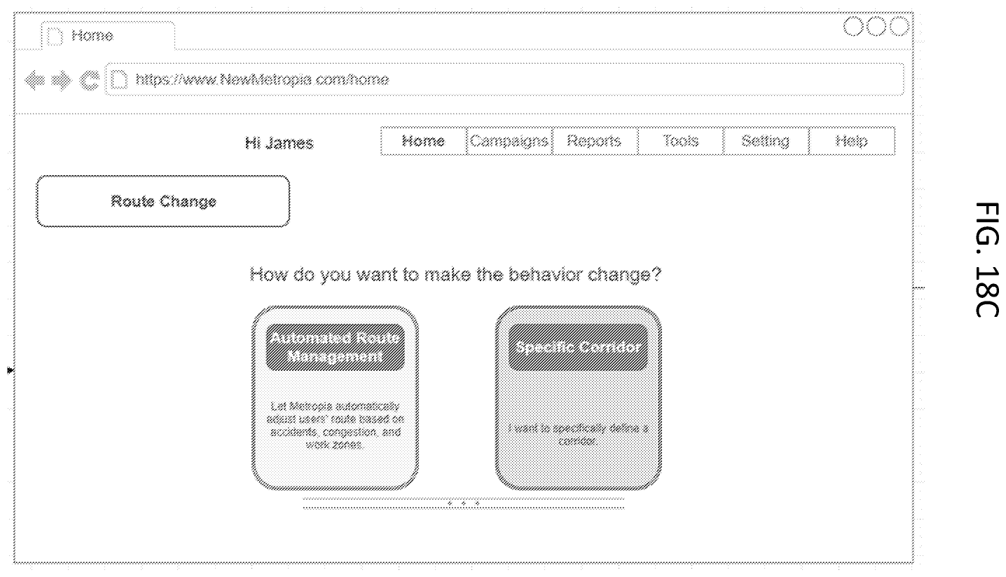

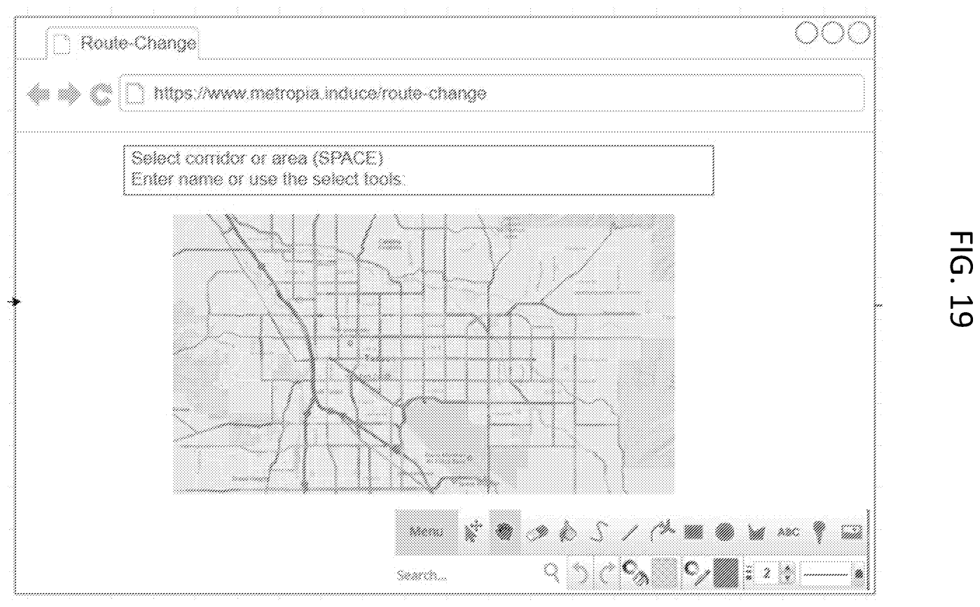

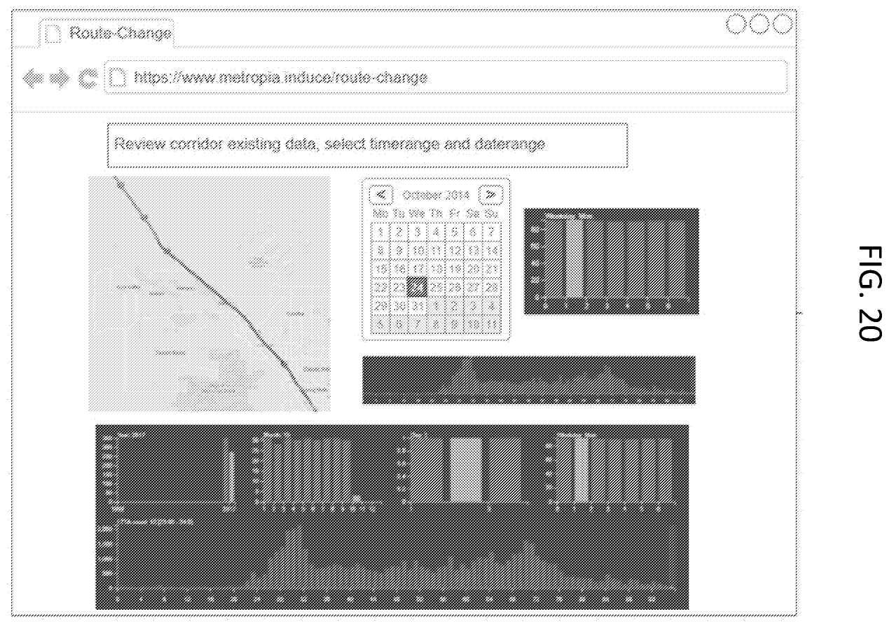

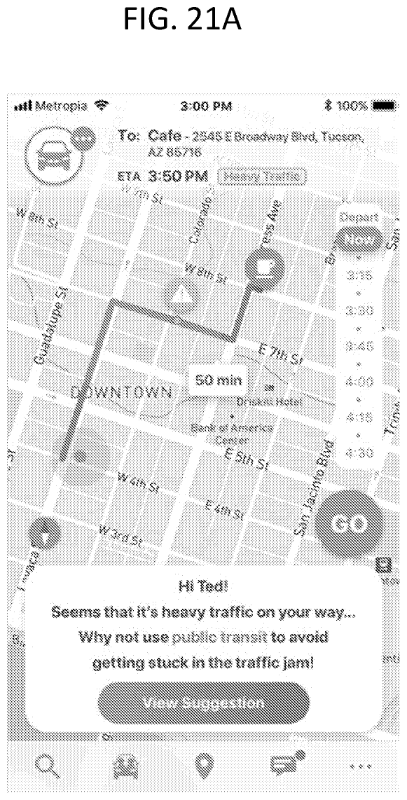

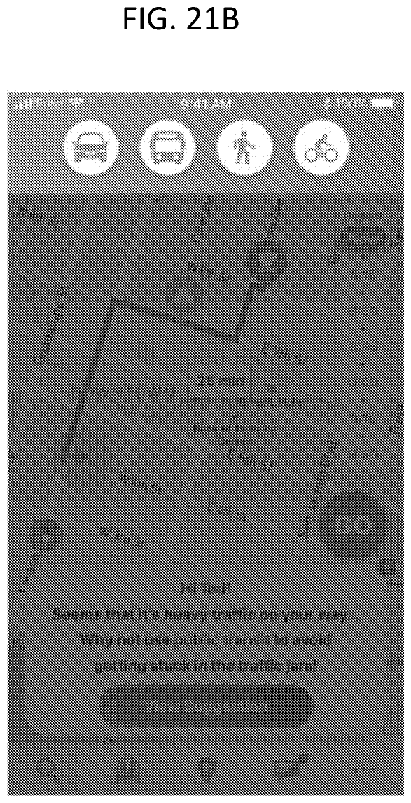

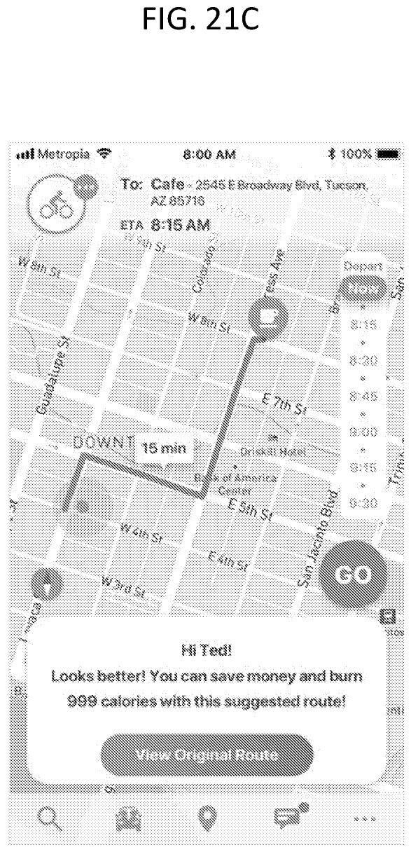

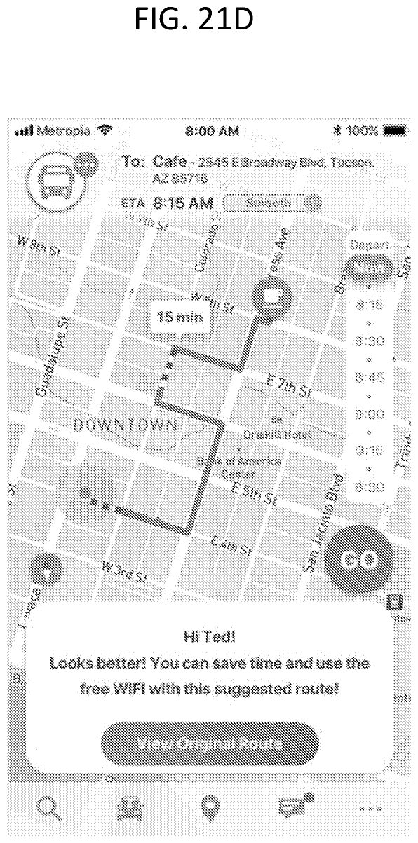

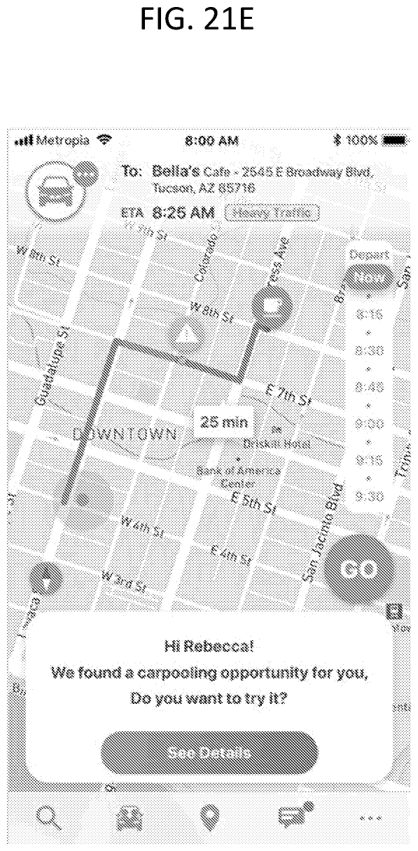

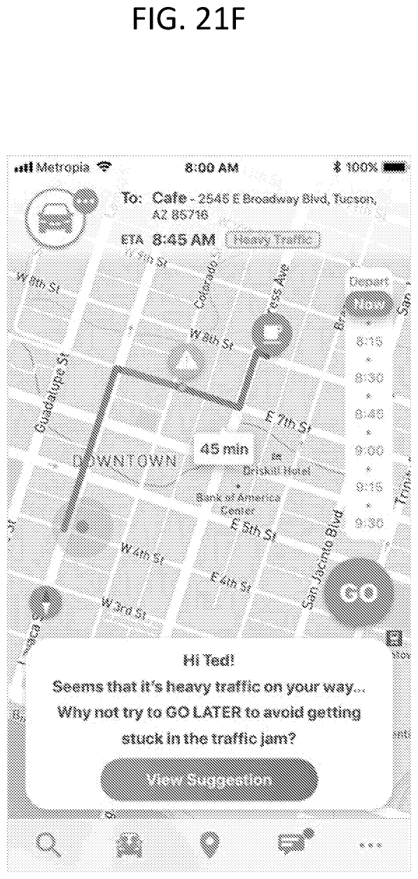

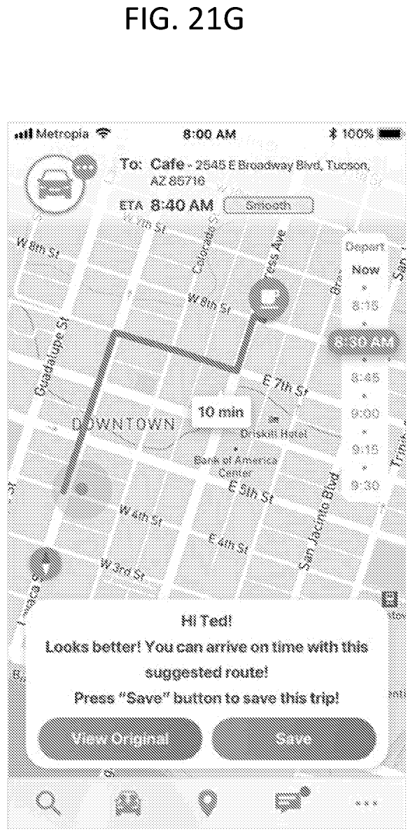

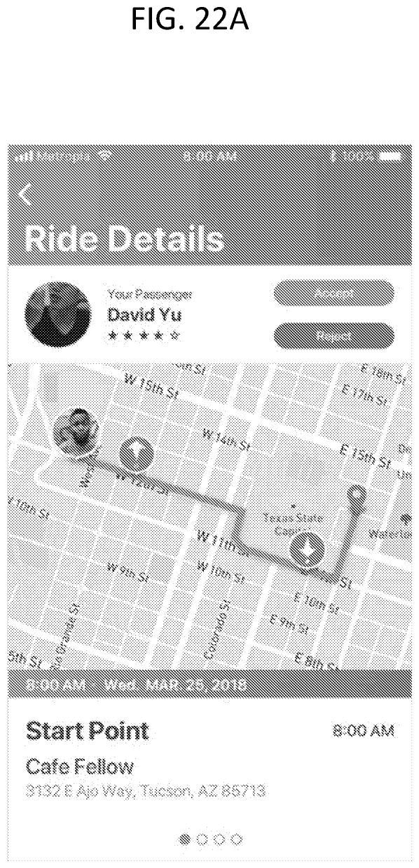

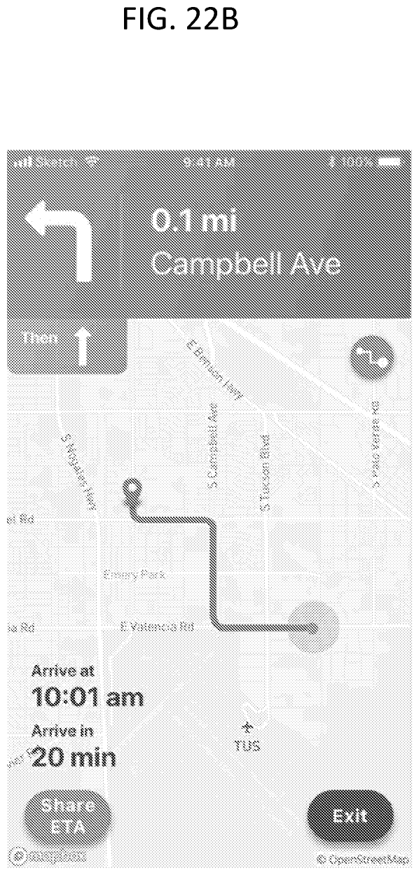

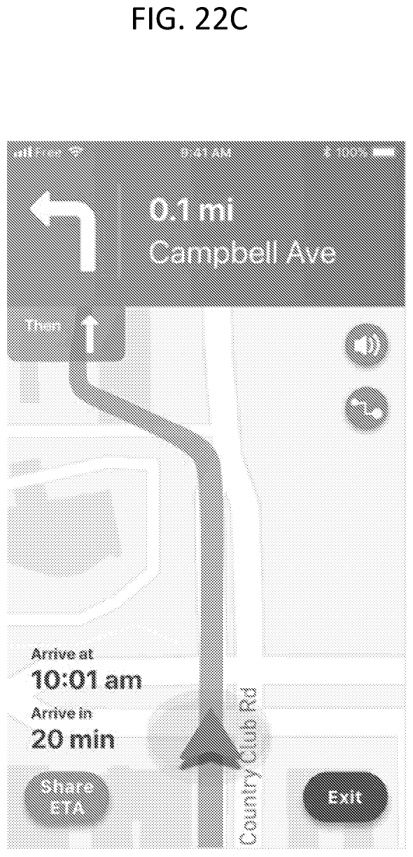

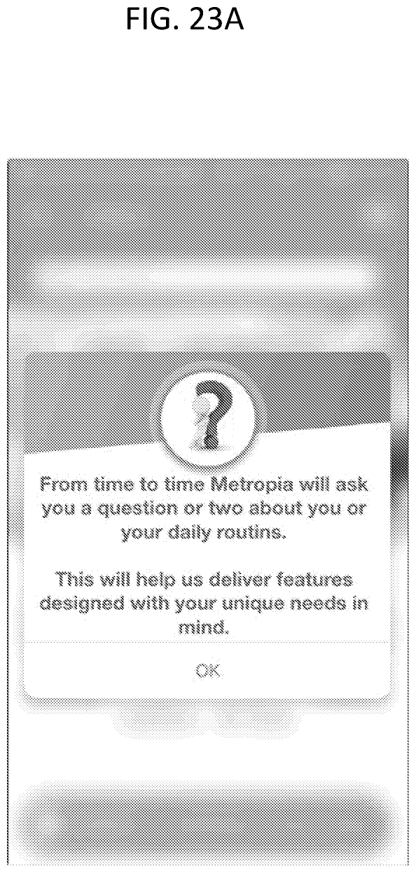

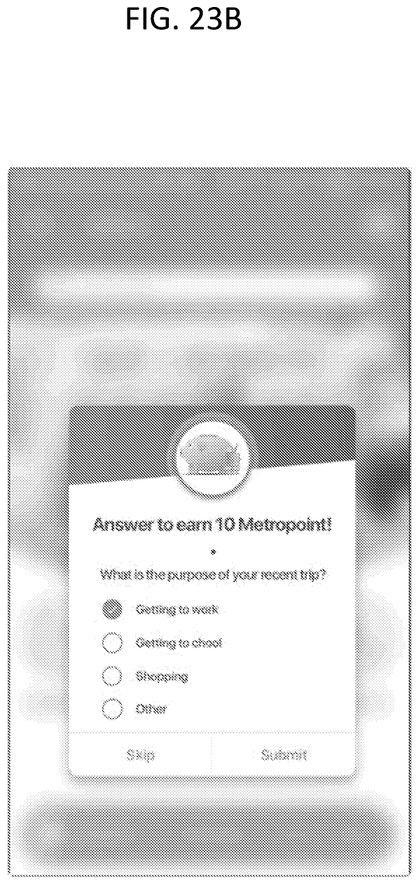

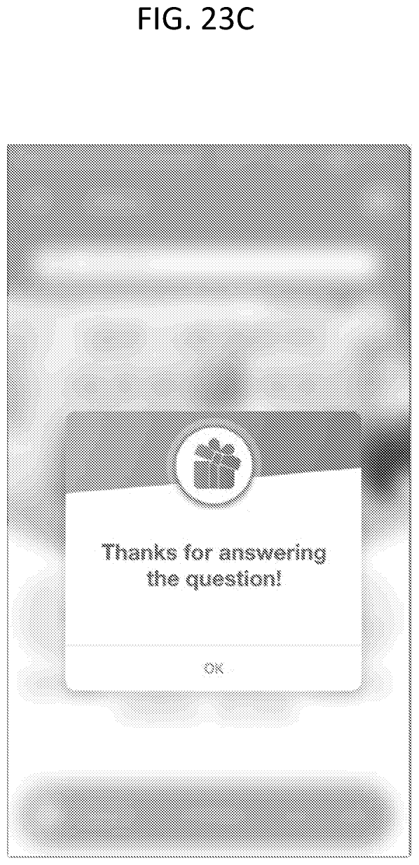

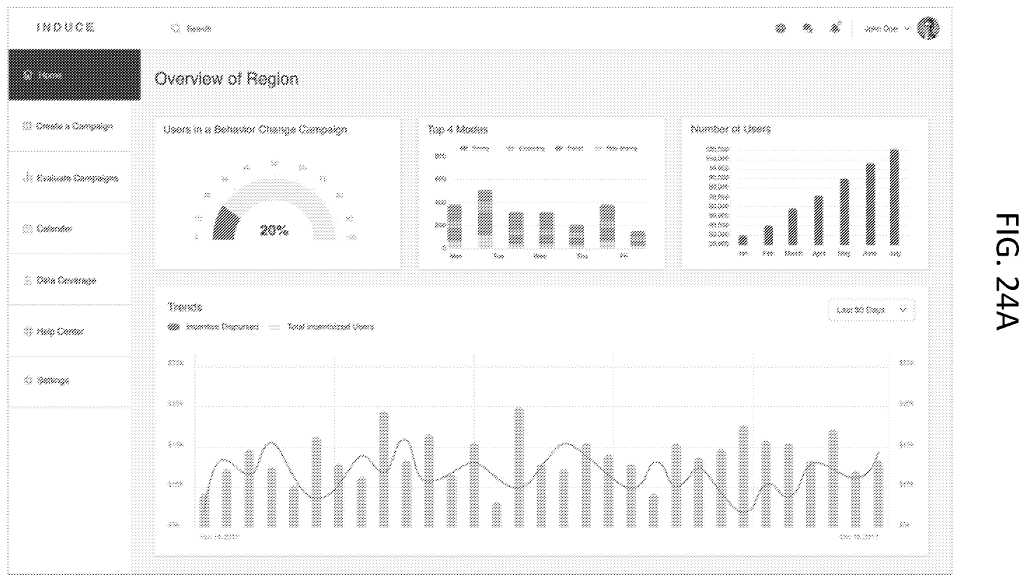

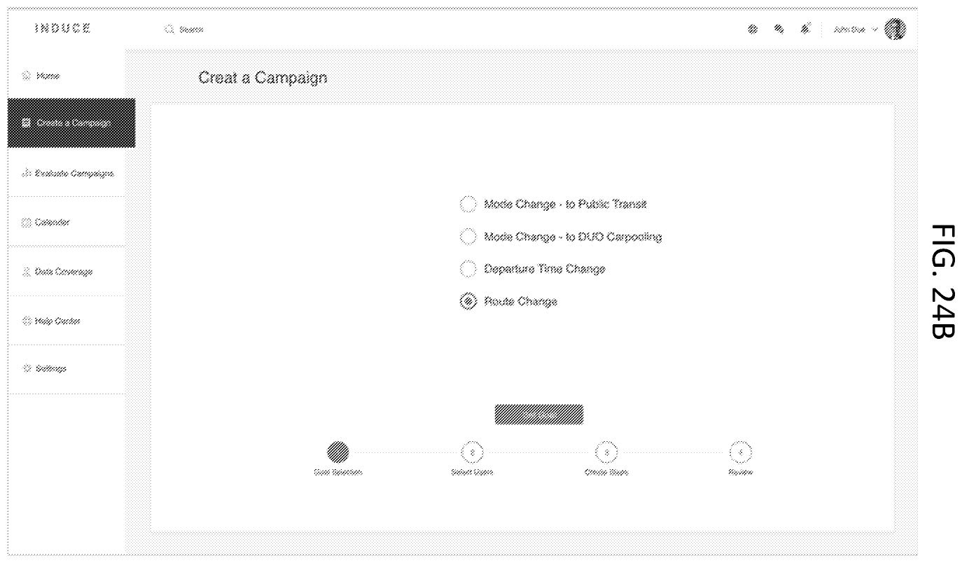

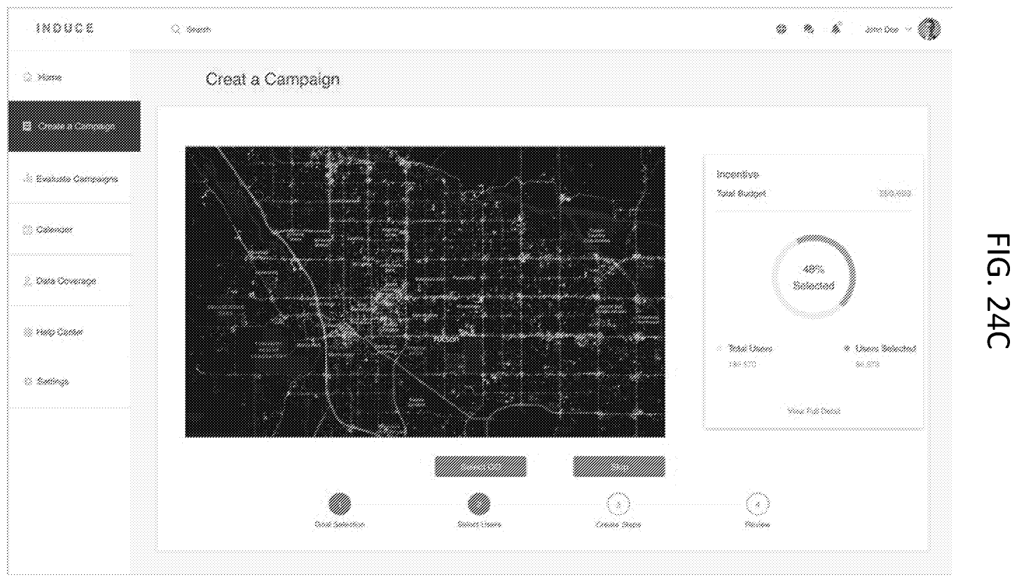

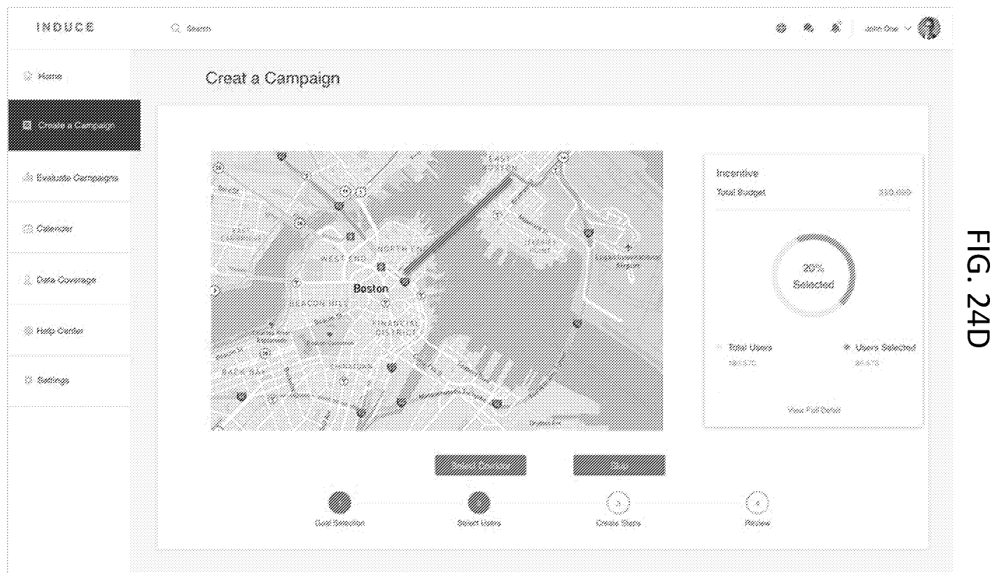

FIGS. 1A and 1B depict a block diagram of a traffic management system 100 (or “system”) according to an embodiment of the present disclosure. Specifically, FIG. 1A depicts an upper portion of the block diagram illustrating a reservation process 104 of the system 100, and FIG. 1B depicts a lower portion of the block diagram illustrating a validation process 108 and a post transaction process 112 of the system 100. A diagram of an exemplary hardware environment and an operating environment in which the system 100 may be implemented is shown in FIG. 5 and is described below.

As discussed above, the system 100 includes an electronic device application 197 (e.g., a smartphone application) operating on a user's electronic device 196 such as an iPhone®, Android®, or Windows Phone® platform phone, etc., and various algorithms and software modules executing on one or more remotely located server systems. Although not shown for clarity purposes, it should be appreciated that the software modules and other components of the system 100 may be operative to communicate with each other, as described below. The system 100 may also include a general web application 195 to allow users access the system via a conventional computer 194, such as a laptop, desktop, or tablet computer.

In operation, the device application 197 of the system 100 allows a user to agree on a departure time window and route between the user's specified origin and destination location. This process begins by having the user enter into the application 197 the intended origin and destination location and preferred time of travel. The application 197 may then transmit this information to the system 100, and the system returns to the application the predicted experienced travel time for the specified origin/destination (OD) pair at a plurality of future departure time intervals. The time intervals may be 15 minute, 30 minute, or other time intervals.

For each departure time window, the system 100 provides one or more (e.g., one to three, or the like) different routes traveling through distinct freeways or arterials. For each provided route, a set of available incentives may be provided, and where the incentive may vary among both the route and the departure time options. Generally, an incentive is the discount or coupon provided by an entity (e.g., retailers, service providers, manufactures, municipalities, etc.). Using his or her electronic device 196, the user can examine the provided route(s), modes of transportation, departure time windows along with the corresponding predicted travel times and the offered incentives and make a reservation for that incentive by agreeing to depart at the specified departure time window, take the specified route, and use the specified mode of transportation associated with that incentive. The agreed upon travel selection, route, and/or transportation mode should be successfully completed by the user in order for the system 100 to grant the user the previously agreed upon incentive.

In some embodiments, the system 100 has a two-step method to verify the travel completion by the user. In some embodiments, prior to the reserved departure time window, the device application 197 executed on the user's device 196 starts to communicate with GPS satellites 198. When the user is en route, the device 196 uses two methods to verify that the user has entered the reserved route at the reserved departure time window. In some embodiments, the device application 197 compares the GPS location data with the route data stored in the device 196 during the reservation process. Additionally, upon user agreement, the device application 197 may transmit the GPS data to the system 100. If the user enters the agreed upon route within the agreed upon time window, the first step of the verification process is completed. The device application 197 then continues to either perform internal checking or communicate with the system 100 as the user travels along the journey. Once the system 100 verifies that the user has successfully completed at least a sufficiently validating portion (but not necessarily all) of the reserved route, then the second validation step for the route and window analysis is completed. In some embodiments, mode of transportation requires analysis of location data from the trip and comparison to known routes and/or corridors as well as calculated speeds during the trip. For example, in some embodiments, the user location data is compared against a metro or bus route along with travel speed comparisons to designated metro/bus stops to determine if the user has indeed traveled using those mass transit options.

In some embodiments, a user needs to successfully pass the first and second validation steps in order to have the previously made reservation considered fully validated by the system 100. In the case of a shift in transportation mode, the user needs to successfully pass a validation step verifying the user used the selected mode of transportation. After validating the completion of the sufficiently validating portion of the reserved route, the system 100 may then transmit the agreed upon incentive to the user's account via the user's designated email address, via the electronic device application 197, or the like. The incentive can then be redeemed according to instructions given to the user. Additional details regarding the possible incentive offerings are discussed below.

Referring still to FIGS. 1A and 1B, the system 100 includes a plurality of algorithms or sub-modules for implementing its functionality. Each of these sub-modules is described in detail below. It will be appreciated that one or more of these sub-modules may be logically or physically combined in one or more ways, and the modules and other components may be operative to communicate with each other as needed to implement the functionality described herein. Further, some embodiments may include all of the sub-modules or a subset of the sub-modules.

The system 100 includes a data-mining engine 120 that is operative to receive and analyze historical traffic data and to prepare data in a format that is suitable for real-time queries, data processing, and path calculations. In some embodiments, historical traffic data comes in a format of average speed by 15-minute bins or windows for each link segment (e.g., a segment of roadway between to defined points) of a roadway for each day over a historical period (e.g., the past year, past five years, etc.). Other lengths of time for the bins or windows are contemplated such as at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, or 60 minutes or more, and/more no more than 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, or 60 minutes. The data may also include numbers of vehicles traveling on particular roadways. This raw historical data is processed to extract the statistical attributes of the time-varying travel times (e.g. mean, standard deviation, etc.). Due to possible seasonal factors of traffic, noise data for the prediction of travel times of a given day (e.g., the fifth Friday of September, a particular holiday, etc.) may be filtered out in order to improve the prediction accuracy. Moreover, a variable temporal discretization scheme may be applied in order to reduce data storage requirements while increasing accuracy of the path calculation, as described below.

In some embodiments, the data-mining engine 120 also includes a capacity discovery algorithm operative to determine the available capacity of roadway segments using the incoming traffic speed data. The capacity discovery algorithm estimates the available capacity for each roadway by link segment and by time. An available capacity index (ACI) is defined and calculated for each link segment that estimates the residual capacity between the current traffic flow condition (using real-time data) and a link segment's theoretical capacity. The ACI index is saved for each link segment to be used by the algorithm described below.

In some embodiments, the system 100 also includes an online user transaction execution engine (TEE) 130 that comprises several sub-modules or algorithms, including an experienced travel time prediction algorithm 132, an M-time-dependent minimal marginal cost path algorithm 136 (or “route determination module”), an incentive offering algorithm 140, a spatio-temporal load balancing algorithm 144, and an incentive generation and bookkeeping algorithm 148. Each of these sub-modules of the TEE 130 is discussed below.

One embodiment of the experienced travel time prediction algorithm 132 of the TEE 130 is first described. When a user enters an OD pair via the electronic device 196, the electronic device application 197 transmits this OD information to the TEE 130, block 190. The TEE 130 uses the experienced travel time prediction algorithm 132 to return the predicted experienced travel time 180 between the OD pair for a plurality of future departure time windows over one or more routes. The experienced travel time generally means the predicted time that the user will experience when departing at a specific departure time window for each of the one or more routes. Since future conditions need to be considered for each departure time window, the prediction algorithm 132 utilizes both historical travel time data 124 and real-time data 122 as inputs for its model. The weight given to each of the historical travel time data 124 and the real-time data 122 may vary dependent on one or more factors, such as the amount of time into the future the prediction algorithm 132 is estimating travel times. For example, the real-time data 124 may become more relevant as the intended travel times become close in time to when the predictions are made. In some embodiments, the real-time data 122 and/or historical data 124 may be provided by a third party provider, such as INRIX, Inc., TomTom, Int'l., Traffic.com, or the like.

In some embodiments, when a user browses and/or selects an intended departure time, one or more routes (“M routes”) 184 are produced by the M-time-dependent minimal marginal cost path algorithm 136 and displayed on the user's electronic device 196. This algorithm 136 calculates a total of M routes for the OD pair and departure times that are minimal marginal cost routes. The concept of marginal cost is the unit increase of travel time when one additional unit of flow is added to the route. Thus, the route with minimal marginal cost means that once a user is assigned to that route, the incremental cost to all existing users of that route is minimal. This calculation ensures that the user's travel causes the minimal cost to the selected route. The best M minimal marginal cost routes are computed by the algorithm 136, where M is a system-specified parameter. As an example, M may be set to three, as much more than three routes could be confusing to the user. In other embodiments, M may be set to a value less than or greater than three.

In some embodiments, the incentive offering algorithm 140 is configured to select a set of suitable incentives 188 and to present them to the user via the electronic device application 197. Each incentive 188 may be associated with a given departure time and route. In other words, when a user selects a departure time window and a route, block 192, the set of incentives presented to the user may vary if the user selects different departure times and/or different routes. In some embodiments, the incentive offering algorithm 140 provides incentives with a higher value to the user for departure times and routes that are more beneficial to the traffic congestion management goals. The incentive offering algorithm 140 may also call the spatio-temporal load balancing algorithm 144, described below, to account for the previously made reservations that have a departure time prior to the user's departure time in order to adjust the loading of traffic flow in order to preventing overloading the traffic network due to users of the system 100.

In some embodiments, the incentive offering algorithm 140 associates the incentive offering with the user's preferences or life style information 172 stored by the system 100. This can be done by (1) asking for the user's life-style information during the user registration process, block 176, and/or (2) partnering with other vendors (e.g., Amazon®, etc.) to understand the user's preferences or “wish lists” in order to provide more targeted and attractive incentives or coupons. In some embodiments, the incentive offering algorithm utilizes user data (e.g., stored in a personalized user profile) to personalize or customize the incentive offering. In some embodiments, the incentive offering algorithm determines an incentive offer based on an estimated likelihood to adopt by the user. In some embodiments, the estimated likelihood to adopt is determined using population data, which is optionally filtered to generate a relevant population dataset. For example, the determination of a user's likelihood to adopt a particular type of incentive offering may be based on historical adoption by a subject population having one or more common characteristics with the user. In this example, the subject population is filtered to include those users having the one or more common characteristics with the user (e.g., gender, age group, income, location, etc), and a model based on the historical adoption rate by the population is generated. This model can be then used to calculate an estimated or predicted adoption rate by the user. In some embodiments, the incentive with the highest adoption rate is offered to the user. Alternatively, in some embodiments, the incentive with the highest ratio of adoption rate to cost is offered to the user (e.g., a 50% adoption rate based on a $1 cost has a higher ratio than a 90% adoption rate based on a $10 cost). In some embodiments, the incentive with the lowest cost and an adoption rate above a minimum threshold is offered to the user. In some embodiments, incentives being offered to users are dynamically adjusted during the course of a traffic campaign. In some embodiments, incentives are offered in two or more tiers or categories such as according to traffic campaign parameters. For example, an administrator may configure the campaign to increase incentives (e.g., increase value/cost of the incentive offer) during peak traffic congestion, but decrease the incentives outside of peak traffic congestion.

In some embodiments, the incentive offering algorithm generates an incentive offering that is non-monetary or otherwise has no monetary value. An example of a non-monetary incentive offering is a psychological incentive such as, for example, an informational incentive. Examples of informational incentives include information on nearby and/or available alternative travel options. The informational incentives can be personalized based on user data and/or specific travel information entered by the user such as departure location, destination location, departure time, destination time, mode of transportation, and/or other trip details. In some embodiments, incentive offers such as informational incentives are screened or filtered to be limited to those incentives falling within trip details entered by the user. For example, a user may enter preferred modes of transportation and/or unacceptable modes of transportation, and the incentive offers may be positively or negatively selected based on such preferences. In some embodiments, psychological incentives such as informational incentives make suggestions without an accompanying monetary or other non-psychological reward.

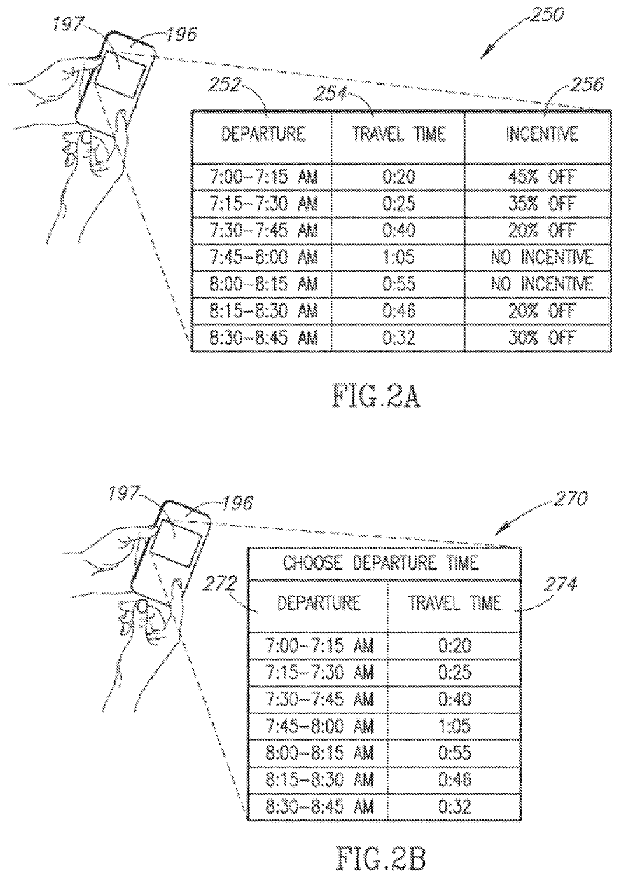

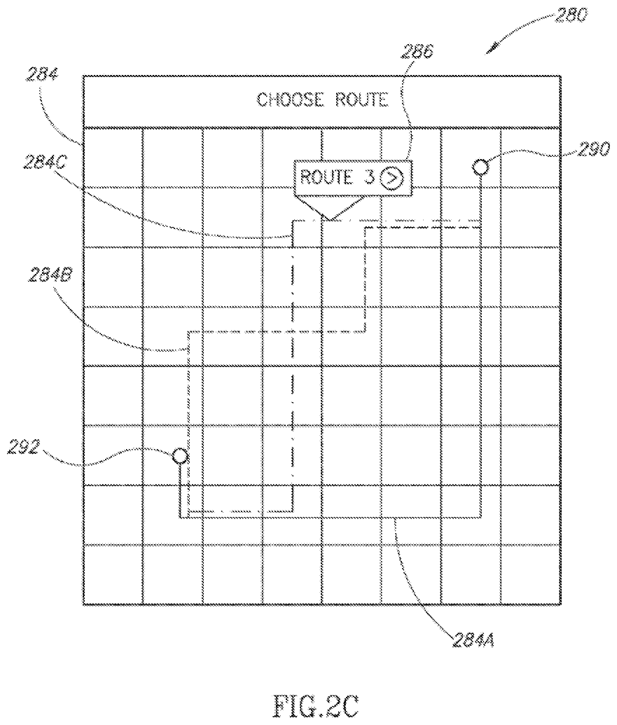

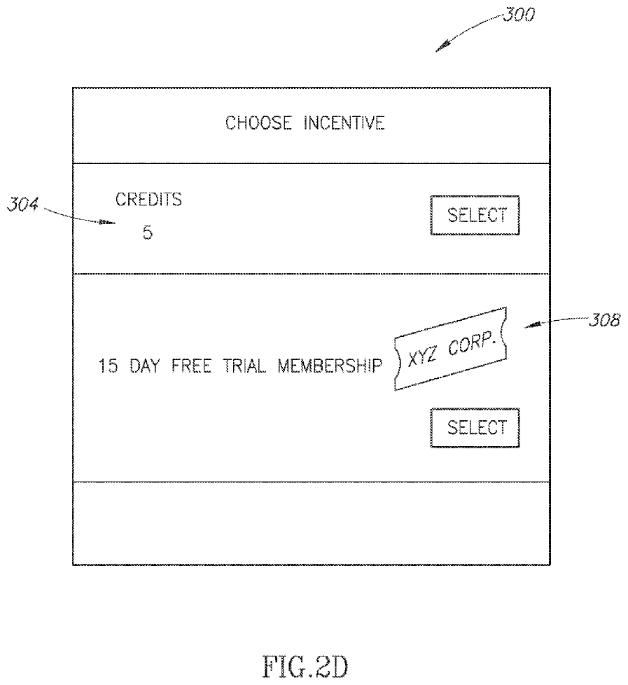

An example embodiment of a departure time selection screen display 250 of the device application 197 executing on the electronic device 196 is shown in FIG. 2A. As shown, the user is provided with a list of departure time windows 252, estimated travel times 254 for each of the departure time windows for a prior-selected route(s), and offered incentives 256 for each of the departure time windows. The estimated travel times 254 may comprise an average, minimum, or other statistical measure of multiple routes (e.g., three routes). In this example, the longest travel times (i.e., the most congested times) occur during the departure time windows 252 of 7:45-8:00 AM and 8:00-8:15 AM. Thus, no incentives are offered during these departure time windows 252. Further, as the estimated travel times 254 decrease (i.e., the less congested times), greater incentives 256 are offered to the user in an attempt to entice the user to travel at these less congested times, thereby improving the overall traffic flow of the selected route. It should be appreciated that in some embodiments the user may be able to select among a variety of combinations varying with regard to departure time windows, routes, and incentives.

FIGS. 2B, 2C, and 2D illustrates sequential screen displays 270, 280, and 300, respectively, of the device application 197 executing on the device 196 which illustrate another embodiment for allowing a user to select a departure time, route, and incentive. FIG. 2B illustrates a departure time selection screen 270 that provides the user with a list of departure time windows 272 and estimated travel times 274. As discussed above, the estimated travel times 274 may comprise an average, minimum, or other statistical measure of multiple routes.

Once the user has selected a departure time window, a route selection display screen 280 may be provided to the user, as shown in FIG. 2C. In this illustrated embodiment, the route selection display screen 280 includes three routes 284A-284C for the user to travel between an origin location 292 and a destination location 290. In response to the user touching or otherwise activating one of the routes 284A-C, a window 286 may pop-up that allows the user to select the activated or “highlighted” route. In this example, the user has selected Route 3 (or route 284C).

After the user has selected a particular route, an incentive selection screen 300 may be displayed, as shown in FIG. 2D. The incentive selection screen 300 may provide the user with one or more options for selecting credits 304, coupons 308, or other incentives for a variety of products, services, account enhancement features, etc., as discussed above.

A purpose of the spatio-temporal load balancing algorithm 144 is to avoid assigning too much traffic to the same departure time window and/or route so that a particular departure time/route is not overloaded. Because the incentives are offered for each user at different times for various future departure times, a reservation made by a user at a given time needs to consider all previously made reservations with departure times prior to the current user's considered departure time. This is because trips departing earlier using the same route may impact the trips departing at later times. Similarly, the current user can affect previously made reservations with later departure times. In this case, the spatio-temporal load balancing algorithm 144 can calculate and track the predicted travel times to make sure that the previously reserved departure times/routes are not severely impacted by later user reservations.

The incentive generation and bookkeeping module or algorithm 148 of the TEE 130 is now described. In some embodiments, once a user makes a reservation for an incentive by agreeing to depart at a specific departure time window and taking a certain route, block 192, this reservation is stored by the TEE 130 and is labeled as being “active.” The reservation may be changed to other statuses, such as “completed” if the user completes the route as agreed upon, or “failed” if the user fails to complete travel as promised. The transaction status data may be stored and analyzed to better understand the behaviors and/or preferences of each user. In some embodiments, the incentive generation and bookkeeping algorithm 148 also ensures that the offered incentives are valid according to the contract agreements with the incentive providers.

As shown in FIG. 1B, the system 100 also includes an online roadway condition monitoring and user alert module 150. In the event an unscheduled work zone or an unexpected accident occurs on the traffic network, and this event is not known to the system 100 at the time a user reservation is made, the user alert module 150 will notify the user if the system 100 determines that (1) this incident will severely affect the user's travel time on the selected route, and/or (2) the user sets a preference in his or her user profile 172 to receive real-time alerts for incidents that may affect him or her.

In this case, the roadway condition monitoring and user alert module 150 may regularly send an inquiry to the real-time network condition data provider 122 for the real-time network condition data so that new incident events may be identified. The user alert module 150 may then be called and regularly scan existing reservations and update the travel times for each of the routes associated with existing reservations. If the increased travel times exceed a certain threshold, then the user alert module 150 may trigger the notification process to enable to user to (1) reevaluate the route for the same departure time, or (2) reevaluate one or more new departure times and routes. The user can then choose to keep the previously agreed upon incentive and route and departure time window or to select a new incentive for a newly selected departure time and route.

In some embodiments, the system 100 further includes an online validation engine (VLE) 152. As can be appreciated, a previously agreed upon travel needs to be validated in order for system 100 to grant the user the reserved incentive. To accomplish this, a two-step validation process may be used. Shortly prior to the user's scheduled departure time, the electronic device application 197 starts to communicate with GPS satellites 198. When the user becomes en route, the device 196 uses two methods to verify that the user has entered the reserved route at the reserved departure time window. As discussed above, in some embodiments, the device application 197 compares the GPS location data with the route data stored in the device 196 during the reservation process. Additionally, upon user agreement, the device application 197 may transmit the GPS data to the system 100. If the user enters the agreed upon route within the agreed upon time window, the first step of the verification process is completed. The device application 197 then continues to either perform internal checking or communicate with the system 100 as the user travels along the journey. Once the system 100 verifies that the user has successfully completed at least a sufficiently validating portion (but not necessarily all) of the reserved route, then the second validation step is completed. Otherwise, if the user has not completed at least a sufficiently validating portion of the reserved route, the VLE 152 marks the reservation to have a final status of “invalidated.”

In some embodiments, after the first validation step, the user needs to continue following the pre-planned route as the VLE 152 is analyzing the received GPS locational data. If the user successfully completes a sufficiently validating portion of the pre-planned route, then the VLE 152 considers the second step validation completed. The VLE 152 considers a reservation to be fully validated only if both the first and second validation steps are completed by the user.

Another advantageous use of the data from the VLE 152 is to validate the predicted travel time accuracy by recording the actual experienced travel time for a user and comparing it with the previously calculated predicted travel time. Such information may be used as the input to a link segment travel time update engine 156, described below.

The device application 197 may display the route during the validation process as the user is traveling. In some embodiments, the device application 197 is operative to provide turn-by-turn audio and/or visual guidance to help guide the user to follow the selected route between the origin and destination.

The link segment travel time update engine (“STU”) 156 is operative to record and merge the experienced link segment travel time with the historical link travel time data in order to update the estimated link travel times. In some embodiments, this is done using Bayesian updating methods. In some embodiments, the current experienced travel time information may also be used as part of a historical travel time data set 124 for future estimation calculations by the system 100.

In some embodiments, the system 100 includes a vendor transaction engine and accounting database (“VTE”) 160 that tracks how many types and the number of coupons that have been generated by the system. Each coupon has its own attributes and is stored as a database record in the VTE 160. During each transaction reconciliation period, the VTE 160 may validate its records with a coupon vendor's transaction database. For franchise vendors, the coupon transactions may be automatically recorded and processed in the franchise's accounting system. The accounting system's records may be compared and reconciled with the VTE 160, wherein used and expired coupons may be voided. Revenue due to used coupons may be processed to produce accounts receivable information. For typical merchants without a pre-existing coupon transaction accounting mechanism, the system 100 also provides a website for the merchants to enter coupon codes and transaction amounts when coupons are redeemed. This step voids the used coupons and transmits the transaction amounts record to the VTE 160. The aforementioned processes use retailer coupons as an example for the operation of the VTE 160, but it should be appreciated that the operation of the VTE 160 may be configured to accommodate other types of incentives.

In some embodiments, the system 100 also includes a user behavior analysis engine (UBA) 164. The status of each reservation is recorded and analyzed by the UBA 164. The analysis focuses on understanding how frequent a registered user makes a reservation, how frequently he or she fully validates the reservation, and how frequently he or she starts a trip and attempts to validate a reservation but fails to have the reservation validated. Possible reasons for failing to validate the reservation could be due to traffic congestion prior to entering the agreed route and/or diversion from the agreed route due to unknown reasons. The UBA 164 may also be operative to periodically send out surveys to users to better understand their experience by collecting their feedback.

The analysis pertaining to coupon transactions focuses on how frequently a user would use a reserved coupon and the average transaction amount, grouped, for example, by socio-demographic attributes. The UBA 164 may also try to understand and analyze the types of coupons that different users select based on their preference and/or life style information 172. Based on this information 172, marketing staff of the system 100 are able to have a better idea of what types of incentives are more desirable by users. Thus, a marketing campaign can be designed and incentives can be selected accordingly.

User experience feedback may be an important component to the collection of user information 172 as the basis for functionality improvements for the system 100. User feedback information 172 may be collected from the system's web application 195 as well as the system's electronic device application 197 through a “send feedback” function on the respective platform.

As shown in FIG. 1A, in some embodiments, the system 100 also includes a marketing intelligence engine (MIE) 170. In some embodiments, the MIE 170 is operative to allow marketing staff to query and receive analysis results produced by the UBA 164 to assist in the design and execution of marketing campaigns. Typical questions marketing staff may ask include: types of coupons/incentives most selected by personal attributes, time, OD pairs, or cities; reservation frequency by city, corridor, origin, destination, or departure time; coupon use characteristics by city, corridor, origin, destination, and/or personal attributes; and any user feedback data collected by the website application 195 or the electronic device application 197.

### Algorithms

In some embodiments, the systems, methods, and media described herein use one or more algorithms analyzing user data and/or trip information. In some embodiments, the algorithms utilize statistical modeling to generate predictions or estimates about the user or user behavior and/or responsiveness to various incentive or informational offers. In some embodiments, machine learning algorithms are used for training prediction models and/or making predictions. In some embodiments, the algorithm predicts a likelihood or probability (e.g., probability of adoption or adoption rate of an alternative travel option). Various algorithms can be used to generate models that are used to make such predictions. In some instances, machine learning methods are applied to the generation of such models.

In some embodiments, a machine learning algorithm uses a supervised learning approach. In supervised learning, the algorithm generates a function from labeled training data. Each training example is a pair consisting of an input object and a desired output value. In some embodiments, an optimal scenario allows for the algorithm to correctly determine the class labels for unseen instances. In some embodiments, a supervised learning algorithm requires the user to determine one or more control parameters. These parameters are optionally adjusted by optimizing performance on a subset, called a validation set, of the training set. After parameter adjustment and learning, the performance of the resulting function is optionally measured on a test set that is separate from the training set. Regression methods are commonly used in supervised learning. Accordingly, supervised learning allows for a model or classifier to be generated or trained with training data in which the expected output is known in advance such as in calculating an adoption rate of a particular incentive offer type when historical adoption rates are known.

In some embodiments, a machine learning algorithm uses an unsupervised learning approach. In unsupervised learning, the algorithm generates a function to describe hidden structures from unlabeled data (e.g., a classification or categorization is not included in the observations). Since the examples given to the learner are unlabeled, there is no evaluation of the accuracy of the structure that is output by the relevant algorithm. Approaches to unsupervised learning include: clustering, anomaly detection, and neural networks.

In some embodiments, a machine learning algorithm learns in batches based on the training dataset and other inputs for that batch. In other embodiments, the machine learning algorithm performs on-line learning where the weights and error calculations are constantly updated. In some embodiments, the machine learning algorithm updates the prediction model based on new or updated user data (e.g., from the personalized user profile). For example, a machine learning algorithm can be applied to new or updated data to be re-trained or optimized to generate a new prediction model. In some embodiments, a machine learning algorithm or model is re-trained periodically.

In some embodiments, the classifier or trained algorithm of the present disclosure comprises one feature space. In some cases, the classifier comprises two or more feature spaces. In some embodiments, the two or more feature spaces are distinct from one another. In various embodiments, each feature space comprises types of attributes associated with user demographic information (e.g., gender, age group, ethnicity), user location information (e.g., historical or current location, home location, work location), travel information (e.g., departure time, destination, mode of transportation), responsiveness to various incentive offers or types of incentive offers (e.g., historical adoption rate of incentive offers such as monetary incentives or informational incentives). In some embodiments, the accuracy of the classification or prediction is improved by combining two or more feature spaces in a classifier instead of using a single feature space. The attributes generally make up the input features of the feature space and are labeled to indicate the classification of each communication for the given set of input features corresponding to that communication.

In some embodiments, an algorithm utilizes a predictive model such as a neural network, a decision tree, a support vector machine, or other applicable model. Using the training data, an algorithm is able to form a classifier for generating a classification or prediction according to relevant features. The features selected for classification can be classified using a variety of viable methods. In some embodiments, the trained algorithm comprises a machine learning algorithm. In some embodiments, the machine learning algorithm is selected from at least one of a supervised, semi-supervised and unsupervised learning, such as, for example, a support vector machine (SVM), a Naïve Bayes classification, a random forest, an artificial neural network, a decision tree, a K-means, learning vector quantization (LVQ), regression algorithm (e.g., linear, logistic, multivariate), association rule learning, deep learning, dimensionality reduction and ensemble selection algorithms. In some embodiments, the machine learning algorithm is a support vector machine (SVM), a Naïve Bayes classification, a random forest, or an artificial neural network. Machine learning techniques include bagging procedures, boosting procedures, random forest algorithms, and combinations thereof.

In some embodiments, a machine learning algorithm such as a classifier is tested using data that was not used for training to evaluate its predictive ability. In some embodiments, the predictive ability of the classifier is evaluated using one or more metrics. These metrics include accuracy, specificity, sensitivity, positive predictive value, negative predictive value, which are determined for a classifier by testing it against a set of independent cases. In some instances, an algorithm has an accuracy of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein. In some instances, an algorithm has a specificity of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein. In some instances, an algorithm has a sensitivity of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein. In some instances, an algorithm has a positive predictive value of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein. In some instances an algorithm has a negative predictive value of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein.

Computing System

FIG. 5 is a diagram of hardware and an operating environment in conjunction with which implementations of the traffic management system 100 may be practiced. The description of FIG. 5 is intended to provide a brief, general description of suitable computer hardware and a suitable computing environment in which implementations may be practiced. Although not required, implementations are described in the general context of computer-executable instructions, such as program modules, being executed by a computer, such as a personal computer or the like. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, cloud computing architectures, and the like. Implementations may also be practiced in distributed computing environments where tasks are performed by remote processing devices that are linked through one or more communications networks. In a distributed computing environment, program modules may be located in both local and remote memory storage devices.

The exemplary hardware and operating environment of FIG. 5 includes a general-purpose computing device in the form of a computing device 12. The computing device 12 includes the system memory 22, a processing unit 21, and a system bus 23 that operatively couples various system components, including the system memory 22, to the processing unit 21. There may be only one or there may be more than one processing unit 21, such that the processor of computing device 12 comprises a single central-processing unit (CPU), or a plurality of processing units, commonly referred to as a parallel processing environment. The computing device 12 may be a conventional computer, a distributed computer, a mobile computing device, or any other type of computing device.

The system bus 23 may be any of several types of bus structures including a memory bus or memory controller, a peripheral bus, and a local bus using any of a variety of bus architectures. The system memory 22 may also be referred to as simply the memory, and may include read only memory (ROM) 24 and random access memory (RAM) 25. A basic input/output system (BIOS) 26, containing the basic routines that help to transfer information between elements within the computing device 12, such as during start-up, may be stored in ROM 24. The computing device 12 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media. The computing device 12 may also include one or more other types of memory devices (e.g., flash memory storage devices, and the like).

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, USB drives, and the like) accessible by the processing unit 21 may be considered components of the system memory 22.

A number of program modules may be stored on the hard disk drive 27, magnetic disk 29, optical disk 31, ROM 24, or RAM 25, including an operating system 35, one or more application programs 36, other program modules 37 (e.g., one or more of the modules and applications described above), and program data 38. A user may enter commands and information into the computing device 12 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus 23, but may be connected by other interfaces, such as a parallel port, game port, a universal serial bus (USB), or the like. A monitor 47 or other type of display device is also connected to the system bus 23 via an interface, such as a video adapter 48. In addition to the monitor, computers typically include other peripheral output devices (not shown), such as speakers and printers.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections can include a local-area network (LAN) 51 and a wide-area network (WAN) 52. Such networking environments are commonplace in offices, enterprise-wide computer networks, intranets and the Internet.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

### Digital Processing Device

In some embodiments, the platforms, media, methods and applications described herein include a digital processing device, a processor, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device. In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In some embodiments, the non-volatile memory comprises magnetoresistive random-access memory (MRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a subject. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In some embodiments, the display is E-paper or E ink. In other embodiments, the display is a video projector. In still further embodiments, the display is a combination of devices such as those disclosed herein.

In some embodiments, the digital processing device includes an input device to receive information from a subject. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, media, methods and applications described herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, media, methods and applications described herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™ JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

In one aspect, disclosed herein is an electronic device comprising a memory, a processor, and non-transitory computer readable medium including instructions executable by the processor to create a software application comprising: a software module for receiving travel details for a trip comprising a user-selected origin and destination pair; a software module identifying at least one targeted shift in transit behavior based on the travel details; a software module offering the targeted shift in transit behavior to the user; a software module verifying the user has successfully completed the targeted shift in transit behavior; and a software module communicating details of the trip. In some embodiments, the electronic device and software application are in communication with the traffic campaign management system described herein. In some embodiments, the targeted shift in transit behavior is based on a traffic campaign described herein. In some embodiments, the software application comprises a software module presenting a microsurvey to the user. In some embodiments, the software application is a stand-alone application such as a mobile app that does not require communication with a traffic campaign management system.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications. In some embodiments, the standalone application is independent of a traffic campaign builder. For example, a standalone application can be the mobile application on a user communication device configured to receive transit suggestions without requiring an ongoing traffic campaign. In some cases, the mobile application provides transit suggestions based on user location and other trip information (e.g., destination, mode of transportation, etc.) without further personalizing the transit suggestions based on user profile or other user information.

### Software Modules

In some embodiments, the platforms, media, methods and applications described herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of barcode, route, parcel, subject, or network information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™ PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Certain Terminologies

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, a “user” refers to one or more person or persons associated with an electronic device such as a communication device, mobile phone, smartphone, computer, tablet, or other electronic device. In some embodiments, a device associated with a user is a device carried or worn on the person of the user such as a phone. In some embodiments, a device associated with a user is not carried or worn on the person of the user such as a vehicle navigation system.

As used herein, “user data” refers to information associated with a user of an electronic device. In some embodiments, user data comprises user identity, user name, height, weight, eye color, hair color, ethnicity, national origin, religion, language(s) spoken, vision (e.g., whether user needs corrective lenses), home address, work address, occupation, family information, user contact information, emergency contact information, social security number, alien registration number, driver's license number, vehicle VIN, organ donor (e.g., whether user is an organ donor), or any combination thereof. In some embodiments, user data is obtained via user input such as during registration of a mobile app for providing targeted shifts in transit behavior. User data can include information about the user obtained from social media or responses to microsurvey questions on the mobile app. In some cases, user data includes past travel or transit information. The user data can also include responses to prior targeted shifts in transit behavior offered by the mobile app with and/or without accompanying user incentives. The user profile can include user data.

As used herein, “proximity” refers to a user being within a threshold travel distance or travel time of a geographic location or corridor. In some embodiments, proximity is established for different legs of a trip based on expected user location. For example, a user who enters trip details for traveling from location A to location B and then location C can be offered transit suggestions for traveling from A to B based on proximity to A, and then separate transit suggestions for traveling from B to C based on expected proximity to B. In some embodiments, the threshold travel distance is satisfied when the shortest travel distance between the user and the geographic location or corridor is equal to or shorter than the threshold travel distance. In some embodiments, a travel distance is not a straight-line distance between the user and the geographic location or corridor, but rather is based on an actual route of travel for reaching the geographic location or corridor. In some embodiments, a travel distance or travel time to a travel corridor (e.g., a route, road, or area) is based on a location on the travel corridor that is closest to the user. In some embodiments, a user is in proximity to a geographic location or corridor if the threshold travel distance is no more than 50, 100, 200, 300, 400, 500, 600, 700, 800, 900, or 1000 meters, or no more than 1, 2, 3, 4, 5, 6, 7, 8, 9, 10, 15, 20, 25, or 30 kilometers or more. In some embodiments, the threshold travel time is satisfied when the shortest travel time between a user and the geographic location or corridor is equal to or shorter than the threshold travel time. In some embodiments, a user is in proximity to a geographic location or corridor if the threshold travel time is no more than 1, 2, 3, 4, 5, 6, 7, 8, 9, 10, 15, 20, 25, 30, 35, 40, 45, 50, 55, or 60 minutes or more. In some embodiments, the proximity is a threshold travel distance or travel time set by a user.

### Numbered Embodiments

The following embodiments recite nonlimiting permutations of combinations of features disclosed herein. Other permutations of combinations of features are also contemplated. In particular, each of these numbered embodiments is contemplated as depending from or relating to every previous or subsequent numbered embodiment, independent of their order as listed.

1. A traffic campaign management system, comprising: a) an electronic device application executable on an electronic device of a user; and b) a server in operative communication with the electronic device application deployed to a plurality of electronic devices, the server comprising at least one processor, a memory, and instructions executable by the at least one processor to create a server application comprising: i) a campaign builder module generating a traffic campaign for reducing congestion by making micro-targeted incentive offers personalized to target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof; ii) a reward profile module analyzing user data to generate personalized reward profiles comprising incentive offers predicted to successfully shift transit behavior, the user data comprising responsiveness to previous incentive offers; iii) a campaign targeting module identifying target users by comparing traffic campaign parameters with user data comprising user-selected origin and destination pairs, wherein the user of the electronic device application is one of the target users, and determining at least one available travel option from the targeted shift in transit behavior for the user; iv) an incentive offering module calculating a user incentive for each available travel option according to a reward profile associated with the targeted shift in transit behavior for the user, and presenting the at least one available travel option and associated user incentive to the user; and v) a validation module receiving location information from the electronic device application, and verifying that the user has departed from the origin during a selected departure time window, traveled along at least a portion of the route thereafter, and utilized a selected mode of transportation according to one of the at least one available travel option. 2. The system of embodiment 1, wherein the user data comprises historical user transit behavior. 3. The system of embodiment 2, wherein the historical user transit behavior comprises departure time, mode of transportation, and route traveled for past trips. 4. The system of embodiment 1, wherein the user data comprises a user-selected origin and destination pair, preferred travel time, mode of transportation, or any combination thereof for a current or upcoming trip. 5. The system of embodiment 1, wherein the user data comprises activity or lifestyle, personality, socio-demographic, geo-relation, corridor relation, or any combination thereof. 6. The system of embodiment 5, wherein the campaign builder module allows sorting or filtering based on activity or lifestyle, personality, socio-demographic, geo-relation, corridor relation, or any combination thereof for identifying target users. 7. The system of embodiment 5, wherein geo-relation indicates a user-selected origin and destination pair that matches a location targeted by the traffic campaign for reducing congestion. 8. The system of embodiment 5, wherein corridor relation indicates a user-selected origin and destination pair that matches a route targeted by the traffic campaign for reducing congestion. 9. The system of embodiment 1, wherein the user data is obtained from GPS points, microsurveys, social media, email, or any combination thereof. 10. The system of embodiment 9, wherein the GPS points are a source of user data comprising geo-relation, corridor relation, activity or lifestyle, or any combination thereof. 11. The system of embodiment 9, wherein the microsurveys are a source of user data comprising activity or lifestyle, socio-demographic, psychographic, or any combination thereof. 12. The system of embodiment 9, wherein social media is a source of user data comprising socio-demographic. 13. The system of embodiment 1, further comprising a microsurvey module presenting at least one user with at least one question and user incentive for answering the at least one question. 14. The system of embodiment 13, wherein the microsurvey is triggered to present the at least one question and user incentive based on the user data, wherein the user data is indicative of a current state of the at least one user. 15. The system of embodiment 14, wherein the current state of the at least one user comprises current time, physical location, and interaction with at least one of the plurality of electronic device applications. 16. The system of embodiment 13, wherein the user incentive is selected based on past responsiveness to incentives for the at least one user. 17. The system of embodiment 13, wherein the at least one question is selected based on relevance to the at least one user. 18. The system of embodiment 1, wherein a reward profile comprises personalized incentives associated with different modes of transportation, departure time windows, routes, or any combination thereof. 19. The system of embodiment 18, wherein modes of transportation comprise driving, biking, bus, train, ride-sharing, carpooling, subway, trolley, taxi, walking, scooter, microtransit, or any combination thereof. 20. The system of embodiment 18, wherein modes of transportation comprise a plurality of modes of transportation and an incentive associated with each of the plurality of modes of transportation. 21. The system of embodiment 18, wherein a reward profile comprises a plurality of departure time windows and an incentive associated with each of the plurality of departure time windows. 22. The system of embodiment 18, wherein a reward profile comprises a plurality of departure time windows proximate to a preferred travel time. 23. The system of embodiment 18, wherein a reward profile comprises a plurality of routes and an incentive associated with each of the plurality of routes. 24. The system of embodiment 1, wherein a reward profile is adjusted to increase incentives corresponding to the targeted shift in transit behavior. 25. The system of embodiment 1, wherein the traffic campaign comprises location, duration, budget, and targeted number of users. 26. The system of embodiment 25, wherein the incentive offering module offers the user incentive based on a reward profile of the user so as to maximize the targeted shift in transit behavior without exceeding the budget. 27. The system of embodiment 25, wherein the incentive offering module offers the user incentive based on a reward profile of the user so as to maximize a ratio of the targeted shift in transit behavior to a cost of the incentives. 28. The system of embodiment 25, wherein the incentive offering module continues offering incentives to target users until the targeted number of users have accepted the targeted shift in transit behavior or performed the targeted shift in transit behavior. 29. The system of embodiment 25, wherein the incentive offering module continues offering incentives to target users until the budget has been expended. 30. The system of embodiment 25, wherein comparing traffic campaign parameters with user data comprises determining a geo-relation or corridor relation between users and the location of the traffic campaign. 31. The system of embodiment 1, wherein the campaign targeting module dynamically identifies target users by receiving current or upcoming transit information from the target users and comparing the transit information with traffic campaign parameters. 32. The system of embodiment 1, wherein the campaign targeting module identifies target users by comparing traffic campaign parameters with user data before receiving current or upcoming transit information from the target users. 33. The system of embodiment 1, wherein the campaign targeting module presents incentive offers to target users in an order that minimizes cost of attaining the targeted shift in transit behavior for a targeted number of users. 34. The system of embodiment 1, wherein target users are sorted into groups based on incentives corresponding to the targeted shift in transit behavior, wherein target users with lower incentives are presented with incentive offers before target users with higher incentives. 35. The system of embodiment 1, wherein the traffic campaign comprises an incentive threshold that places a limit on an incentive amount that can be offered to a target user. 36. The system of embodiment 1, wherein the targeted shift in transit behavior is a shift in mode of transportation, a shift in departure time, a shift in route, or any combination thereof. 37. The system of embodiment 36, wherein the shift in mode of transportation comprises a change from driving to biking, bus, train, walking, or any combination thereof. 38. The system of embodiment 36, wherein the shift in departure time comprises multiple departure time windows proximate in time to a preferred travel time for a user-selected origin and destination pair, wherein each of the departure time windows corresponds to a time interval when a user is to depart from the origin and travel along a route toward the destination. 39. The system of embodiment 36, wherein the shift in route comprises at least one additional route distinct from a preferred route for a user-selected origin and destination pair. 40. The system of embodiment 1, wherein the validation module disburses the user incentive offered to the at least one target user after verifying that the at least one target user has performed the targeted shift in transit behavior. 41. The system of embodiment 1, wherein the verifying that the at least one target user has performed the targeted shift in transit behavior comprises analyzing location data obtained from at least one electronic device of the at least one target user. 42. The system of embodiment 41, wherein the verifying comprises determining a mode of transportation used by the at least one target user and comparing a mode of transportation of the at least one target user with a targeted shift in mode of transportation. 43. The system of embodiment 41, wherein the verifying comprises comparing a departure time of the at least one target user with a targeted shift in departure time. 44. The system of embodiment 41, wherein the verifying comprises comparing a route taken by the at least one target user with a targeted shift in route. 45. The system of embodiment 1, further comprising a transaction module tracking incentives collected by users and allowing exchange of incentives for rewards. 46. The system of embodiment 45, wherein incentives comprise points that are redeemable for rewards. 47. The system of embodiment 45, wherein rewards comprise parking, high occupancy vehicle designation, third party purchases, vouchers, discounts, gift cards, cash, or any combination thereof. 48. The system of embodiment 1, wherein the user incentive has a monetary or non-monetary value. 49. The system of embodiment 1, wherein the user incentive is selected to appeal to a lifestyle, socio-demographic, or psychographic aspect of the at least one user. 50. The system of embodiment 1, further comprising an analytics module calculating results of the traffic campaign. 51. The system of embodiment 50, wherein the results comprise number of users shifted, change in average travel speed, average cost per user shifted, or any combination thereof. 52. The system of embodiment 1, wherein the traffic campaign is a static campaign configured by an administrative user. 53. The system of embodiment 1, wherein the traffic campaign is a dynamic campaign that is automatically configured in response to one or more traffic events. 54. The system of embodiment 1, wherein the electronic device is a mobile device, a tablet, a laptop, a computer, or a vehicle console. 55. A computer-implemented method for conducting a traffic campaign for reducing congestion, comprising: a) generating a traffic campaign for reducing congestion by making micro-targeted incentive offers personalized to target users via electronic devices of the target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof b) analyzing user data to generate personalized reward profiles comprising incentive offers predicted to successfully shift transit behavior, the user data comprising responsiveness to previous incentive offers; c) identifying target users by comparing traffic campaign parameters with user data comprising user-selected origin and destination pairs; d) determining at least one available travel option from the targeted shift in transit behavior for a user selected from the target users; e) calculating a user incentive for each available travel option according to a reward profile associated with the targeted shift in transit behavior for the user; f) presenting the at least one available travel option and associated user incentive to the user; g) receiving location information from the electronic device application; and h) verifying that the user has departed from the origin during a selected departure time window, traveled along at least a portion of the route thereafter, and utilized a selected mode of transportation according to one of the at least one available travel option. 56. The method of embodiment 55, wherein the user data comprises historical user transit behavior. 57. The method of embodiment 56, wherein the historical user transit behavior comprises departure time, mode of transportation, and route traveled for past trips. 58. The method of embodiment 55, wherein the user data comprises a user-selected origin and destination pair, preferred travel time, mode of transportation, or any combination thereof for a current or upcoming trip. 59. The method of embodiment 55, wherein the user data comprises activity or lifestyle, personality, socio-demographic, geo-relation, corridor relation, or any combination thereof. 60. The method of embodiment 59, further comprising sorting or filtering based on activity or lifestyle, personality, socio-demographic, geo-relation, corridor relation, or any combination thereof for identifying the at least one target user. 61. The method of embodiment 59, wherein geo-relation indicates a user-selected origin and destination pair that matches a location targeted by the traffic campaign for reducing congestion. 62. The method of embodiment 59, wherein corridor relation indicates a user-selected origin and destination pair that matches a route targeted by the traffic campaign for reducing congestion. 63. The method of embodiment 55, wherein the user data is obtained from GPS points, microsurveys, social media, email, or any combination thereof. 64. The method of embodiment 63, wherein the GPS points are a source of user data comprising geo-relation, corridor relation, activity or lifestyle, or any combination thereof. 65. The method of embodiment 63, wherein the microsurveys are a source of user data comprising activity or lifestyle, socio-demographic, psychographic, or any combination thereof. 66. The method of embodiment 63, wherein social media is a source of user data comprising socio-demographic. 67. The method of embodiment 55, further comprising presenting at least one user with a microsurvey comprising at least one question and user incentive for answering the at least one question. 68. The method of embodiment 67, wherein the microsurvey is triggered to present the at least one question and user incentive based on the user data, wherein the user data is indicative of a current state of the at least one user. 69. The method of embodiment 68, wherein the current state of the at least one user comprises current time, physical location, and interaction with at least one of the plurality of electronic device applications. 70. The method of embodiment 67, wherein the user incentive is selected based on past responsiveness to incentives for the at least one user. 71. The method of embodiment 67, wherein the at least one question is selected based on relevance to the at least one user. 72. The method of embodiment 55, wherein a reward profile comprises personalized incentives associated with different modes of transportation, departure time windows, routes, or any combination thereof. 73. The method of embodiment 72, wherein modes of transportation comprise driving, biking, bus, train, ride-sharing, carpooling, subway, trolley, taxi, walking, scooter, microtransit, or any combination thereof. 74. The method of embodiment 72, wherein modes of transportation comprise a plurality of modes of transportation and an incentive associated with each of the plurality of modes of transportation. 75. The method of embodiment 72, wherein a reward profile comprises a plurality of departure time windows and an incentive associated with each of the plurality of departure time windows. 76. The method of embodiment 72, wherein a reward profile comprises a plurality of departure time windows proximate to a preferred travel time. 77. The method of embodiment 72, wherein a reward profile comprises a plurality of routes and an incentive associated with each of the plurality of routes. 78. The method of embodiment 55, wherein a reward profile is adjusted to increase the incentives corresponding to the targeted shift in transit behavior. 79. The method of embodiment 55, wherein the traffic campaign further comprises location, duration, budget, and targeted number of users. 80. The method of embodiment 79, wherein the user incentive is based on a reward profile of the user so as to maximize the targeted shift in transit behavior without exceeding the budget. 81. The method of embodiment 79, wherein the user incentive is based on a reward profile of the user so as to maximize a ratio of the targeted shift in transit behavior to a cost of the user incentive. 82. The method of embodiment 79, further comprising continuing to offer incentives to target users until the targeted number of users have accepted the targeted shift in transit behavior or performed the targeted shift in transit behavior. 83. The method of embodiment 79, further comprising continuing to offer incentives to target users until the budget has been expended. 84. The method of embodiment 79, wherein comparing the user data with traffic campaign parameters comprises determining a geo-relation or corridor relation between users and the location of the traffic campaign. 85. The method of embodiment 55, wherein target users are dynamically identified by receiving current or upcoming transit information from the target users and comparing the transit information with traffic campaign parameters. 86. The method of embodiment 55, wherein target users are identified by comparing traffic campaign parameters with user data before receiving current or upcoming transit information from the target users. 87. The method of embodiment 55, wherein incentives are offered to target users in an order that minimizes cost of attaining the targeted shift in transit behavior for a targeted number of users. 88. The method of embodiment 55, wherein target users are sorted into groups based on incentives corresponding to the targeted shift in transit behavior, wherein target users with lower incentives are presented with incentive offers before target users with higher incentives. 89. The method of embodiment 55, wherein the traffic campaign comprises an incentive threshold that places a limit on an incentive amount that can be offered to a target user. 90. The method of embodiment 55, wherein the targeted shift in transit behavior is a shift in mode of transportation, a shift in departure time, a shift in route, or any combination thereof. 91. The method of embodiment 90, wherein the shift in mode of transportation comprises a change from driving to biking, bus, train, walking, or any combination thereof. 92. The method of embodiment 90, wherein the shift in departure time comprises multiple departure time windows proximate in time to a preferred travel time for a user-selected origin and destination pair, wherein each of the departure time windows corresponds to a time interval when a user is to depart from the origin and travel along a route toward the destination. 93. The method of embodiment 90, wherein the shift in route comprises at least one additional route distinct from a preferred route for a user-selected origin and destination pair. 94. The method of embodiment 55, further comprising disbursing the user incentive offered to the at least one target user after verifying that the at least one target user has performed the targeted shift in transit behavior. 95. The method of embodiment 55, wherein the verifying that the at least one target user has performed the targeted shift in transit behavior comprises analyzing location data obtained from at least one electronic device of the at least one target user. 96. The method of embodiment 95, wherein the verifying comprises determining a mode of transportation used by the at least one target user and comparing a mode of transportation of the at least one target user with a targeted shift in mode of transportation. 97. The method of embodiment 95, wherein the verifying comprises comparing a departure time of the at least one target user with a targeted shift in departure time. 98. The method of embodiment 95, wherein the verifying comprises comparing a route taken by the at least one target user with a targeted shift in route. 99. The method of embodiment 55, further comprising tracking incentives collected by users and allowing exchange of incentives for rewards. 100. The method of embodiment 99, wherein incentives comprise points that are redeemable for rewards. 101. The method of embodiment 99, wherein rewards comprise parking, high occupancy vehicle designation, third party purchases, vouchers, discounts, gift cards, cash, or any combination thereof. 102. The method of embodiment 55, wherein the user incentive has a monetary or non-monetary value. 103. The method of embodiment 55, wherein the user incentive is selected to appeal to a lifestyle, socio-demographic, or psychographic aspect of the at least one user. 104. The method of embodiment 55, further comprising calculating results of the traffic campaign. 105. The method of embodiment 104, wherein the results comprise number of users shifted, change in average travel speed, average cost per user shifted, or any combination thereof. 106. The method of embodiment 55, wherein the traffic campaign is a static campaign configured by an administrative user. 107. The method of embodiment 55, wherein the traffic campaign is a dynamic campaign that is automatically configured in response to one or more traffic events. 108. The method of embodiment 55, wherein the electronic device is a mobile device, a tablet, a laptop, a computer, or a vehicle console. 109. Non-transitory computer-readable storage media encoded with a computer program including instructions executable by at least one processor to create a computer software server system in operative communication with a plurality of electronic device applications executable on a plurality of electronic devices of a plurality of users, the computer software server system comprising: i) a campaign builder module generating a traffic campaign for reducing congestion by making micro-targeted incentive offers personalized to target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof; ii) a reward profile module analyzing user data to generate personalized reward profiles comprising incentive offers predicted to successfully shift transit behavior, the user data comprising responsiveness to previous incentive offers; iii) a campaign targeting module identifying target users by comparing traffic campaign parameters with user data comprising user-selected origin and destination pairs, and determining at least one available travel option from the targeted shift in transit behavior for a user; iv) an incentive offering module calculating a user incentive for each available travel option according to a reward profile associated with the targeted shift in transit behavior for the user, and presenting the at least one available travel option and associated user incentive to the user; and v) a validation module receiving location information from the electronic device application, and verifying that the user has departed from the origin during a selected departure time window, traveled along at least a portion of the route thereafter, and utilized a selected mode of transportation according to one of the at least one available travel option. 110. The media of embodiment 109, wherein the user data comprises historical user transit behavior. 111. The media of embodiment 110, wherein the historical user transit behavior comprises departure time, mode of transportation, and route traveled for past trips. 112. The media of embodiment 109, wherein the user data comprises a user-selected origin and destination pair, preferred travel time, mode of transportation, or any combination thereof for a current or upcoming trip. 113. The media of embodiment 109, wherein the user data comprises activity or lifestyle, personality, socio-demographic, geo-relation, corridor relation, or any combination thereof. 114. The media of embodiment 113, wherein the campaign builder module allows sorting or filtering based on activity or lifestyle, personality, socio-demographic, geo-relation, corridor relation, or any combination thereof for identifying the at least one target user. 115. The media of embodiment 113, wherein geo-relation indicates a user-selected origin and destination pair that matches a location targeted by the traffic campaign for reducing congestion. 116. The media of embodiment 113, wherein corridor relation indicates a user-selected origin and destination pair that matches a route targeted by the traffic campaign for reducing congestion. 117. The media of embodiment 109, wherein the user data is obtained from GPS points, microsurveys, social media, email, or any combination thereof. 118. The media of embodiment 117, wherein the GPS points are a source of user data comprising geo-relation, corridor relation, activity or lifestyle, or any combination thereof. 119. The media of embodiment 117, wherein the microsurveys are a source of user data comprising activity or lifestyle, socio-demographic, psychographic, or any combination thereof. 120. The media of embodiment 117, wherein social media is a source of user data comprising socio-demographic. 121. The media of embodiment 109, further comprising a microsurvey module presenting at least one user with at least one question and user incentive for answering the at least one question. 122. The media of embodiment 121, wherein the microsurvey is triggered to present the at least one question and user incentive based on the user data, wherein the user data is indicative of a current state of the at least one user. 123. The media of embodiment 122, wherein the current state of the at least one user comprises current time, physical location, and interaction with at least one of the plurality of electronic device applications. 124. The media of embodiment 121, wherein the user incentive is selected based on past responsiveness to incentives for the at least one user. 125. The media of embodiment 121, wherein the at least one question is selected based on relevance to the at least one user. 126. The media of embodiment 109, wherein a reward profile comprises personalized incentives associated with different modes of transportation, departure time windows, routes, or any combination thereof. 127. The media of embodiment 126, wherein modes of transportation comprise driving, biking, bus, train, ride-sharing, carpooling, subway, trolley, taxi, walking, scooter, microtransit, or any combination thereof. 128. The media of embodiment 126, wherein modes of transportation comprise a plurality of modes of transportation and an incentive associated with each of the plurality of modes of transportation 129. The media of embodiment 126, wherein a reward profile comprises a plurality of departure time windows and an incentive associated with each of the plurality of departure time windows. 130. The media of embodiment 126, wherein a reward profile comprises a plurality of departure time windows proximate to a preferred travel time. 131. The media of embodiment 126, wherein a reward profile comprises a plurality of routes and an incentive associated with each of the plurality of routes. 132. The media of embodiment 109, wherein a reward profile is adjusted to increase the incentives corresponding to the targeted shift in transit behavior. 133. The media of embodiment 109, wherein the traffic campaign comprises location, duration, budget, and targeted number of users. 134. The media of embodiment 133, wherein the incentive offering module offers incentives to the at least one target user based on reward profiles of said target user so as to maximize the targeted shift in transit behavior without exceeding the budget. 135. The media of embodiment 133, wherein the incentive offering module offers the user incentive based on a reward profile of the user so as to maximize a ratio of the targeted shift in transit behavior to a cost of the incentives 136. The media of embodiment 133, wherein the incentive offering module continues offering incentives to target users until the targeted number of users have accepted the targeted shift in transit behavior or performed the targeted shift in transit behavior. 137. The media of embodiment 133, wherein the incentive offering module continues offering incentives to target users until the budget has been expended. 138. The media of embodiment 133, wherein comparing the user data with traffic campaign parameters comprises determining a geo-relation or corridor relation between users and the location of the traffic campaign. 139. The media of embodiment 109, wherein the campaign targeting module dynamically identifies target users by receiving current or upcoming transit information from the target users and comparing the transit information with traffic campaign parameters. 140. The media of embodiment 109, wherein the campaign targeting module identifies target users by comparing traffic campaign parameters with user data before receiving current or upcoming transit information from the target users. 141. The media of embodiment 109, wherein the campaign targeting module presents incentive offers to target users in an order that minimizes cost of attaining the targeted shift in transit behavior for a targeted number of users. 142. The media of embodiment 109, wherein target users are sorted into groups based on incentives corresponding to the targeted shift in transit behavior, wherein target users with lower incentives are presented with incentive offers before target users with higher incentives. 143. The media of embodiment 109, wherein the traffic campaign comprises an incentive threshold that places a limit on an incentive amount that can be offered to a target user. 144. The media of embodiment 109, wherein the targeted shift in transit behavior is a shift in mode of transportation, a shift in departure time, a shift in route, or any combination thereof. 145. The media of embodiment 144, wherein the shift in mode of transportation comprises a change from driving to biking, bus, train, walking, or any combination thereof. 146. The media of embodiment 144, wherein the shift in departure time comprises multiple departure time windows proximate in time to a preferred travel time for a user-selected origin and destination pair, wherein each of the departure time windows corresponds to a time interval when a user is to depart from the origin and travel along a route toward the destination. 147. The media of embodiment 144, wherein the shift in route comprises at least one additional route distinct from a preferred route for a user-selected origin and destination pair. 148. The media of embodiment 109, wherein the validation module disburses the user incentive offered to the at least one target user after verifying that the at least one target user has performed the targeted shift in transit behavior. 149. The media of embodiment 109, wherein the verifying that the at least one target user has performed the targeted shift in transit behavior comprises analyzing location data obtained from at least one electronic device of the at least one target user. 150. The media of embodiment 149, wherein the verifying comprises determining a mode of transportation used by the at least one target user and comparing a mode of transportation of the at least one target user with a targeted shift in mode of transportation. 151. The media of embodiment 149, wherein the verifying comprises comparing a departure time of the at least one target user with a targeted shift in departure time. 152. The media of embodiment 149, wherein the verifying comprises comparing a route taken by the at least one target user with a targeted shift in route. 153. The media of embodiment 109, further comprising a transaction module tracking incentives collected by users and allowing exchange of incentives for rewards. 154. The media of embodiment 153, wherein incentives comprise points that are redeemable for rewards. 155. The media of embodiment 153, wherein rewards comprise parking, high occupancy vehicle designation, third party purchases, vouchers, discounts, gift cards, cash, or any combination thereof. 156. The media of embodiment 109, wherein the user incentive has a monetary or non-monetary value. 157. The media of embodiment 109, wherein the user incentive is selected to appeal to a lifestyle, socio-demographic, or psychographic aspect of the at least one user. 158. The media of embodiment 109, further comprising an analytics module calculating results of the traffic campaign. 159. The media of embodiment 158, wherein the results comprise number of users shifted, change in average travel speed, average cost per user shifted, or any combination thereof. 160. The media of embodiment 109, wherein the traffic campaign is a static campaign configured by an administrative user. 161. The media of embodiment 109, wherein the traffic campaign is a dynamic campaign that is automatically configured in response to one or more traffic events. 162. The media of embodiment 109, wherein the electronic device is a mobile device, a tablet, a laptop, a computer, or a vehicle console. 163. A traffic campaign management system, comprising: a) an electronic device application executable on an electronic device of a user; and b) a server in operative communication with the electronic device application deployed to a plurality of electronic devices, the server comprising at least one processor, a memory, and instructions executable by the at least one processor to create a server application comprising: i) a campaign builder module generating a traffic campaign for reducing congestion by making micro-targeted transit suggestions personalized to target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof; ii) a reward profile module analyzing user data to generate personalized reward profiles comprising transit suggestions predicted to successfully shift transit behavior, the user data comprising responsiveness to previous transit suggestions; iii) a campaign targeting module identifying target users by comparing traffic campaign parameters with user data comprising user-selected origin and destination pairs, wherein the user of the electronic device application is one of the target users, and determining at least one available travel option from the targeted shift in transit behavior for the user; iv) a transit suggestion module determining a transit suggestion for each available travel option according to a reward profile associated with the targeted shift in transit behavior for the user, and presenting the at least one available travel option and the transit suggestion to the user. 164. The system of embodiment 163, wherein the user data comprises historical user transit behavior. 165. The system of embodiment 164, wherein the historical user transit behavior comprises departure time, mode of transportation, and route traveled for past trips. 166. The system of embodiment 163, wherein the user data comprises a user-selected origin and destination pair, preferred travel time, mode of transportation, or any combination thereof for a current or upcoming trip. 167. The system of embodiment 163, wherein the user data comprises activity or lifestyle, personality, socio-demographic, geo-relation, corridor relation, or any combination thereof. 168. The system of embodiment 167, wherein the campaign builder module allows sorting or filtering based on activity or lifestyle, personality, socio-demographic, geo-relation, corridor relation, or any combination thereof for identifying target users. 169. The system of embodiment 167, wherein geo-relation indicates a user-selected origin and destination pair that matches a location targeted by the traffic campaign for reducing congestion. 170. The system of embodiment 167, wherein corridor relation indicates a user-selected origin and destination pair that matches a route targeted by the traffic campaign for reducing congestion. 171. The system of embodiment 163, wherein the user data is obtained from GPS points, microsurveys, social media, email, or any combination thereof. 172. The system of embodiment 171, wherein the GPS points are a source of user data comprising geo-relation, corridor relation, activity or lifestyle, or any combination thereof. 173. The system of embodiment 171, wherein the microsurveys are a source of user data comprising activity or lifestyle, socio-demographic, psychographic, or any combination thereof. 174. The system of embodiment 171, wherein social media is a source of user data comprising socio-demographic. 175. The system of embodiment 163, further comprising a microsurvey module presenting at least one user with at least one question and an incentive offer for answering the at least one question. 176. The system of embodiment 175, wherein the microsurvey is triggered to present the at least one question and the incentive offer based on the user data, wherein the user data is indicative of a current state of the at least one user. 177. The system of embodiment 176, wherein the current state of the at least one user comprises current time, physical location, and interaction with at least one of the plurality of electronic device applications. 178. The system of embodiment 175, wherein the transit suggestion is selected based on responsiveness to past transit suggestions for the at least one user. 179. The system of embodiment 175, wherein the at least one question is selected based on relevance to the at least one user. 180. The system of embodiment 163, wherein a reward profile comprises personalized transit suggestions associated with different modes of transportation, departure time windows, routes, or any combination thereof. 181. The system of embodiment 180, wherein modes of transportation comprise driving, biking, bus, train, ride-sharing, carpooling, subway, trolley, taxi, walking, scooter, microtransit, or any combination thereof. 182. The system of embodiment 180, wherein modes of transportation comprise a plurality of modes of transportation and a transit suggestion associated with each of the plurality of modes of transportation. 183. The system of embodiment 180, wherein a reward profile comprises a plurality of departure time windows and a transit suggestion associated with each of the plurality of departure time windows. 184. The system of embodiment 180, wherein a reward profile comprises a plurality of departure time windows proximate to a preferred travel time. 185. The system of embodiment 180, wherein a reward profile comprises a plurality of routes and a transit suggestion associated with each of the plurality of routes. 186. The system of embodiment 163, wherein a reward profile is adjusted to provide an incentive corresponding to the targeted shift in transit behavior. 187. The system of embodiment 163, wherein the traffic campaign comprises location, duration, and targeted number of users. 188. The system of embodiment 187, wherein the transit suggestion module offers the transit suggestion based on a reward profile of the user so as to maximize the targeted shift in transit behavior. 189. The system of embodiment 187, wherein the transit suggestion module continues offering transit suggestions to target users until the targeted number of users have accepted the targeted shift in transit behavior or performed the targeted shift in transit behavior. 190. The system of embodiment 187, wherein comparing traffic campaign parameters with user data comprises determining a geo-relation or corridor relation between users and the location of the traffic campaign. 191. The system of embodiment 163, wherein the campaign targeting module dynamically identifies target users by receiving current or upcoming transit information from the target users and comparing the transit information with traffic campaign parameters. 192. The system of embodiment 163, wherein the campaign targeting module identifies target users by comparing traffic campaign parameters with user data before receiving current or upcoming transit information from the target users. 193. The system of embodiment 163, wherein the campaign targeting module presents transit suggestions to target users in an order that maximizes an adoption rate for the targeted shift in transit behavior for a targeted number of users. 194. The system of embodiment 163, wherein the targeted shift in transit behavior is a shift in mode of transportation, a shift in departure time, a shift in route, or any combination thereof. 195. The system of embodiment 194, wherein the shift in mode of transportation comprises a change from driving to biking, bus, train, walking, or any combination thereof. 196. The system of embodiment 194, wherein the shift in departure time comprises multiple departure time windows proximate in time to a preferred travel time for a user-selected origin and destination pair, wherein each of the departure time windows corresponds to a time interval when a user is to depart from the origin and travel along a route toward the destination. 197. The system of embodiment 194, wherein the shift in route comprises at least one additional route distinct from a preferred route for a user-selected origin and destination pair. 198. The system of embodiment 163, wherein the transit suggestion has no monetary value. 199. The system of embodiment 163, wherein the transit suggestion is selected to appeal to a lifestyle, socio-demographic, or psychographic aspect of the at least one user. 200. The system of embodiment 163, further comprising an analytics module calculating results of the traffic campaign. 201. The system of embodiment 200, wherein the results comprise number of users shifted, change in average travel speed, average cost per user shifted, or any combination thereof. 202. The system of embodiment 163, wherein the traffic campaign is a static campaign configured by an administrative user. 203. The system of embodiment 163, wherein the traffic campaign is a dynamic campaign that is automatically configured in response to one or more traffic events. 204. The system of embodiment 163, wherein the electronic device is a mobile device, a tablet, a laptop, a computer, or a vehicle console. 205. The system of embodiment 163, wherein the server application further comprises a validation module receiving location information from the electronic device application, and verifying that the user has departed from the origin during a selected departure time window, traveled along at least a portion of the route thereafter, and utilized a selected mode of transportation according to one of the at least one available travel option. 206. A computer-implemented method for conducting a traffic campaign for reducing congestion, comprising: a) generating a traffic campaign for reducing congestion by making micro-targeted transit suggestions personalized to target users via electronic devices of the target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof b) analyzing user data to generate personalized reward profiles comprising transit suggestions predicted to successfully shift transit behavior, the user data comprising responsiveness to previous transit suggestions; c) identifying target users by comparing traffic campaign parameters with user data comprising user-selected origin and destination pairs; d) determining at least one available travel option from the targeted shift in transit behavior for a user selected from the target users; e) determining a transit suggestion for each available travel option according to a reward profile associated with the targeted shift in transit behavior for the user; and f) presenting the at least one available travel option and the transit suggestion to the user. 207. The method of embodiment 206, wherein the user data comprises historical user transit behavior. 208. The method of embodiment 207, wherein the historical user transit behavior comprises departure time, mode of transportation, and route traveled for past trips. 209. The method of embodiment 206, wherein the user data comprises a user-selected origin and destination pair, preferred travel time, mode of transportation, or any combination thereof for a current or upcoming trip. 210. The method of embodiment 206, wherein the user data comprises activity or lifestyle, personality, socio-demographic, geo-relation, corridor relation, or any combination thereof. 211. The method of embodiment 210, further comprising sorting or filtering based on activity or lifestyle, personality, socio-demographic, geo-relation, corridor relation, or any combination thereof for identifying the at least one target user. 212. The method of embodiment 210, wherein geo-relation indicates a user-selected origin and destination pair that matches a location targeted by the traffic campaign for reducing congestion. 213. The method of embodiment 210, wherein corridor relation indicates a user-selected origin and destination pair that matches a route targeted by the traffic campaign for reducing congestion. 214. The method of embodiment 206, wherein the user data is obtained from GPS points, microsurveys, social media, email, or any combination thereof. 215. The method of embodiment 214, wherein the GPS points are a source of user data comprising geo-relation, corridor relation, activity or lifestyle, or any combination thereof. 216. The method of embodiment 214, wherein the microsurveys are a source of user data comprising activity or lifestyle, socio-demographic, psychographic, or any combination thereof. 217. The method of embodiment 214, wherein social media is a source of user data comprising socio-demographic. 218. The method of embodiment 206, further comprising presenting at least one user with a microsurvey comprising at least one question and an incentive offer for answering the at least one question. 219. The method of embodiment 218, wherein the microsurvey is triggered to present the at least one question and the incentive offer based on the user data, wherein the user data is indicative of a current state of the at least one user. 220. The method of embodiment 219, wherein the current state of the at least one user comprises current time, physical location, and interaction with at least one of the plurality of electronic device applications. 221. The method of embodiment 218, wherein the transit suggestion is selected based on responsiveness to past transit suggestions for the at least one user. 222. The method of embodiment 218, wherein the at least one question is selected based on relevance to the at least one user. 223. The method of embodiment 206, wherein a reward profile comprises personalized transit suggestions associated with different modes of transportation, departure time windows, routes, or any combination thereof. 224. The method of embodiment 223, wherein modes of transportation comprise driving, biking, bus, train, ride-sharing, carpooling, subway, trolley, taxi, walking, scooter, microtransit, or any combination thereof. 225. The method of embodiment 223, wherein modes of transportation comprise a plurality of modes of transportation and a transit suggestion associated with each of the plurality of modes of transportation. 226. The method of embodiment 223, wherein a reward profile comprises a plurality of departure time windows and a transit suggestion associated with each of the plurality of departure time windows. 227. The method of embodiment 223, wherein a reward profile comprises a plurality of departure time windows proximate to a preferred travel time. 228. The method of embodiment 223, wherein a reward profile comprises a plurality of routes and a transit suggestion associated with each of the plurality of routes. 229. The method of embodiment 206, wherein a reward profile is adjusted to provide an incentive corresponding to the targeted shift in transit behavior. 230. The method of embodiment 206, wherein the traffic campaign comprises location, duration, and targeted number of users. 231. The method of embodiment 230, wherein the transit suggestion is based on a reward profile of the user so as to maximize the targeted shift in transit behavior. 232. The method of embodiment 230, further comprising continuing to offer transit suggestions to target users until the targeted number of users have accepted the targeted shift in transit behavior or performed the targeted shift in transit behavior. 233. The method of embodiment 230, wherein comparing the user data with traffic campaign parameters comprises determining a geo-relation or corridor relation between users and the location of the traffic campaign. 234. The method of embodiment 206, wherein target users are dynamically identified by receiving current or upcoming transit information from the target users and comparing the transit information with traffic campaign parameters. 235. The method of embodiment 206, wherein target users are identified by comparing traffic campaign parameters with user data before receiving current or upcoming transit information from the target users. 236. The method of embodiment 206, wherein incentives are offered to target users in an order that maximizes an adoption rate for the targeted shift in transit behavior for a targeted number of users. 237. The method of embodiment 206, wherein the targeted shift in transit behavior is a shift in mode of transportation, a shift in departure time, a shift in route, or any combination thereof. 238. The method of embodiment 237, wherein the shift in mode of transportation comprises a change from driving to biking, bus, train, walking, or any combination thereof. 239. The method of embodiment 237, wherein the shift in departure time comprises multiple departure time windows proximate in time to a preferred travel time for a user-selected origin and destination pair, wherein each of the departure time windows corresponds to a time interval when a user is to depart from the origin and travel along a route toward the destination. 240. The method of embodiment 237, wherein the shift in route comprises at least one additional route distinct from a preferred route for a user-selected origin and destination pair. 241. The method of embodiment 206, wherein the transit suggestion has no monetary value. 242. The method of embodiment 206, wherein the transit suggestion is selected to appeal to a lifestyle, socio-demographic, or psychographic aspect of the at least one user. 243. The method of embodiment 206, further comprising calculating results of the traffic campaign. 244. The method of embodiment 243, wherein the results comprise number of users shifted, change in average travel speed, average cost per user shifted, or any combination thereof. 245. The method of embodiment 206, wherein the traffic campaign is a static campaign configured by an administrative user. 246. The method of embodiment 206, wherein the traffic campaign is a dynamic campaign that is automatically configured in response to one or more traffic events. 247. The method of embodiment 206, wherein the electronic device is a mobile device, a tablet, a laptop, a computer, or a vehicle console. 248. The method of embodiment 206, further comprising receiving location information from the electronic device application, and verifying that the user has departed from the origin during a selected departure time window, traveled along at least a portion of the route thereafter, and utilized a selected mode of transportation according to one of the at least one available travel option. 249. Non-transitory computer-readable storage media encoded with a computer program including instructions executable by at least one processor to create a computer software server system in operative communication with a plurality of electronic device applications executable on a plurality of electronic devices of a plurality of users, the computer software server system comprising: i) a campaign builder module generating a traffic campaign for reducing congestion by making micro-targeted transit suggestions personalized to target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof; ii) a reward profile module analyzing user data to generate personalized reward profiles comprising transit suggestions predicted to successfully shift transit behavior, the user data comprising responsiveness to previous transit suggestions; iii) a campaign targeting module identifying target users by comparing traffic campaign parameters with user data comprising user-selected origin and destination pairs, and determining at least one available travel option from the targeted shift in transit behavior for a user; iv) a transit suggestion module determining a transit suggestion for each available travel option according to a reward profile associated with the targeted shift in transit behavior for the user, and presenting the at least one available travel option and the transit suggestion to the user. 250. The media of embodiment 249, wherein the user data comprises historical user transit behavior. 251. The media of embodiment 250, wherein the historical user transit behavior comprises departure time, mode of transportation, and route traveled for past trips. 252. The media of embodiment 249, wherein the user data comprises a user-selected origin and destination pair, preferred travel time, mode of transportation, or any combination thereof for a current or upcoming trip. 253. The media of embodiment 249, wherein the user data comprises activity or lifestyle, personality, socio-demographic, geo-relation, corridor relation, or any combination thereof. 254. The media of embodiment 253, wherein the campaign builder module allows sorting or filtering based on activity or lifestyle, personality, socio-demographic, geo-relation, corridor relation, or any combination thereof for identifying the at least one target user. 255. The media of embodiment 253, wherein geo-relation indicates a user-selected origin and destination pair that matches a location targeted by the traffic campaign for reducing congestion. 256. The media of embodiment 253, wherein corridor relation indicates a user-selected origin and destination pair that matches a route targeted by the traffic campaign for reducing congestion. 257. The media of embodiment 249, wherein the user data is obtained from GPS points, microsurveys, social media, email, or any combination thereof. 258. The media of embodiment 257, wherein the GPS points are a source of user data comprising geo-relation, corridor relation, activity or lifestyle, or any combination thereof. 259. The media of embodiment 257, wherein the microsurveys are a source of user data comprising activity or lifestyle, socio-demographic, psychographic, or any combination thereof. 260. The media of embodiment 257, wherein social media is a source of user data comprising socio-demographic. 261. The media of embodiment 249, further comprising a microsurvey module presenting at least one user with at least one question and an incentive offer for answering the at least one question. 262. The media of embodiment 261, wherein the microsurvey is triggered to present the at least one question and the incentive offer based on the user data, wherein the user data is indicative of a current state of the at least one user. 263. The media of embodiment 262, wherein the current state of the at least one user comprises current time, physical location, and interaction with at least one of the plurality of electronic device applications. 264. The media of embodiment 261, wherein the transit suggestion is selected based on responsiveness to past transit suggestions for the at least one user. 265. The media of embodiment 261, wherein the at least one question is selected based on relevance to the at least one user. 266. The media of embodiment 249, wherein a reward profile comprises personalized transit suggestions associated with different modes of transportation, departure time windows, routes, or any combination thereof. 267. The media of embodiment 266, wherein modes of transportation comprise driving, biking, bus, train, ride-sharing, carpooling, subway, trolley, taxi, walking, scooter, microtransit, or any combination thereof. 268. The media of embodiment 266, wherein modes of transportation comprise a plurality of modes of transportation and a transit suggestion associated with each of the plurality of modes of transportation 269. The media of embodiment 266, wherein a reward profile comprises a plurality of departure time windows and a transit suggestion associated with each of the plurality of departure time windows. 270. The media of embodiment 266, wherein a reward profile comprises a plurality of departure time windows proximate to a preferred travel time. 271. The media of embodiment 266, wherein a reward profile comprises a plurality of routes and a transit suggestion associated with each of the plurality of routes. 272. The media of embodiment 249, wherein a reward profile is adjusted to provide an incentive corresponding to the targeted shift in transit behavior. 273. The media of embodiment 249, wherein the traffic campaign comprises location, duration, and targeted number of users. 274. The media of embodiment 273, wherein the transit suggestion module offers incentives to the at least one target user based on reward profiles of said target user so as to maximize the targeted shift in transit behavior. 275. The media of embodiment 273, wherein the transit suggestion module continues offering transit suggestions to target users until the targeted number of users have accepted the targeted shift in transit behavior or performed the targeted shift in transit behavior. 276. The media of embodiment 273, wherein comparing the user data with traffic campaign parameters comprises determining a geo-relation or corridor relation between users and the location of the traffic campaign. 277. The media of embodiment 249, wherein the campaign targeting module dynamically identifies target users by receiving current or upcoming transit information from the target users and comparing the transit information with traffic campaign parameters. 278. The media of embodiment 249, wherein the campaign targeting module identifies target users by comparing traffic campaign parameters with user data before receiving current or upcoming transit information from the target users. 279. The media of embodiment 249, wherein the campaign targeting module presents transit suggestions to target users in an order that maximizes an adoption rate for the targeted shift in transit behavior for a targeted number of users. 280. The media of embodiment 249, wherein the targeted shift in transit behavior is a shift in mode of transportation, a shift in departure time, a shift in route, or any combination thereof. 281. The media of embodiment 280, wherein the shift in mode of transportation comprises a change from driving to biking, bus, train, walking, or any combination thereof. 282. The media of embodiment 280, wherein the shift in departure time comprises multiple departure time windows proximate in time to a preferred travel time for a user-selected origin and destination pair, wherein each of the departure time windows corresponds to a time interval when a user is to depart from the origin and travel along a route toward the destination. 283. The media of embodiment 280, wherein the shift in route comprises at least one additional route distinct from a preferred route for a user-selected origin and destination pair. 284. The media of embodiment 249, wherein the transit suggestion has no monetary value. 285. The media of embodiment 249, wherein the transit suggestion is selected to appeal to a lifestyle, socio-demographic, or psychographic aspect of the at least one user. 286. The media of embodiment 249, further comprising an analytics module calculating results of the traffic campaign. 287. The media of embodiment 286, wherein the results comprise number of users shifted, change in average travel speed, average cost per user shifted, or any combination thereof. 288. The media of embodiment 249, wherein the traffic campaign is a static campaign configured by an administrative user. 289. The media of embodiment 249, wherein the traffic campaign is a dynamic campaign that is automatically configured in response to one or more traffic events. 290. The media of embodiment 249, wherein the electronic device is a mobile device, a tablet, a laptop, a computer, or a vehicle console. 291. The media of embodiment 249, wherein the software server system further comprises a validation module receiving location information from one of the plurality of electronic device applications, and verifying that the user has departed from the origin during a selected departure time window, traveled along at least a portion of the route thereafter, and utilized a selected mode of transportation according to one of the at least one available travel option. 292. A computer-implemented method for conducting a traffic campaign for reducing congestion, comprising: a) generating a traffic campaign for reducing congestion by making micro-targeted transit suggestions personalized to target users via electronic devices of the target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof b) analyzing user data to generate personalized reward profiles comprising transit suggestions predicted to successfully shift transit behavior, the user data comprising responsiveness to previous transit suggestions; c) identifying target users by comparing traffic campaign parameters with user data comprising user-selected origin and destination pairs; d) determining at least one available travel option from the targeted shift in transit behavior for a user selected from the target users; e) determining a transit suggestion for each available travel option according to a reward profile associated with the targeted shift in transit behavior for the user; and f) presenting the at least one available travel option and the transit suggestion to the user. 293. The method of embodiment 292, wherein the user data comprises a user-selected origin and destination pair, preferred travel time, mode of transportation, or any combination thereof for a current or upcoming trip. 294. The method of embodiment 292, further comprising presenting the user with at least one question and an incentive offer for answering the at least one question. 295. The method of embodiment 292, wherein the transit suggestion is selected based on responsiveness to past transit suggestions for the user. 296. The method of embodiment 292, wherein the reward profile for the user comprises personalized transit suggestions associated with different modes of transportation, departure time windows, routes, or any combination thereof. 297. The method of embodiment 296, wherein the modes of transportation comprise driving, biking, bus, train, ride-sharing, carpooling, subway, trolley, taxi, walking, scooter, microtransit, or any combination thereof. 298. The method of embodiment 296, wherein the reward profile comprises a plurality of departure time windows and a transit suggestion associated with each of the plurality of departure time windows. 299. The method of embodiment 296, wherein the reward profile comprises a plurality of routes and a transit suggestion associated with each of the plurality of routes. 300. The method of embodiment 292, wherein the transit suggestion module offers the transit suggestion based on a reward profile of the user so as to maximize the targeted shift in transit behavior. 301. The method of embodiment 300, wherein the transit suggestion is selected to appeal to a lifestyle, socio-demographic, or psychographic aspect of the at least one user. 302. A traffic campaign management system, comprising: a) an electronic device application executable on an electronic device of a user; and b) a server in operative communication with the electronic device application deployed to a plurality of electronic devices, the server comprising at least one processor, a memory, and instructions executable by the at least one processor to create a server application comprising: i) a campaign builder module generating a traffic campaign for reducing congestion by making micro-targeted transit suggestions personalized to target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof; ii) a reward profile module analyzing user data to generate personalized reward profiles comprising transit suggestions predicted to successfully shift transit behavior, the user data comprising responsiveness to previous transit suggestions; iii) a campaign targeting module identifying target users by comparing traffic campaign parameters with user data comprising user-selected origin and destination pairs, wherein the user of the electronic device application is one of the target users, and determining at least one available travel option for the targeted shift in transit behavior for the user; iv) a transit suggestion module determining a transit suggestion for each available travel option according to a reward profile associated with the targeted shift in transit behavior for the user, and presenting the at least one available travel option and the transit suggestion to the user. 303. The system of embodiment 302, wherein the user data comprises a user-selected origin and destination pair, preferred travel time, mode of transportation, or any combination thereof for a current or upcoming trip. 304. The system of embodiment 302, further comprising a microsurvey module presenting the user with at least one question and an incentive offer for answering the at least one question. 305. The system of embodiment 302, wherein the reward profile for the user comprises personalized transit suggestions associated with different modes of transportation, departure time windows, routes, or any combination thereof. 306. The system of embodiment 305, wherein the modes of transportation comprise driving, biking, bus, train, ride-sharing, carpooling, subway, trolley, taxi, walking, scooter, microtransit, or any combination thereof. 307. The system of embodiment 302, wherein the transit suggestion module offers the transit suggestion based on a reward profile of the user so as to maximize the targeted shift in transit behavior. 308. The system of embodiment 307, wherein the transit suggestion is selected to appeal to a lifestyle, socio-demographic, or psychographic aspect of the at least one user. 309. The method of embodiment 302, wherein the user data is obtained from GPS points, microsurveys, social media, email, or any combination thereof. 310. The method of embodiment 309, wherein the GPS points are a source of user data comprising geo-relation, corridor relation, activity or lifestyle, or any combination thereof. 311. Non-transitory computer-readable storage media encoded with a computer program including instructions executable by at least one processor to create a computer software server system in operative communication with a plurality of electronic device applications executable on a plurality of electronic devices of a plurality of users, the computer software server system comprising: i) a campaign builder module generating a traffic campaign for reducing congestion by making micro-targeted transit suggestions personalized to target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof; ii) a reward profile module analyzing user data to generate personalized reward profiles comprising transit suggestions predicted to successfully shift transit behavior, the user data comprising responsiveness to previous transit suggestions; iii) a campaign targeting module identifying target users by comparing traffic campaign parameters with user data comprising user-selected origin and destination pairs, and determining at least one available travel option from the targeted shift in transit behavior for a user; iv) a transit suggestion module determining a transit suggestion for each available travel option according to a reward profile associated with the targeted shift in transit behavior for the user, and presenting the at least one available travel option and the transit suggestion to the user.

### EXAMPLES

The following illustrative example is representative of embodiments of the inventions described herein and is not meant to be limiting in any way.

### Example 1—Incentivized Traffic Campaigns

Traffic Campaign Setup

City A has been experiencing rapid growth due to the expanding local tech industry, which has been accompanied by a constant influx of working professionals. Many of these workers live in the suburbs south of the city and commute to work, which has been increasing traffic congestion, especially during peak commuting periods. The Department of Transportation (DOT) for city A has been trying to combat this growing traffic congestion for the past five years without much success. Plans to expand the interstate highway connecting the city to the surrounding suburbs to the south have been rejected by the city council due to high costs and heightened congestion during the expected construction period of 3 years.

However, DOT administrators have recently implemented a digital system for incentive-based traffic management. The traffic management system provides a server software application that allows administrators to setup traffic campaigns that target individual users. DOT launches a campaign offering free 1-week parking passes to drivers who download and register the traffic mobile application (which is in communication with the traffic management system/server) onto their phones. Parking is expensive, and many drivers download the mobile application and register.

Citizens and commuters have been complaining about the gridlock traffic that occurs during rush hour, and in response, the administrators decide to establish a traffic campaign for reducing the number of vehicles traveling along the interstate highway between City A and the suburbs. An administrator opens the server software application and configures a new traffic campaign with a target shift in transit behavior to reduce the number of vehicles traveling north along the interstate highway (corridor) from the suburbs to City A during morning rush hour (7 AM-8:30 AM) and to reduce the number of vehicle starveling south along the interstate highway back to the suburbs during the evening rush hour (5 PM-6:30 PM). Since this is just a pilot study, the administrator sets the total campaign budget at $500, a targeted number of users at 100 users per day, and a duration of one working week (5 business days). The administrator also sets the daily budget at $100 per day to ensure a consistent daily budget through the duration of the traffic campaign. The administrator does not choose a specific target shift in transit behavior, instead selecting all possible transportation options for reducing the number of vehicles on the freeway. Since the traffic management program has just been instituted, there is no user data available for creating personalized reward profiles. This is not a problem because the administrator is able to manually set incentive point allocations for alternative transportation options. The administrator uses the server application to identify different transportation options available to commuters. The server application determines that there are two bus routes that run on local roads parallel to a portion of the interstate highway. The administrator assigns 50 points as an incentive for taking the bus for at least 5 miles. The application also finds the local metro that runs from the northern part of the suburbs to various destinations throughout the city. The metro is relatively new but has not gained much popularity amongst the populace, so the administrator decides to allocate 100 points to taking the metro for at least 2 miles, hoping to increase adoption of metro transportation. Finally, the application identifies a number of local bypass roads that tend to have slightly lower traffic and can serve as alternate routes for commuters traveling between the suburbs and the city. Since these bypass roads are still somewhat congested, the administrator does not want to over-incentivize drivers into piling into these roads, especially when other transit options are available. Therefore, the administrator assigns only 10 points for taking an alternative route using bypass roads for at least 5 miles. Finally, the administrator assigns 50 points for incentivizing drivers to change their departure time such that travel time falls outside of rush hour periods. The administrator then finishes the campaign setup and launches the traffic campaign.

Traffic Campaign Implementation

The next day during morning rush hour, the configured traffic campaign is initiated for the first time. At 1 hour before the morning rush hour period commences, the traffic management system sends out incentive offers to 100 users whose phone GPS/location indicates they are in the suburbs south of City A (and thus are likely to commute to the city for work in the morning). Each user has the option of selecting any of the available transportation options. Of the 100 users, 25 respond by selecting a transportation option. The rest ignore or refuse the incentive offer. The traffic management system then selects a new group of 100 users and makes them the same offer. This time, 40 users accept. The traffic management system then tracks the location of the users who accepted the offers during the morning rush hour period. Those who performed the selected transportation option are then awarded the corresponding points into their user accounts. In this case, 55 of the 65 users who accepted the incentive offer performed their part of the agreement.

During the evening rush hour that same day, the traffic management system makes the same incentive offer to users until 45 users have accepted (thus adding up with the 55 users who performed to reach the daily targeted number of 100 users). During rush hour, it becomes clear that 15 of the users will not perform according to the accepted incentive offer (e.g., drove during rush hour instead of during an alternative departure time outside of rush hour, or drove instead of taking a mass transit option). Since the rush hour is still ongoing, the traffic management system makes the incentive offer to additional users until 15 more users who have not yet begun their commute accept the offer. In this case, 10 of the users actually end up following through with the bargain. Accordingly, at the end of the first day, transit behavior has been shifted for 95 users.

Traffic Campaign Monitoring

The administrator is able to use the traffic management system to actively monitor and manage the traffic campaign throughout this process. For example, the administrator has the option of changing traffic campaign parameters while the campaign is in progress such as increasing incentive points when he notices that users do not seem to be responsive to the initial incentive offers (e.g., low offer acceptance). The administrator is also able to sort users based on various filters (e.g., using user data such as user location, vehicle type, etc) and actively select users or groups of users to receive an incentive offer.

In addition, the administrator has the option of setting campaign parameters or rules that provide further instruction on what to do during certain scenarios such as this one in which the target number of users is not reached. One campaign parameter/rule can be to continue making incentive offers to additional users until the target number of users whose transit behavior has been shifted is reached. Alternatively, a campaign parameter/rule is to make up any deficit or surplus in the target number of users at a later time. In this case, the traffic management server has been configured to make up any morning rush hour deficit/surplus during the evening. The server can be configured to attempt to make up the first day's deficit/surplus on the second or a later day.

The traffic campaign continues to operate in this manner for the rest of the week until the campaign duration is expired. The users are able to use their mobile applications to access a “reward shop” for exchanging earned incentive points for various rewards such as coupons, discounts, free services, parking passes, etc. The points can be set to have a consistent monetary value that is pegged to the budgetary cost of the rewards that can be purchased by the points. For example, a coupon that cost DOT 10 cents may be purchased with 10 points, while free movie tickets that cost 10 dollars may be purchased with 1000 points (each point has a monetary value of 1 cent such that a point provides equal monetary value regardless of the reward it is being exchanged for). The “price” of a reward in points is thus measured by the actual monetary cost of the reward to DOT. This allows for campaign budgets to be more easily managed.

Although a reduction of merely ˜100 vehicles during rush hour a day is not enough to make a significant impact on traffic congestion, the pilot traffic campaign is a successful proof-of-principle experiment showing that transit behavior can be modified using incentive-based offers. However, the low responsiveness to the incentive offers is cause for concern. If users are not interested in the amount or type of incentives offered, then they could begin to abandon the mobile application. Moreover, the low responsiveness makes it difficult to predict the expected success of a traffic campaign.

Fortunately, the traffic management system utilizes various resources to obtain user data that can be used to build personalized reward profiles that allow better predictions of user responsiveness to incentive offers. User data includes information entered during registration such as user identity, vehicle(s) driven, home address, work address, and preferred commuting behavior (e.g., transportation mode, route, and departure time). Certain user data can be used to extrapolate additional user data. For example, the vehicle model entered by a user during registration can be used to determine gas mileage. User data also includes user responses to previous incentive offers (e.g., whether a user accepted or rejected an incentive offer, the transportation option chosen, and the corresponding incentive(s)). The user data is stored on one or more databases by the traffic management system. The system also retrieves user data from various social media platforms. In addition, user transit behavior is determined using location data retrieved from their electronic devices (e.g., typical rush hour commuting behavior—departure time, travel time, route, mode of transportation, etc. are tracked via GPS location monitoring).

In some embodiments, the reward profiles comprise user data including location information (historical and/or current location) that is analyzed to identify incentives. For example, a current user location may be in geographical proximity to an electric bike rental (e.g., within a 5 minute walk). The user may be offered an incentive or information offer on the electric bike rental when entering trip information. This incentive or information offer may be further personalized based on the user data. For example, the offer may be made only if the user data indicates a past history of using electric bikes (or renting electric bikes). In some cases, the length of the trip affects whether the incentive or information offer is made. A trip that exceeds a threshold distance or estimated travel time may result in the offer not being made based on an estimation or prediction that the distance is too long for the mode of transportation (e.g., 50 miles being too long for non-electric bike transportation mode). The threshold distance or estimated travel time may be changed based on user data. For example, a user who is a triathlete with numerous past bicycle trips exceeding 50-100 miles may be given the incentive or information offer, whereas a more average user may not receive the offer.

In some embodiments, user location data (e.g., including trip data) is used to identify or infer additional information about the user. As an example, regular trips between home and the same destination location during morning and evening rush hour periods on weekdays may be used to infer that the destination location is a workplace for the user. Likewise, regular trips between the workplace and a nearby plaza around noon on weekdays may be used to infer lunch times and locations. Depending on the accuracy of the location data, specific destination locations may be identified (e.g., specific eateries or stores). In various embodiments, algorithms are configured to identify such patterns in user data to infer additional information, which may be useful for further personalizing incentives. Various embodiments and examples of personalized incentives or information offers based on user data are listed below.

Information and/or incentive offers can be customized or personalized based on user data (e.g., from the personalized user profile) such as location data. Location data can be analyzed to identify potential points of interest that can be used to enhance the adoption rate of travel options provided by information or incentive offers. Information offers may make the user aware of points of interest that may be near the route or destination of a planned trip (or alternative travel options for the trip). In some cases, the information offer alone provides sufficient psychological incentive to convince a user to adopt an alternative travel option. Alternatively or in combination, incentive offers can leverage the user data to increase the likelihood of adoption of the alternative travel option(s). In some embodiments, coupons to restaurants the user is predicted to frequent may be used as an incentive offer. In some embodiments, an information offer configured to persuade the user to alter his route (e.g., to reduce traffic on a congested roadway) may provide an alternative route that is estimated to take the user near a favorite restaurant around lunchtime; the information offer may informs the user that this route allows him to have lunch at the restaurant in addition to any other information or incentives. In some embodiments, the user data indicates that the user frequents high-end restaurants (e.g., menu items are priced above a certain level such as via online review sites like Yelp) based on location data.

The traffic management system allows an administrator to sort and/or target specific users or groups of users (with the traffic campaign) using filters or parameters based on user data. For example, the administrator has the option of setting a campaign parameter/rule that selects for users who drive SUVs and offers them larger incentives to switch to a different mode of transportation (e.g., an incentive multiplier such as double incentive points compared to drivers of non-SUVs). Alternatively, the administrator has the option of setting a campaign parameter that selects for users with vehicles having gas mileage no higher than 10 mpg and offers them larger incentives to switch to a different mode of transportation.

Accordingly, the administrator configures and deploys subsequent traffic campaigns that provide additional user feedback and responses to incentive offers. This allows for the user reward profiles to be personalized for individual users. The system adjusts reward profiles for users who ignore or refuse incentive offers for certain travel options by raising the incentives for those travel options. The administrator also selects specific user groups by filtering for target demographics based on user data. In one campaign, the administrator filters for teenage drivers and configures a campaign to incentivize this group of drivers to take mass transit or ride-sharing when traveling to and from the local fair. When users within this group enter travel information indicating they are going to the fair, the system sends the incentive offers to these users according to the traffic campaign parameters. The incentive offers themselves, however, vary between users since they are personalized based on individual user data.

Traffic Campaign Assessment

Once the pilot campaigns have completed, the administrator accesses the traffic management system for analytics to evaluate the success of the campaigns. The system provides analytics/metrics that indicate the campaign has successfully reduced average traffic congestion along the interstate highway during rush hour by 15% and increased the average traffic speed from 25 mph to 45 mph. Example 2—Transit Suggestions

DOT administrators in City B implement a digital system for traffic management. The traffic management system provides a server software application that allows administrators to setup traffic campaigns that target individual users. The administrators decide to setup an informational traffic campaign that targets users with informational offers or transit suggestions for alternative travel options.

Users download and install mobile applications provided for download by DOT administrators onto their smartphones and tablets. Users who enter travel information for a planned trip then receive targeted transit suggestions providing alternative available travel options. The transit suggestions are initially determined based on any available travel options that are established as preferred alternative travel options according to the traffic campaign parameters. In this case, the administrators configure the traffic campaign to increase use of electric transportation modes. Accordingly, users who enter trip details are provided with transit suggestions for available electric bicycles/scooters, a local electric trolley, a subway, and electric ride-shares that are in proximity to the users. The administrators use the traffic management system to set the proximity to include any suitable modes of transportation within a 1 mile radius of users. However, users also have the option to adjust the proximity on their own mobile apps. Some users increase or decrease the proximity based on their personal preferences.

Over time, as more information is gathered on user travel behavior, the user data is analyzed and modeled to generate predictions of adoption rates for certain transit suggestions or categories of transit suggestions for the user or a relevant user population based on shared characteristics. The predictions are used to personalize the targeted transit suggestions to optimize adoption rate.

The traffic campaign becomes a success, and the administrators decide to implement a perpetual traffic campaign (no set duration) covering all users. Eventually, the administrators release a stand-alone mobile application that provides transit suggestions to users based on user entered trip details without requiring a specific traffic campaign to be setup and launched. Instead, the mobile application continues to provide transit suggestions for decreasing traffic congestion, decreasing pollution, improving health, increasing use of green technologies, and/or other traffic or transportation goals by default. Thus, the mobile application operates as if there is a perpetual or ongoing traffic campaign without a specified duration.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A computer-implemented method for conducting a traffic campaign for reducing congestion, comprising:
a) generating a traffic campaign for reducing congestion by making micro-targeted transit suggestions personalized to target users via electronic devices of the target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof;
b) analyzing user data to generate personalized reward profiles comprising transit suggestions predicted to successfully shift transit behavior, the user data comprising responsiveness to previous transit suggestions;
c) identifying target users by comparing traffic campaign parameters with user data comprising user-selected origin and destination pairs;
d) determining at least one available travel option from the targeted shift in transit behavior for a user selected from the target users;
e) determining a transit suggestion for each available travel option according to a reward profile associated with the targeted shift in transit behavior for the user; and
f) presenting the at least one available travel option and the transit suggestion to the user.

2. The method of claim 1, wherein the user data comprises a user-selected origin and destination pair, preferred travel time, mode of transportation, or any combination thereof for a current or upcoming trip.

3. The method of claim 1, further comprising presenting the user with at least one question and an incentive offer for answering the at least one question.

4. The method of claim 1, wherein the transit suggestion is selected based on responsiveness to past transit suggestions for the user.

5. The method of claim 1, wherein the reward profile for the user comprises personalized transit suggestions associated with different modes of transportation, departure time windows, routes, or any combination thereof.

6. The method of claim 5, wherein the modes of transportation comprise driving, biking, bus, train, ride-sharing, carpooling, subway, trolley, taxi, walking, scooter, microtransit, or any combination thereof.

7. The method of claim 5, wherein the reward profile comprises a plurality of departure time windows and a transit suggestion associated with each of the plurality of departure time windows.

8. The method of claim 5, wherein the reward profile comprises a plurality of routes and a transit suggestion associated with each of the plurality of routes.

9. The method of claim 1, wherein the transit suggestion module offers the transit suggestion based on a reward profile of the user so as to maximize the targeted shift in transit behavior.

10. The method of claim 9, wherein the transit suggestion is selected to appeal to a lifestyle, socio-demographic, or psychographic aspect of the at least one user.

11. A traffic campaign management system, comprising:
a) an electronic device application executable on an electronic device of a user; and
b) a server in operative communication with the electronic device application deployed to a plurality of electronic devices, the server comprising at least one processor, a memory, and instructions executable by the at least one processor to create a server application comprising:
i) a campaign builder module generating a traffic campaign for reducing congestion by making micro-targeted transit suggestions personalized to target users, the traffic campaign having traffic campaign parameters comprising a targeted shift in transit behavior and at least one of location, duration, budget, or number of target users, wherein the targeted shift in transit behavior is a change in mode of transportation, travel route, departure time window, or any combination thereof;
ii) a reward profile module analyzing user data to generate personalized reward profiles comprising transit suggestions predicted to successfully shift transit behavior, the user data comprising responsiveness to previous transit suggestions;
iii) a campaign targeting module identifying target users by comparing traffic campaign parameters with user data comprising user-selected origin and destination pairs, wherein the user of the electronic device application is one of the target users, and determining at least one available travel option for the targeted shift in transit behavior for the user;
iv) a transit suggestion module determining a transit suggestion for each available travel option according to a reward profile associated with the targeted shift in transit behavior for the user, and presenting the at least one available travel option and the transit suggestion to the user.

12. The system of claim 11, wherein the user data comprises a user-selected origin and destination pair, preferred travel time, mode of transportation, or any combination thereof for a current or upcoming trip.

13. The system of claim 11, further comprising a microsurvey module presenting the user with at least one question and an incentive offer for answering the at least one question.

14. The system of claim 11, wherein the reward profile for the user comprises personalized transit suggestions associated with different modes of transportation, departure time windows, routes, or any combination thereof.

15. The system of claim 14, wherein the modes of transportation comprise driving, biking, bus, train, ride-sharing, carpooling, subway, trolley, taxi, walking, scooter, microtransit, or any combination thereof.

16. The system of claim 11, wherein the transit suggestion module offers the transit suggestion based on a reward profile of the user so as to maximize the targeted shift in transit behavior.

17. The system of claim 16, wherein the transit suggestion is selected to appeal to a lifestyle, socio-demographic, or psychographic aspect of the at least one user.

18. The method of claim 11, wherein the user data is obtained from GPS points, microsurveys, social media, email, or any combination thereof.

19. The method of claim 18, wherein the GPS points are a source of user data comprising geo-relation, corridor relation, activity or lifestyle, or any combination thereof.

20. (canceled)

21. A computer-implemented method for conducting a traffic campaign for reducing congestion, comprising:
a) generating a traffic campaign for reducing congestion by making micro-targeted incentive offers personalized to target users via electronic devices of the target users, the traffic campaign having traffic campaign parameters comprising at least one of location, duration, budget, or number of target users, and a targeted shift in transit behavior, wherein the targeted shift in transit behavior is a change in mode of transportation, travel route, departure time window, or any combination thereof;
b) analyzing user data to generate personalized reward profiles comprising incentive offers predicted to successfully shift transit behavior, the user data comprising responsiveness to previous incentive offers;
c) identifying target users by comparing traffic campaign parameters with user data comprising user-selected origin and destination pairs;
d) determining at least one available travel option from the targeted shift in transit behavior for a user selected from the target users;
e) calculating a user incentive for each available travel option according to a reward profile associated with the targeted shift in transit behavior for the user;
f) presenting the at least one available travel option and associated user incentive to the user;
g) receiving location information from the electronic device application; and
h) verifying that the user has departed from the origin during a selected departure time window, traveled along at least a portion of the route thereafter, and utilized a selected mode of transportation according to one of the at least one available travel option.

22.-38. (canceled)
